(19) United States
(12) Patent Application Publication
(10) Pub. No.: US 2009/0319261 A1
(43) Pub. Date: Dec. 24, 2009

(54) CODING OF TRANSITIONAL SPEECH FRAMES FOR LOW-BIT-RATE APPLICATIONS

(75) Inventors: Alok Kumar Gupta, Encinitas, CA (US); Sharath Manjunath, Bangalore (IN); Ananthapadmanabhan A. Kandhadai, San Diego, CA (US)

Correspondence Address: QUALCOMM INCORPORATED, 5775 MOREHOUSE DR., SAN DIEGO, CA, 92121, US

(73) Assignee: Qualcomm Incorporated, San Diego, CA (US)

(21) Appl. No.: 12/143,719

(22) Filed: Jun. 20, 2008

(51) Int. Cl. G10L 21/00

(52) U.S. Cl. 704/207; 704/E21.001

(57) ABSTRACT

Systems, methods, and apparatus for low-bit-rate coding of transitional speech frames are disclosed.

### FIELD

This disclosure relates to processing of speech signals.

### BACKGROUND

Transmission of audio signals, such as voice and music, by digital techniques has become widespread, particularly in long distance telephony, packet-switched telephony such as Voice over IP (also called VoIP, where IP denotes Internet Protocol), and digital radio telephony such as cellular telephony. Such proliferation has created interest in reducing the amount of information used to transfer a voice communication over a transmission channel while maintaining the perceived quality of the reconstructed speech. For example, it is desirable to make the best use of available wireless system bandwidth. One way to use system bandwidth efficiently is to employ signal compression techniques. For wireless systems which carry speech signals, speech compression (or “speech coding”) techniques are commonly employed for this purpose.

Devices that are configured to compress speech by extracting parameters that relate to a model of human speech generation are often called vocoders, “audio coders,” or “speech coders.” (These three terms are used interchangeably herein.) A speech coder generally includes an encoder and a decoder. The encoder typically divides the incoming speech signal (a digital signal representing audio information) into segments of time called “frames,” analyzes each frame to extract certain relevant parameters, and quantizes the parameters into an encoded frame. The encoded frames are transmitted over a transmission channel (i.e., a wired or wireless network connection) to a receiver that includes a decoder. The decoder receives and processes encoded frames, dequantizes them to produce the parameters, and recreates speech frames using the dequantized parameters.

In a typical conversation, each speaker is silent for about sixty percent of the time. Speech encoders are usually configured to distinguish frames of the speech signal that contain speech (“active frames”) from frames of the speech signal that contain only silence or background noise (“inactive frames”). Such an encoder may be configured to use different coding modes and/or rates to encode active and inactive frames. For example, speech encoders are typically configured to use fewer bits to encode an inactive frame than to encode an active frame. A speech coder may use a lower bit rate for inactive frames to support transfer of the speech signal at a lower average bit rate with little to no perceived loss of quality.

Examples of bit rates used to encode active frames include 171 bits per frame, eighty bits per frame, and forty bits per frame. Examples of bit rates used to encode inactive frames include sixteen bits per frame. In the context of cellular telephony systems (especially systems that are compliant with Interim Standard (IS)-95 as promulgated by the Telecommunications Industry Association, Arlington, Va., or a similar industry standard), these four bit rates are also referred to as “full rate,” “half rate,” “quarter rate,” and “eighth rate,” respectively.

### SUMMARY

A method of encoding frames of a speech signal according to one configuration includes encoding a first frame of the speech signal as a first encoded frame and encoding a second frame of the speech signal as a second encoded frame. In this method, encoding a first frame includes selecting, based on information from at least one pitch pulse of the first frame, one among a plurality of time-domain pitch pulse shapes; calculating a position of a terminal pitch pulse of the first frame; and estimating a pitch period of the first frame. In this method, encoding a second frame includes calculating a pitch pulse shape differential between a pitch pulse shape of the second frame and a pitch pulse shape of the first frame; and calculating a pitch period differential between a pitch period of the second frame and a pitch period of the first frame. In this method, the first encoded frame includes representations of each among the selected time-domain pitch pulse shape, the calculated position, and the estimated pitch period. In this method, the second encoded frame includes representations of each among the pitch pulse shape differential and the pitch period differential, and the second frame follows said first frame in the speech signal.

A method of decoding excitation signals of a speech signal according to one configuration includes decoding a portion of a first encoded frame to obtain a first excitation signal; and decoding a portion of a second encoded frame to obtain a second excitation signal. In this method, the portion of the first encoded frame includes representations of each among a time-domain pitch pulse shape, a pitch peak position, and a pitch period. In this method, the portion of the second encoded frame includes representations of each among a pitch pulse shape differential and a pitch period differential. In this method, decoding a portion of a first encoded frame includes arranging a first copy of the time-domain pitch pulse shape within the first excitation signal according to the pitch peak position; and arranging a second copy of the time-domain pitch pulse shape within the first excitation signal according to the pitch peak position and the pitch period. In this method, decoding a portion of a second encoded frame includes calculating a second pitch pulse shape based on the time-domain pitch pulse shape and the pitch pulse shape differential; calculating a second pitch period based on the pitch period and the pitch period differential; and arranging a plurality of copies of the second pitch pulse shape within the second excitation signal according to the pitch peak position and the second pitch period.

A method of detecting pitch peaks of a frame of a speech signal according to one configuration includes detecting a first pitch peak of the frame; selecting a candidate sample from among a plurality of samples within a first search window of the frame; selecting a candidate distance from among a plurality of distances, each among the plurality of distances corresponding to a different sample within a second search window of the frame. This method includes selecting, as a second pitch peak of the frame, one among (A) the candidate sample and (B) the sample that corresponds to the candidate distance. In this method, each among the plurality of distances is a distance between A) the corresponding sample and B) the first pitch peak.

Apparatus and other means configured to perform such methods, and computer-readable media having instructions which when executed by a processor cause the processor to execute the elements of such methods, are also expressly contemplated and disclosed herein.

### BRIEF DESCRIPTION OF THE DRAWINGS

FIG. 1 shows an example of a voiced segment of a speech signal.

FIG. 2A shows an example of amplitude over time for a speech segment.

FIG. 2B shows an example of amplitude over time for an LPC residual.

FIG. 3A shows a flowchart of a method of speech encoding M100 according to a general configuration.

FIG. 3B shows a flowchart of an implementation E102 of encoding task E100.

FIG. 4 shows a schematic representation of features in a frame.

FIG. 5A shows a diagram of an implementation E202 of encoding task E200.

FIG. 5B shows a flowchart of an implementation M110 of method M100.

FIG. 5C shows a flowchart of an implementation M120 of method M100.

FIG. 6A shows a block diagram of an apparatus MF100 according to a general configuration.

FIG. 6B shows a block diagram of an implementation FE102 of means FE100.

FIG. 7A shows a flowchart of a method of decoding excitation signals of a speech signal M200 according to a general configuration.

FIG. 7B shows a flowchart of an implementation D102 of decoding task D100.

FIG. 8A shows a block diagram of an apparatus MF200 according to a general configuration.

FIG. 8B shows a flowchart of an implementation FD102 of means for decoding FD100.

FIG. 9A shows a speech encoder AE10 and a corresponding speech decoder AD10.

FIG. 9B shows instances AE10a, AE10b of speech encoder AE10 and instances AD10a, AD 10b of speech decoder AD10.

FIG. 10A shows a block diagram of an apparatus for encoding frames of a speech signal A100 according to a general configuration.

FIG. 10B shows a block diagram of an implementation 102 of encoder 100.

FIG. 11A shows a block diagram of an apparatus for decoding excitation signals of a speech signal A200 according to a general configuration.

FIG. 11B shows a block diagram of an implementation 302 of first frame decoder 300.

FIG. 12A shows a block diagram of a multi-mode implementation AE20 of speech encoder AE10.

FIG. 12B shows a block diagram of a multi-mode implementation AD20 of speech decoder AD10.

FIG. 13 shows a block diagram of a residual generator R10.

FIG. 14 shows a schematic diagram of a system for satellite communications.

FIG. 15A shows a flowchart of a method M300 according to a general configuration.

FIG. 15B shows a block diagram of an implementation L102 of task L100.

FIG. 15C shows a flowchart of an implementation L202 of task L200.

FIG. 16A shows an example of a search by task L120.

FIG. 16B shows an example of a search by task L130.

FIG. 17A shows a flowchart of an implementation L210a of task L210.

FIG. 17B shows a flowchart of an implementation L220a of task L220.

FIG. 17C shows a flowchart of an implementation L230a of task L230.

FIGS. 18A-F illustrate search operations of iterations of task L212.

FIG. 19A shows a table of test conditions for task L214.

FIGS. 19B and 19C illustrate search operations of iterations of task L222.

FIG. 20A illustrates a search operation of task L232.

FIG. 20B illustrates a search operation of task L234.

FIG. 20C illustrates a search operation of an iteration of task L232.

FIG. 21 shows a flowchart for an implementation L302 of task L300.

FIG. 22A illustrates a search operation of task L320.

FIGS. 22B and 22C illustrate alternative search operations of task L320.

FIG. 23 shows a flowchart of an implementation L332 of task L330.

FIG. 24A shows four different sets of test conditions that may be used by an implementation of task L334.

FIG. 24B shows a flowchart for an implementation L338a of task L338.

FIG. 25 shows a flowchart for an implementation L304 of task L300.

FIG. 26 shows a table of bit allocations for various coding schemes of an implementation of speech encoder AE10.

FIG. 27A shows a block diagram of an apparatus MF300 according to a general configuration.

FIG. 27B shows a block diagram of an apparatus A300 according to a general configuration.

FIG. 27C shows a block diagram of an apparatus MF350 according to a general configuration.

FIG. 27D shows a block diagram of an apparatus A350 according to a general configuration.

FIG. 28 shows a flowchart of a method M500 according to a general configuration.

FIGS. 29A-D show various regions of a 160-bit frame.

FIG. 30 shows a flowchart of a method M600 according to a general configuration.

FIG. 31A shows an example of a uniform division of a lag range into bins.

FIG. 31B shows an example of a nonuniform division of a lag range into bins.

FIG. 32 shows a list of features used in a frame classification scheme.

FIG. 33 shows a flowchart of a procedure for computing a pitch-based normalized autocorrelation function.

FIG. 34 is a flowchart that illustrates a frame classification scheme at a high level.

FIG. 35 is a state diagram that illustrates possible transitions between states in a frame classification scheme.

FIGS. 36-37, 38-40, and 41-44 show code listings for three different procedures of a frame classification scheme.

FIGS. 45-52B show conditions for frame reclassification.

FIG. 53 shows a block diagram of an implementation AE30 of speech encoder AE20.

FIG. 54A shows a block diagram of an implementation AE40 of speech encoder AE10.

FIG. 54B shows a block diagram of an implementation E72 of periodic frame encoder E70.

FIG. 55 shows a block diagram of an implementation E74 of periodic frame encoder E72.

FIGS. 56A-D show some typical frame sequences in which the use of a transitional frame coding mode may be desirable.

FIG. 57 shows a code listing.

FIG. 58 shows four different conditions for canceling a decision to use transitional frame coding.

FIG. 59 shows a diagram of a method M700 according to a general configuration.

A reference label may appear in more than one figure to indicate the same structure.

### DETAILED DESCRIPTION

Systems, methods, and apparatus as described herein (e.g., methods M100, M200, M300, M500, M600, and/or M700) may be used to support speech coding at a low constant bit rate, or at a low maximum bit rate, such as two kilobits per second. Applications for such constrained-bit-rate speech coding include the transmission of voice telephony over satellite links (also called “voice over satellite”), which may be used to support telephone service in remote areas that lack the communications infrastructure for cellular or wireline telephony. Satellite telephony may also be used to support continuous wide-area coverage for mobile receivers such as vehicle fleets, enabling services such as push-to-talk. More generally, applications for such constrained-bit-rate speech coding are not limited to applications that involve satellites and may extend to any power-limited channel.

Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, generating, and/or selecting from a set of values. Unless expressly limited by its context, the term “obtaining” is used to indicate any of its ordinary meanings, such as calculating, deriving, receiving (e.g., from an external device), and/or retrieving (e.g., from an array of storage elements). Unless expressly limited by its context, the term “estimating” is used to indicate any of its ordinary meanings, such as computing and/or evaluating. Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). Any incorporation by reference of a portion of a document shall also be understood to incorporate definitions of terms or variables that are referenced within the portion, where such definitions appear elsewhere in the document.

Unless indicated otherwise, any disclosure of a speech encoder having a particular feature is also expressly intended to disclose a method of speech encoding having an analogous feature (and vice versa), and any disclosure of a speech encoder according to a particular configuration is also expressly intended to disclose a method of speech encoding according to an analogous configuration (and vice versa). Unless indicated otherwise, any disclosure of an apparatus for performing operations on frames of a speech signal is also expressly intended to disclose a corresponding method for performing operations on frames of a speech signal (and vice versa. Unless indicated otherwise, any disclosure of a speech decoder having a particular feature is also expressly intended to disclose a method of speech decoding having an analogous feature (and vice versa), and any disclosure of a speech decoder according to a particular configuration is also expressly intended to disclose a method of speech decoding according to an analogous configuration (and vice versa). The terms “coder,” “codec,” and “coding system” are used interchangeably to denote a system that includes at least one encoder configured to receive a frame of a speech signal (possibly after one or more pre-processing operations, such as a perceptual weighting and/or other filtering operation) and a corresponding decoder configured to produce a decoded representation of the frame.

For speech coding purposes, a speech signal is typically digitized (or quantized) to obtain a stream of samples. The digitization process may be performed in accordance with any of various methods known in the art including, for example, pulse code modulation (PCM), companded mu-law PCM, and companded A-law PCM. Narrowband speech encoders typically use a sampling rate of 8 kHz, while wideband speech encoders typically use a higher sampling rate (e.g., 12 or 16 kHz).

A speech encoder is configured to process the digitized speech signal as a series of frames. This series is usually implemented as a nonoverlapping series, although an operation of processing a frame or a segment of a frame (also called a subframe) may also include segments of one or more neighboring frames in its input. The frames of a speech signal are typically short enough that the spectral envelope of the signal may be expected to remain relatively stationary over the frame. A frame typically corresponds to between five and thirty-five milliseconds of the speech signal (or about forty to 200 samples), with ten, twenty, and thirty milliseconds being common frame sizes. The actual size of the encoded frame may change from frame to frame with the coding bit rate.

A frame length of twenty milliseconds corresponds to 140 samples at a sampling rate of seven kilohertz (kHz), 160 samples at a sampling rate of eight kHz, and 320 samples at a sampling rate of 16 kHz, although any sampling rate deemed suitable for the particular application may be used. Another example of a sampling rate that may be used for speech coding is 12.8 kHz, and further examples include other rates in the range of from 12.8 kHz to 38.4 kHz.

Typically all frames have the same length, and a uniform frame length is assumed in the particular examples described herein. However, it is also expressly contemplated and hereby disclosed that nonuniform frame lengths may be used. For example, implementations of the various apparatus and methods described herein may also be used in applications that employ different frame lengths for active and inactive frames and/or for voiced and unvoiced frames.

As noted above, it may be desirable to configure a speech encoder to use different coding modes and/or rates to encode active frames and inactive frames. In order to distinguish active frames from inactive frames, a speech encoder typically includes a speech activity detector (commonly called a voice activity detector or VAD) or otherwise performs a method of detecting speech activity. Such a detector or method may be configured to classify a frame as active or inactive based on one or more factors such as frame energy, signal-to-noise ratio, periodicity, and zero-crossing rate. Such classification may include comparing a value or magnitude of such a factor to a threshold value and/or comparing the magnitude of a change in such a factor to a threshold value.

A speech activity detector or method of detecting speech activity may also be configured to classify an active frame as one of two or more different types, such as voiced (e.g., representing a vowel sound), unvoiced (e.g., representing a fricative sound), or transitional (e.g., representing the beginning or end of a word). Such classification may be based on factors such as autocorrelation of speech and/or residual, zero crossing rate, first reflection coefficient, and/or other features as described in more detail herein (e.g., with respect to coding scheme selector C200 and/or frame reclassifier RC10). It may be desirable for a speech encoder to use different coding modes and/or bit rates to encode different types of active frames.

Frames of voiced speech tend to have a periodic structure that is long-term (i.e., that continues for more than one frame period) and is related to pitch. It is typically more efficient to encode a voiced frame (or a sequence of voiced frames) using a coding mode that encodes a description of this long-term spectral feature. Examples of such coding modes include code-excited linear prediction (CELP) and waveform interpolation techniques such as prototype waveform interpolation (PWI). One example of a PWI coding mode is called prototype pitch period (PPP). Unvoiced frames and inactive frames, on the other hand, usually lack any significant long-term spectral feature, and a speech encoder may be configured to encode these frames using a coding mode that does not attempt to describe such a feature. Noise-excited linear prediction (NELP) is one example of such a coding mode.

A speech encoder or method of speech encoding may be configured to select among different combinations of bit rates and coding modes (also called “coding schemes”). For example, a speech encoder may be configured to use a full-rate CELP scheme for frames containing voiced speech and transitional frames, a half-rate NELP scheme for frames containing unvoiced speech, and an eighth-rate NELP scheme for inactive frames. Other examples of such a speech encoder support multiple coding rates for one or more coding schemes, such as full-rate and half-rate CELP schemes and/or full-rate and quarter-rate PPP schemes.

An encoded frame as produced by a speech encoder or a method of speech encoding typically contains values from which a corresponding frame of the speech signal may be reconstructed. For example, an encoded frame may include a description of the distribution of energy within the frame over a frequency spectrum. Such a distribution of energy is also called a “frequency envelope” or “spectral envelope” of the frame. An encoded frame typically includes an ordered sequence of values that describes a spectral envelope of the frame. In some cases, each value of the ordered sequence indicates an amplitude or magnitude of the signal at a corresponding frequency or over a corresponding spectral region. One example of such a description is an ordered sequence of Fourier transform coefficients.

In other cases, the ordered sequence includes values of parameters of a coding model. One typical example of such an ordered sequence is a set of values of coefficients of a linear prediction coding (LPC) analysis. These LPC coefficient values encode the resonances of the encoded speech (also called “formants”) and may be configured as filter coefficients or as reflection coefficients. The encoding portion of most modern speech coders includes an analysis filter that extracts a set of LPC coefficient values for each frame. The number of coefficient values in the set (which is usually arranged as one or more vectors) is also called the “order” of the LPC analysis. Examples of a typical order of an LPC analysis as performed by a speech encoder of a communications device (such as a cellular telephone) include four, six, eight, ten, 12, 16, 20, 24, 28, and 32.

A speech coder is typically configured to transmit the description of a spectral envelope across a transmission channel in quantized form (e.g., as one or more indices into corresponding lookup tables or “codebooks”). Accordingly, it may be desirable for a speech encoder to calculate a set of LPC coefficient values in a form that may be quantized efficiently, such as a set of values of line spectral pairs (LSPs), line spectral frequencies (LSFs), immittance spectral pairs (ISPs), immittance spectral frequencies (ISFs), cepstral coefficients, or log area ratios. A speech encoder may also be configured to perform other operations, such as perceptual weighting, on the ordered sequence of values before conversion and/or quantization.

In some cases, a description of a spectral envelope of a frame also includes a description of temporal information of the frame (e.g., as in an ordered sequence of Fourier transform coefficients). In other cases, the set of speech parameters of an encoded frame may also include a description of temporal information of the frame. The form of the description of temporal information may depend on the particular coding mode used to encode the frame. For some coding modes (e.g., for a CELP coding mode), the description of temporal information includes a description of a residual of the LPC analysis (also called a description of an excitation signal). A corresponding speech decoder uses the excitation signal to excite an LPC model (e.g., as defined by the description of the spectral envelope). A description of an excitation signal typically appears in an encoded frame in quantized form (e.g., as one or more indices into corresponding codebooks).

The description of temporal information may also include information relating to a pitch component of the excitation signal. For a PPP coding mode, for example, the encoded temporal information may include a description of a prototype to be used by a speech decoder to reproduce a pitch component of the excitation signal. A description of information relating to a pitch component typically appears in an encoded frame in quantized form (e.g., as one or more indices into corresponding codebooks). For other coding modes (e.g., for a NELP coding mode), the description of temporal information may include a description of a temporal envelope of the frame (also called an “energy envelope” or “gain envelope” of the frame).

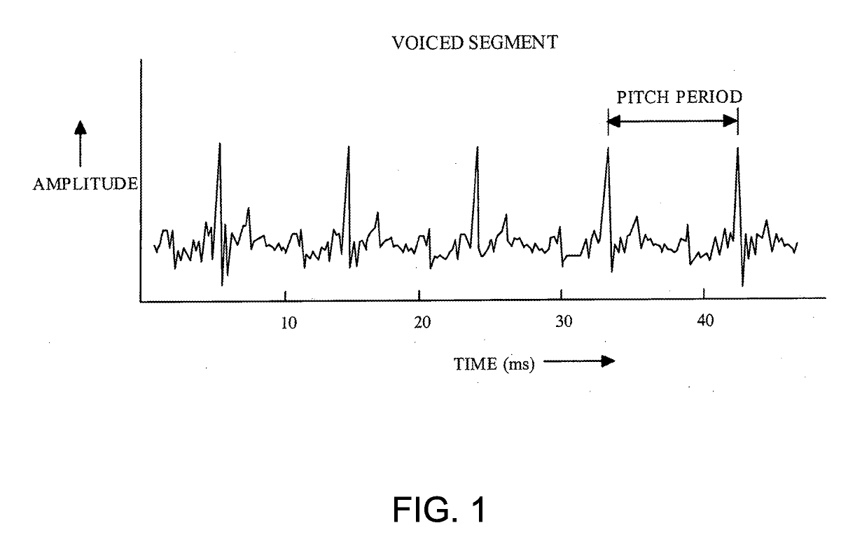

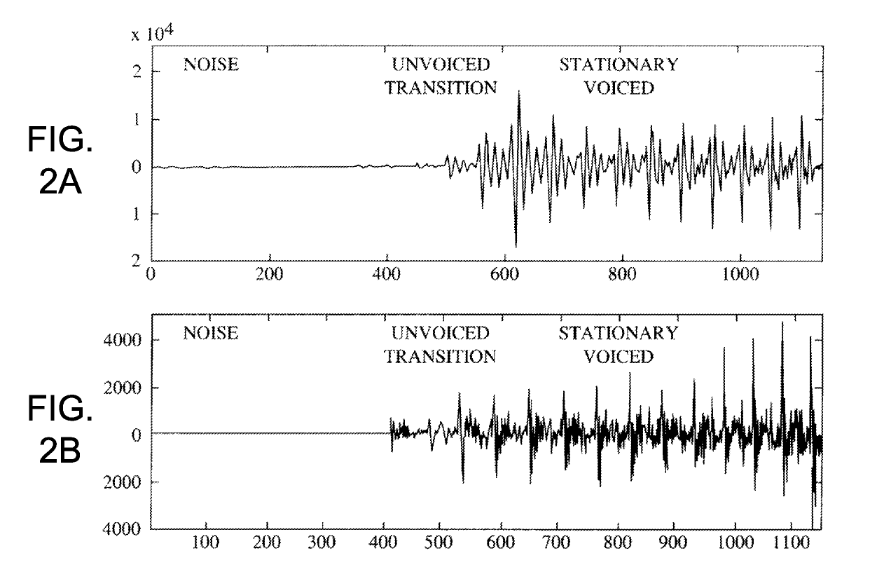

FIG. 1 shows one example of the amplitude of a voiced speech segment (such as a vowel) over time. For a voiced frame, the excitation signal typically resembles a series of pulses that is periodic at the pitch frequency, while for an unvoiced frame the excitation signal is typically similar to white Gaussian noise. A CELP or PWI coder may exploit the higher periodicity that is characteristic of voiced speech segments to achieve better coding efficiency. FIG. 2A shows an example of amplitude over time for a speech segment that transitions from background noise to voiced speech, and FIG. 2B shows an example of amplitude over time for an LPC residual of a speech segment that transitions from background noise to voiced speech. As coding of the LPC residual occupies much of the encoded signal stream, various schemes have been developed to reduce the bit rate needed to code the residual. Such schemes include CELP, NELP, PWI, and PPP.

It may be desirable to perform constrained-bit-rate encoding of a speech signal at a low bit rate (e.g., two kilobits per second) in a manner that provides a toll-quality decoded signal. Toll quality is typically characterized as having a bandwidth of approximately 200-3200 Hz and a signal-to-noise ratio (SNR) greater than 30 dB. In some cases, toll quality is also characterized as having less than two or three percent harmonic distortion. Unfortunately, existing techniques for encoding speech at bit rates near two kilobits per second typically produce synthesized speech that sounds artificial (e.g., robotic), noisy, and/or overly harmonic (e.g., buzzy).

High-quality encoding of nonvoiced frames, such as silence and unvoiced frames, can usually be performed at low bit rates using a noise-excited linear prediction (NELP) coding mode. However, it may be more difficult to perform high-quality encoding of voiced frames at a low bit rate. Good results have been obtained by using a higher bit rate for difficult frames, such as frames that include transitions from unvoiced to voiced speech (also called onset frames or up-transient frames), and a lower bit rate for subsequent voiced frames, to achieve a low average bit rate. For a constrained-bit-rate vocoder, however, the option of using a higher bit rate for difficult frames may not be available.

Existing variable-rate vocoders such as Enhanced Variable Rate Codec (EVRC) typically encode such difficult frames using a waveform coding mode such as CELP at a higher bit rate. Other coding schemes that may be used for storage or transmission of voiced speech segments at low bit rates include PWI coding schemes, such as PPP coding schemes. Such PWI coding schemes periodically locate a prototype waveform having a length of one pitch period in the residual signal. At the decoder, the residual signal is interpolated over the pitch periods between the prototypes to obtain an approximation of the original highly periodic residual signal. Some applications of PPP coding use mixed bit rates, such that a high-bit-rate encoded frame provides a reference for one or more subsequent low-bit-rate encoded frames. In such case, at least some of the information in the low-bit-rate frames may be differentially encoded.

It may be desirable to encode a transitional frame, such as an onset frame, in a non-differential manner that provides a good prototype (i.e., a good pitch pulse shape reference) and/or pitch pulse phase reference for differential PWI (e.g., PPP) encoding of subsequent frames in the sequence.

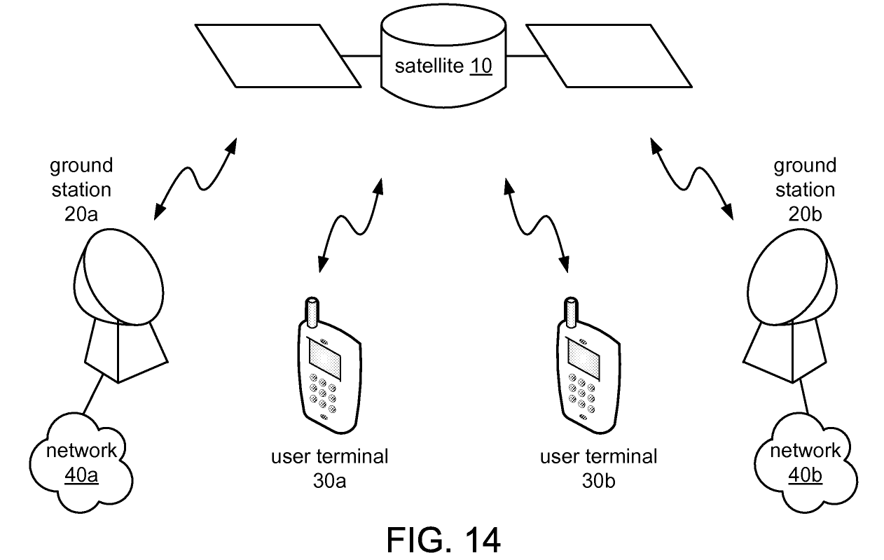

It may be desirable to provide a coding mode for onset frames and/or other transitional frames in a bit-rate-constrained coding system. For example, it may be desirable to provide such a coding mode in a coding system that is constrained to have a low constant bit rate or a low maximum bit rate. A typical example of an application for such a coding system is a satellite communications link (e.g., as described herein with reference to FIG. 14).

As discussed above, a frame of a speech signal may be classified as voiced, unvoiced, or silence. Voiced frames are typically highly periodic, while unvoiced and silence frames are typically aperiodic. Other possible frame classifications include onset, transient, and down-transient. Onset frames (also called up-transient frames) typically occur at the beginnings of words. An onset frame may be aperiodic (e.g., unvoiced) at the start of the frame and become periodic (e.g., voiced) by the end of the frame, as in the region between 400 and 600 samples in FIG. 2B. The transient class includes frames that have voiced but less periodic speech. Transient frames exhibit changes in pitch and/or reduced periodicity and typically occur at the middle or end of a voiced segment (e.g., where the pitch of the speech signal is changing). A typical down-transient frame has low-energy voiced speech and occurs at the end of a word. Onset, transient, and down-transient frames may also be referred to as “transitional” frames.

It may be desirable for a speech encoder to encode locations, amplitudes, and shapes of pulses in a nondifferential manner. For example, it may be desirable to encode an onset frame, or the first of a series of voiced frames, such that the encoded frame provides a good reference prototype for excitation signals of subsequent encoded frames. Such an encoder may be configured to locate the final pitch pulse of the frame, to locate a pitch pulse adjacent to the final pitch pulse, to estimate the lag value according to the distance between the peaks of the pitch pulses, and to produce an encoded frame that indicates the location of the final pitch pulse and the estimated lag value. This information may be used as a phase reference in decoding a subsequent frame that has been encoded without phase information. The encoder may also be configured to produce the encoded frame to include an indication of the shape of a pitch pulse, which may be used as a reference in decoding a subsequent frame that has been differentially encoded (e.g., using a QPPP coding scheme).

In coding a transitional frame (e.g., an onset frame), it may be more important to provide a good reference for subsequent frames than to achieve an accurate reproduction of the frame. Such an encoded frame may be used to provide a good reference for subsequent voiced frames that are encoded using PPP or other encoding schemes. For example, it may be desirable for the encoded frame to include a description of a shape of a pitch pulse (e.g., to provide a good shape reference), an indication of the pitch lag (e.g., to provide a good lag reference), and an indication of the location of the final pitch pulse of the frame (e.g., to provide a good phase reference), while other features of the onset frame may be encoded using fewer bits or even ignored.

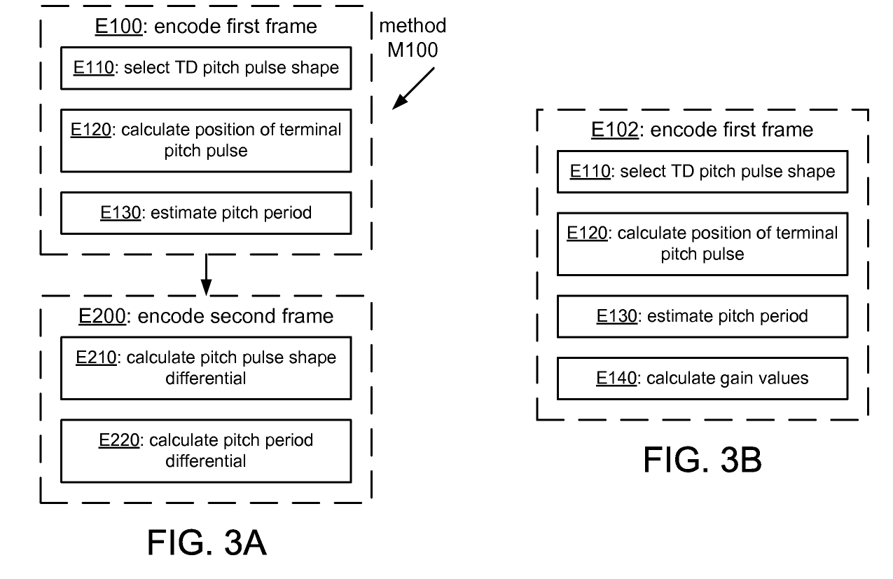

FIG. 3A shows a flowchart of a method of speech encoding M100 according to a configuration that includes encoding tasks E100 and E200. Task E100 encodes a first frame of a speech signal, and task E200 encodes a second frame of the speech signal, where the second frame follows the first frame. Task E100 may be implemented as a reference coding mode that encodes the first frame nondifferentially, and task E200 may be implemented as a relative coding mode (e.g., a differential coding mode) that encodes the second frame relative to the first frame. In one example, the first frame is an onset frame and the second frame is a voiced frame that immediately follows the onset frame. The second frame may also be the first of a series of consecutive voiced frames that immediately follows the onset frame.

Encoding task E100 produces a first encoded frame that includes a description of an excitation signal. This description includes a set of values that indicate the shape of a pitch pulse (i.e., a pitch prototype) in the time domain and the locations at which the pitch pulse is repeated. The pitch pulse locations are indicated by encoding the lag value along with a reference point, such as the position of a terminal pitch pulse of the frame. In this description, the position of a pitch pulse is indicated using the position of its peak, although the scope of this disclosure expressly includes contexts in which the position of a pitch pulse is equivalently indicated by the position of another feature of the pulse, such as its first or last sample. The first encoded frame may also include representations of other information, such as a description of a spectral envelope of the frame (e.g., one or more LSP indices).

Task E100 includes a subtask E110 that selects one among a set of time-domain pitch pulse shapes, based on information from at least one pitch pulse of the first frame. Task E110 may be configured to select the shape that most closely matches (e.g., in a least-squares sense) the pitch pulse having the highest peak in the frame. Alternatively, task E110 may be configured to select the shape that most closely matches the pitch pulse having the highest energy (e.g., the highest sum of squared sample values) in the frame. Alternatively, task E110 may be configured to select the shape that most closely matches an average of two or more pitch pulses of the frame (e.g., the pulses having the highest peaks and/or energies). Task E110 may be implemented to include a search through a codebook (i.e., a quantization table) of pitch pulse shapes (also called “shape vectors”).

Encoding task T100 also includes a subtask E120 that calculates a position of a terminal pitch pulse of the frame (e.g., the position of the initial pitch peak of the frame or the final pitch peak of the frame). The position of the terminal pitch pulse may be indicated relative to the start of the frame, relative to the end of the frame, or relative to another reference location within the frame. Task E120 may be configured to find the terminal pitch pulse peak by selecting a sample near the frame boundary (e.g., based on a relation between the amplitude or energy of the sample and a frame average, where energy is typically calculated as the square of the sample value) and searching within an area next to this sample for the sample having the maximum value. For example, task E120 may be implemented according to any of the configurations of terminal pitch peak locating task L100 described below.

Encoding task E100 also includes a subtask E130 that estimates a pitch period of the frame. The pitch period (also called “pitch lag value,” “lag value,” “pitch lag,” or simply “lag”) indicates a distance between pitch pulses (i.e., a distance between the peaks of adjacent pitch pulses). Typical pitch frequencies range from about 70 to 100 Hz for a male speaker to about 150 to 200 Hz for a female speaker. For a sampling rate of 8 kHz, these pitch frequency ranges correspond to lag ranges of about 40 to 50 samples for a typical female speaker and about 90 to 100 samples for a typical male speaker. To accommodate speakers having pitch frequencies outside these ranges, it may be desirable to support a pitch frequency range of about 50 to 60 Hz to about 300 to 400 Hz. For a sampling rate of 8 kHz, this frequency range corresponds to a lag range of about 20 to 25 samples to about 130 to 160 samples.

Pitch period estimation task E130 may be implemented to estimate the pitch period using any suitable pitch estimation procedure (e.g., as an instance of an implementation of lag estimation task L200 as described below). Such a procedure typically includes finding a pitch peak that is adjacent to the terminal pitch peak (or otherwise finding at least two adjacent pitch peaks) and calculating the lag as the distance between the peaks. Task E130 may be configured to identify a sample as a pitch peak based on a measure of its energy (e.g., a ratio between sample energy and frame average energy) and/or a measure of how well a neighborhood of the sample is correlated with a similar neighborhood of a confirmed pitch peak (e.g., the terminal pitch peak).

Encoding task E100 produces a first encoded frame that includes representations of features of an excitation signal for the first frame, such as the time-domain pitch pulse shape selected by task E110, the terminal pitch pulse position calculated by task E120, and the lag value estimated by task E130. Typically task E100 will be configured to perform pitch pulse position calculation task E120 before pitch period estimation task E130, and to perform pitch period estimation task E130 before pitch pulse shape selection task E110.

The first encoded frame may include a value that indicates the estimated lag value directly. Alternatively, it may be desirable for the encoded frame to indicate the lag value as an offset relative to a minimum value. For a minimum lag value of twenty samples, for example, a seven-bit number may be used to indicate any possible integer lag value in the range of twenty to 147 (i.e., 20+0 to 20+127) samples. For a minimum lag value of 25 samples, a seven-bit number may be used to indicate any possible integer lag value in the range of 25 to 152 (i.e., 25+0 to 25+127) samples. In such manner, encoding the lag value as an offset relative to a minimum value may be used to maximize coverage of a range of expected lag values while minimizing the number of bits required to encode the range of values. Other examples may be configured to support encoding of non-integer lag values. It is also possible for the first encoded frame to include more than one value relating to pitch lag, such as a second lag value or a value that otherwise indicates a change in the lag value from one side of the frame (e.g., the beginning or end of the frame) to the other.

It is likely that the amplitudes of the pitch pulses of a frame will differ from one another. In an onset frame, for example, the energy may increase over time, such that a pitch pulse near the end of the frame will have a larger amplitude than a pitch pulse near the beginning of the frame. At least in such a case, it may be desirable for the first encoded frame to include a description of variation in the average energy of the frame over time (also called a “gain profile”), such as a description of the relative amplitudes of the pitch pulses.

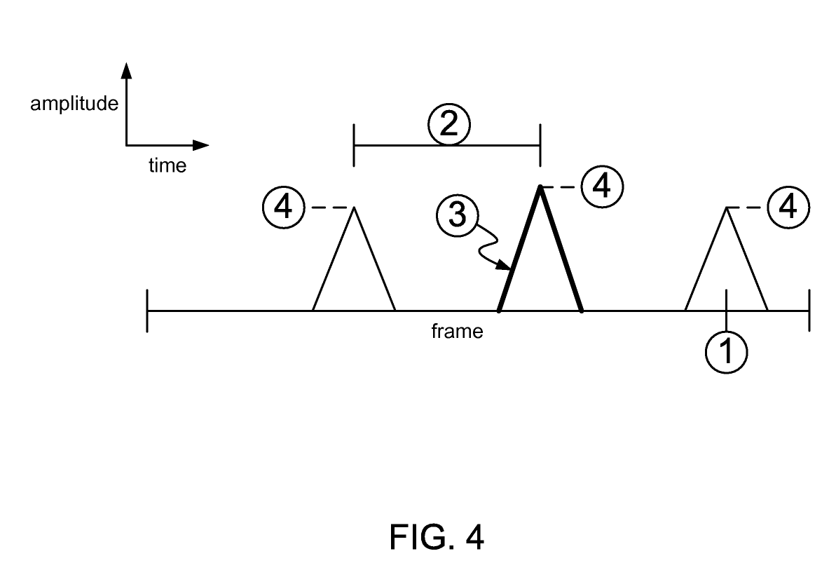

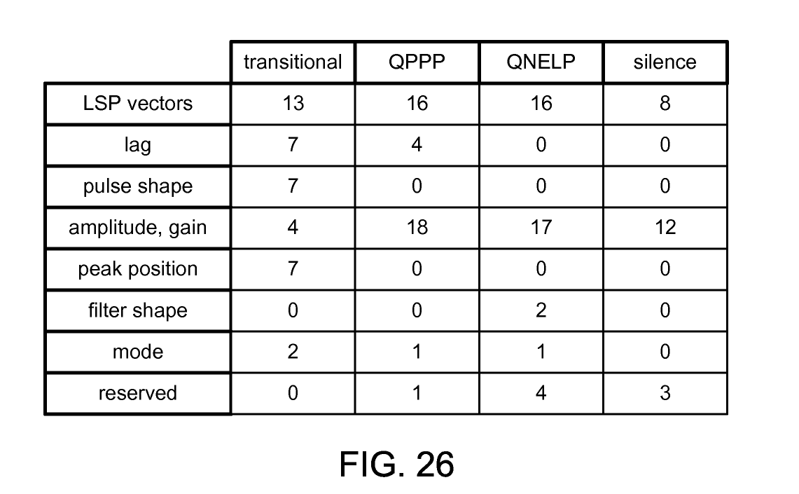

FIG. 3B shows a flowchart of an implementation E102 of encoding task E100 that includes a subtask E140. Task E140 calculates a gain profile of the frame as a set of gain values that correspond to different pitch pulses of the first frame. For example, each of the gain values may correspond to a different pitch pulse of the frame. Task E140 may include a search through a codebook (e.g., a quantization table) of gain profiles and selection of the codebook entry that most closely matches (e.g., in a least-squares sense) a gain profile of the frame. Encoding task E102 produces a first encoded frame that includes representations of the time-domain pitch pulse shape selected by task E110, the terminal pitch pulse position calculated by task E120, the lag value estimated by task E130, and the set of gain values calculated by task E140. FIG. 4 shows a schematic representation of these features in a frame, where the label “1” indicates the terminal pitch pulse position, the label “2” indicates the estimated lag value, the label “3” indicates the selected time-domain pitch pulse shape, and the label “4” indicates the values encoded in the gain profile (e.g., the relative amplitudes of the pitch pulses). Typically task E102 will be configured to perform pitch period estimation task E130 before gain value calculation task E140, which may be performed in series with or in parallel to pitch pulse shape selection task E110. In one example (as shown in the table of FIG. 26), encoding task E102 operates at quarter-rate to produce a forty-bit encoded frame that includes seven bits indicating a reference pulse position, seven bits indicating a reference pulse shape, seven bits indicating a reference lag value, four bits indicating a gain profile, thirteen bits that carry one or more LSP indices, and two bits indicating the coding mode for the frame (e.g., “00” to indicate an unvoiced coding mode such as NELP, “01” to indicate a relative coding mode such as QPPP, and “10” to indicate the reference coding mode E102).

The first encoded frame may include an explicit indication of the number of pitch pulses (or pitch peaks) in the frame. Alternatively, the number of pitch pulses or pitch peaks in the frame may be encoded implicitly. For example, the first encoded frame may indicate the positions of all of the pitch pulses in the frame using only the pitch lag and the position of the terminal pitch pulse (e.g., the position of the terminal pitch peak). A corresponding decoder may be configured to calculate potential positions for the pitch pulses from the lag value and the position of the terminal pitch pulse and to obtain an amplitude for each potential pulse position from the gain profile. For a case in which the frame contains fewer pulses than potential pulse positions, the gain profile may indicate a gain value of zero (or other very small value) for one or more of the potential pulse positions.

As noted herein, an onset frame may begin as unvoiced and end as voiced. It may be more desirable for the corresponding encoded frame to provide a good reference for subsequent frames than to support an accurate reproduction of the entire onset frame, and method M100 may be implemented to provide only limited support for encoding the initial unvoiced portion of such an onset frame. For example, task E140 may be configured to select a gain profile that indicates a gain value of zero (or close to zero) for any pitch pulse periods within the unvoiced portion. Alternatively, task E140 may be configured to select a gain profile that indicates nonzero gain values for pitch periods within the unvoiced portion. In one such example, task E140 selects a generic gain profile that begins at or close to zero and rises monotonically to the gain level of the first pitch pulse of the voiced portion of the frame.

Task E140 may be configured to calculate the set of gain values as an index to one of a set of gain vector quantization (VQ) tables, with different gain VQ tables being used for different numbers of pulses. The set of tables may be configured such that each gain VQ table contains the same number of entries, and different gain VQ tables contain vectors of different lengths. In such a coding system, task E140 computes an estimated number of pitch pulses based on the location of the terminal pitch pulse and the pitch lag, and this estimated number is used to select one among the set of gain VQ tables. In this case, an analogous operation may also be performed by a corresponding method of decoding the encoded frame. If the estimated number of pitch pulses is greater than the actual number of pitch pulses in the frame, task E140 may also convey this information by setting the gain for each additional pitch pulse period in the frame to a small value or to zero as described above.

Encoding task E200 encodes a second frame of the speech signal that follows the first frame. Task E200 may be implemented as a relative coding mode (e.g., a differential coding mode) that encodes features of the second frame relative to corresponding features of the first frame. Task E200 includes a subtask E210 that calculates a pitch pulse shape differential between a pitch pulse shape of the current frame and a pitch pulse shape of a previous frame. For example, task E210 may be configured to extract a pitch prototype from the second frame and to calculate the pitch pulse shape differential as a difference between the extracted prototype and the pitch prototype of the first frame (i.e., the selected pitch pulse shape). Examples of prototype extraction operations that may be performed by task E210 include those described in U.S. Pat. No. 6,754,630 (Das et al.), issued Jun. 22, 2004, and U.S. Pat. No. 7,136,812 (Manjunath et al.), issued Nov. 14, 2006.

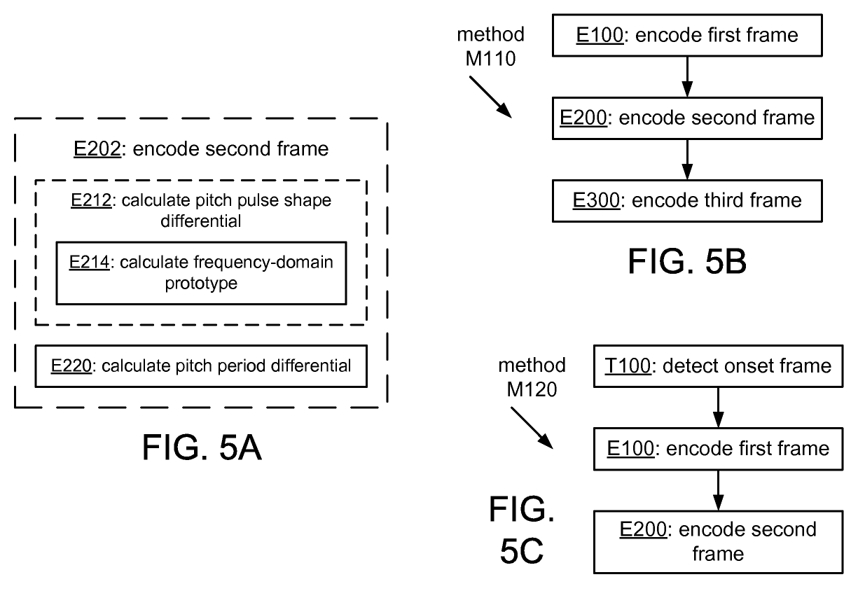

It may be desirable to configure task E210 to calculate the pitch pulse shape differential as a difference between the two prototypes in the frequency domain. FIG. 5A shows a diagram of an implementation E202 of encoding task E200 that includes an implementation E212 of pitch pulse shape differential calculation task E210. Task E212 includes a subtask E214 that calculates a frequency-domain pitch prototype of the current frame. For example, task E214 may be configured to perform a fast Fourier transform operation on the extracted prototype or to otherwise convert the extracted prototype to the frequency domain. Such an implementation of task E212 may also be configured to calculate the pitch pulse shape differential by dividing the frequency-domain prototype into a number of frequency bins (e.g., a set of nonoverlapping bins), calculating a corresponding frequency magnitude vector whose elements are the average magnitude in each bin, and calculating the pitch pulse shape differential as a vector difference between the frequency magnitude vector of the prototype and the frequency magnitude vector of the prototype of the previous frame. In such case, task E212 may also be configured to vector quantize the pitch pulse shape differential such that the corresponding encoded frame includes the quantized differential.

Encoding task E200 also includes a subtask E220 that calculates a pitch period differential between a pitch period of the current frame and a pitch period of a previous frame. For example, task E220 may be configured to estimate a pitch lag of the current frame and to subtract the pitch lag value of the previous frame to obtain the pitch period differential. In one such example, task E220 is configured to calculate the pitch period differential as (current lag estimate−previous lag estimate+7). To estimate the pitch lag, task E220 may be configured to use any suitable pitch estimation technique, such as an instance of pitch period estimation task E130 described above, an instance of lag estimation task L200 described below, or a procedure as described in section 4.6.3 (pp. 4-44 to 4-49) of the EVRC document C.S0014-C referenced above, which section is hereby incorporated by reference as an example. For a case in which the unquantized pitch lag value of the previous frame is different than the dequantized pitch lag value of the previous frame, it may be desirable for task E220 to calculate the pitch period differential by subtracting the dequantized value from the current lag estimate.

Encoding task E200 may be implemented using a coding scheme having limited time-synchrony, such as quarter-rate PPP (QPPP). An implementation of QPPP is described in sections 4.2.4 (pp. 4-10 to 4-17) and 4.12.28 (pp. 4-132 to 4-138) of the Third Generation Partnership Project 2 (3GPP2) document C.S0014-C, v1.0, entitled “Enhanced Variable Rate Codec, Speech Service Options 3, 68, and 70 for Wideband Spread Spectrum Digital Systems,” January 2007 (available online at www.3gpp.org), which sections are hereby incorporated by reference as an example. This coding scheme calculates the frequency magnitude vector of a prototype using a nonuniform set of twenty-one frequency bins whose bandwidths increase with frequency. The forty bits of an encoded frame produced using QPPP include sixteen bits that carry one or more LSP indices, four bits that carry a delta lag value, eighteen bits that carry amplitude information for the frame, one bit to indicate mode, and one reserved bit (as shown in the table of FIG. 26). This example of a relative coding scheme includes no bits for pulse shape and no bits for phase information.

As noted above, the frame encoded in task E100 may be an onset frame, and the frame encoded in task E200 may be the first of a series of consecutive voiced frames that immediately follows the onset frame. FIG. 5B shows a flowchart of an implementation M110 of method M100 that includes a subtask E300. Task E300 encodes a third frame that follows the second frame. For example, the third frame may be the second in a series of consecutive voiced frames that immediately follows the onset frame. Encoding task E300 may be implemented as an instance of an implementation of task E200 as described herein (e.g., as an instance of QPPP encoding). In one such example, task E300 includes an instance of task E210 (e.g., of task E212) that is configured to calculate a pitch pulse shape differential between a pitch prototype of the third frame and a pitch prototype of the second frame, and an instance of task E220 that is configured to calculate a pitch period differential between a pitch period of the third frame and a pitch period of the second frame. In another such example, task E300 includes an instance of task E210 (e.g., of task E212) that is configured to calculate a pitch pulse shape differential between a pitch prototype of the third frame and the selected pitch pulse shape of the first frame, and an instance of task E220 that is configured to calculate a pitch period differential between a pitch period of the third frame and a pitch period of the first frame.

FIG. 5C shows a flowchart of an implementation M120 of method M100 that includes a subtask T100. Task T100 detects a frame that includes a transition from nonvoiced speech to voiced speech (also called an up-transient or onset frame). Task T100 may be configured to perform frame classification according to the EVRC classification scheme described below (e.g., with reference to coding scheme selector C200) and may also be configured to reclassify a frame (e.g., as described below with reference to frame reclassifier RC10).

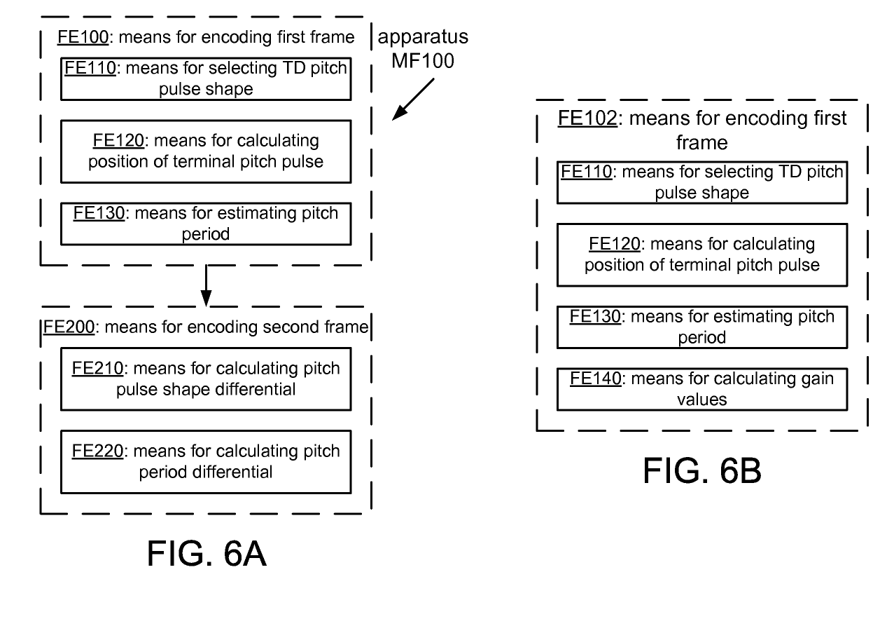

FIG. 6A shows a block diagram of an apparatus MF100 that is configured to encode frames of a speech signal. Apparatus MF100 includes means for encoding a first frame of the speech signal FE100 and means for encoding a second frame of the speech signal FE200, where the second frame follows the first frame. Means FE100 includes means FE110 for selecting one among a set of time-domain pitch pulse shapes based on information from at least one pitch pulse of the first frame (e.g., as described above with reference to various implementations of task E110). Means FE100 also includes means FE120 for calculating a position of a terminal pitch pulse of the first frame (e.g., as described above with reference to various implementations of task E120). Means FE100 also includes means FE130 for estimating a pitch period of the first frame (e.g., as described above with reference to various implementations of task E130). FIG. 6B shows a block diagram of an implementation FE102 of means FE100 that also includes means FE140 for calculating a set of gain values that correspond to different pitch pulses of the first frame (e.g., as described above with reference to various implementations of task E140).

Means FE200 includes means FE210 for calculating a pitch pulse shape differential between a pitch pulse shape of the second frame and a pitch pulse shape of the first frame (e.g., as described above with reference to various implementations of task E210). Means FE200 also includes means FE220 for calculating a pitch period differential between a pitch period of the second frame and a pitch period of the first frame (e.g., as described above with reference to various implementations of task E220).

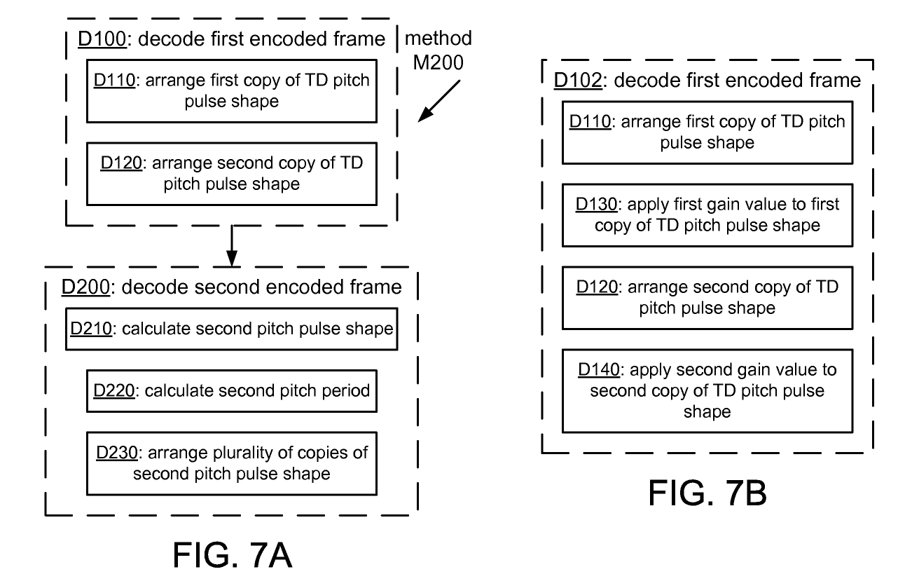

FIG. 7A shows a flowchart of a method of decoding excitation signals of a speech signal M200 according to a general configuration. Method M200 includes a task D100 that decodes a portion of a first encoded frame to obtain a first excitation signal, where the portion includes representations of a time-domain pitch pulse shape, a pitch pulse position, and a pitch period. Task D100 includes a subtask D110 that arranges a first copy of the time-domain pitch pulse shape within the first excitation signal according to the pitch pulse position. Task D100 also includes a subtask D120 that arranges a second copy of the time-domain pitch pulse shape within the first excitation signal according to the pitch pulse position and the pitch period. In one example, tasks D10 and D120 obtain the time-domain pitch pulse shape from a codebook (e.g., according to an index from the first encoded frame that represents the shape) and copy it to an excitation signal buffer. Task D 100 and/or method M200 may also be implemented to include tasks that obtain a set of LPC coefficient values from the first encoded frame (e.g., by dequantizing one or more quantized LSP vectors from the first encoded frame and inverse transforming the result), configure a synthesis filter according to the set of LPC coefficient values, and apply the first excitation signal to the configured synthesis filter to obtain a first decoded frame.

FIG. 7B shows a flowchart of an implementation D102 of decoding task D100. In this case, the portion of the first encoded frame also includes a representation of a set of gain values. Task D102 includes a subtask D130 that applies one of the set of gain values to the first copy of the time-domain pitch pulse shape. Task D102 also includes a subtask D140 that applies a different one of the set of gain values to the second copy of the time-domain pitch pulse shape. In one example, task D130 applies its gain value to the shape during task D110 and task D140 applies its gain value to the shape during task D120. In another example, task D130 applies its gain value to a corresponding portion of an excitation signal buffer after task D110 has executed, and task D140 applies its gain value to a corresponding portion of the excitation signal buffer after task D120 has executed. An implementation of method M200 that includes task D102 may be configured to include a task that applies the resulting gain-adjusted excitation signal to a configured synthesis filter to obtain a first decoded frame.

Method M200 also includes a task D200 that decodes a portion of a second encoded frame to obtain a second excitation signal, where the portion includes representations of a pitch pulse shape differential and a pitch period differential. Task D200 includes a subtask D210 that calculates a second pitch pulse shape based on the time-domain pitch pulse shape and the pitch pulse shape differential. Task D200 also includes a subtask D220 that calculates a second pitch period based on the pitch period and the pitch period differential. Task D200 also includes a subtask D230 that arranges two or more copies of the second pitch pulse shape within the second excitation signal according to the pitch pulse position and the second pitch period. Task D230 may include calculating a position for each of the copies within the second excitation signal as a corresponding offset from the pitch pulse position, where each offset is an integer multiple of the second pitch period. Task D200 and/or method M200 may also be implemented to include tasks that obtain a set of LPC coefficient values from the second encoded frame (e.g., by dequantizing one or more quantized LSP vectors from the second encoded frame and inverse transforming the result), configure a synthesis filter according to the set of LPC coefficient values, and apply the second excitation signal to the configured synthesis filter to obtain a second decoded frame.

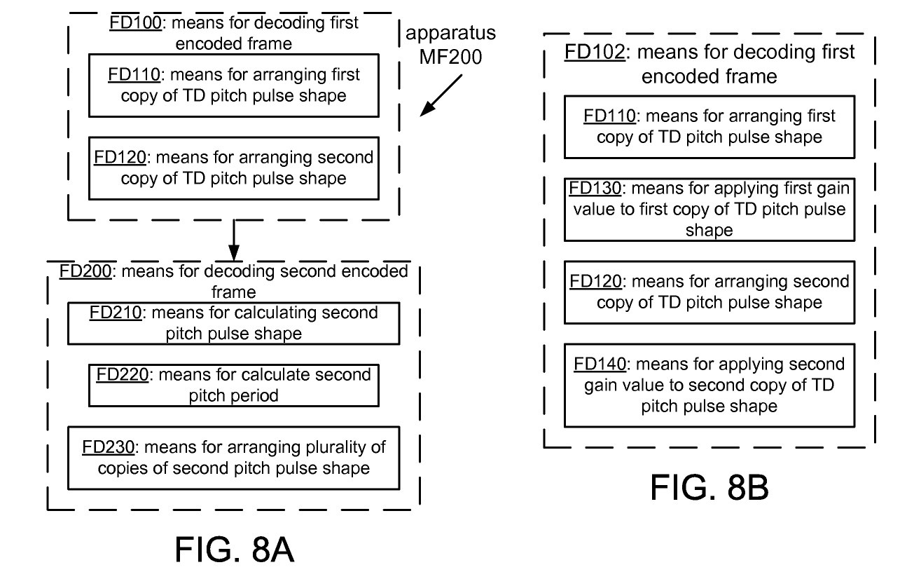

FIG. 8A shows a block diagram of an apparatus MF200 for decoding excitation signals of a speech signal. Apparatus MF200 includes means FD100 for decoding a portion of a first encoded frame to obtain a first excitation signal, where the portion includes representations of a time-domain pitch pulse shape, a pitch pulse position, and a pitch period. Means FD100 includes means FD110 for arranging a first copy of the time-domain pitch pulse shape within the first excitation signal according to the pitch pulse position. Means FD100 also includes means FD120 for arranging a second copy of the time-domain pitch pulse shape within the first excitation signal according to the pitch pulse position and the pitch period. In one example, means FD110 and FD120 are configured to obtain the time-domain pitch pulse shape from a codebook (e.g., according to an index from the first encoded frame that represents the shape) and copy it to an excitation signal buffer. Means FD200 and/or apparatus MF200 may also be implemented to include means for obtaining a set of LPC coefficient values from the first encoded frame (e.g., by dequantizing one or more quantized LSP vectors from the first encoded frame and inverse transforming the result), means for configuring a synthesis filter according to the set of LPC coefficient values, and means for applying the first excitation signal to the configured synthesis filter to obtain a first decoded frame.

FIG. 8B shows a flowchart of an implementation FD102 of means for decoding FD100. In this case, the portion of the first encoded frame also includes a representation of a set of gain values. Means FD102 includes means FD130 for applying one of the set of gain values to the first copy of the time-domain pitch pulse shape. Means FD102 also includes means FD140 for applying a different one of the set of gain values to the second copy of the time-domain pitch pulse shape. In one example, means FD130 applies its gain value to the shape within means FD110 and means FD140 applies its gain value to the shape within means FD120. In another example, means FD130 applies its gain value to a portion of an excitation signal buffer to which means FD110 has arranged the first copy, and means FD140 applies its gain value to a portion of the excitation signal buffer to which means FD120 has arranged the second copy. An implementation of apparatus MF200 that includes means FD102 may be configured to include means for applying the resulting gain-adjusted excitation signal to a configured synthesis filter to obtain a first decoded frame.

Apparatus MF200 also includes means FD200 for decoding a portion of a second encoded frame to obtain a second excitation signal, where the portion includes representations of a pitch pulse shape differential and a pitch period differential. Means FD200 includes means FD210 for calculating a second pitch pulse shape based on the time-domain pitch pulse shape and the pitch pulse shape differential. Means FD200 also includes means FD220 for calculating a second pitch period based on the pitch period and the pitch period differential. Means FD200 also includes means FD230 for arranging two or more copies of the second pitch pulse shape within the second excitation signal according to the pitch pulse position and the second pitch period. Means FD230 may be configured to calculate a position for each of the copies within the second excitation signal as a corresponding offset from the pitch pulse position, where each offset is an integer multiple of the second pitch period. Means FD200 and/or apparatus MF200 may also be implemented to include means for obtaining a set of LPC coefficient values from the second encoded frame (e.g., by dequantizing one or more quantized LSP vectors from the second encoded frame and inverse transforming the result), means for configuring a synthesis filter according to the set of LPC coefficient values, and means for applying the second excitation signal to the configured synthesis filter to obtain a second decoded frame.

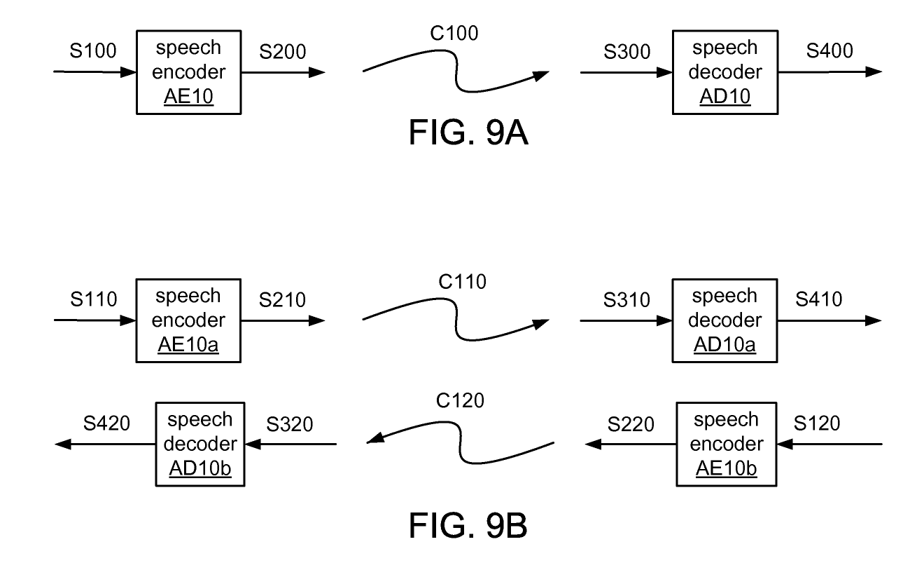

FIG. 9A shows a speech encoder AE10 that is arranged to receive a digitized speech signal S100 (e.g., as a series of frames) and to produce a corresponding encoded signal S200 (e.g., as a series of corresponding encoded frames) for transmission on a communication channel C100 (e.g., a wired, optical, and/or wireless communications link) to a speech decoder AD10. Speech decoder AD10 is arranged to decode a received version S300 of encoded speech signal S200 and to synthesize a corresponding output speech signal S400. Speech encoder AE10 may be implemented to include an instance of apparatus MF100 and/or to perform an implementation of method M100. Speech decoder AD10 may be implemented to include an instance of apparatus MF200 and/or to perform an implementation of method M200.

As described above, speech signal S100 represents an analog signal (e.g., as captured by a microphone) that has been digitized and quantized in accordance with any of various methods known in the art, such as pulse code modulation (PCM), companded mu-law, or A-law. The signal may also have undergone other pre-processing operations in the analog and/or digital domain, such as noise suppression, perceptual weighting, and/or other filtering operations. Additionally or alternatively, such operations may be performed within speech encoder AE10. An instance of speech signal S100 may also represent a combination of analog signals (e.g., as captured by an array of microphones) that have been digitized and quantized.

FIG. 9B shows a first instance AEL10a of speech encoder AE10 that is arranged to receive a first instance S110 of digitized speech signal S100 and to produce a corresponding instance S210 of encoded signal S200 for transmission on a first instance C110 of communication channel C100 to a first instance AD10a of speech decoder AD10. Speech decoder AD10a is arranged to decode a received version S310 of encoded speech signal S210 and to synthesize a corresponding instance S410 of output speech signal S400.

FIG. 9B also shows a second instance AE10b of speech encoder AE10 that is arranged to receive a second instance S120 of digitized speech signal S100 and to produce a corresponding instance S220 of encoded signal S200 for transmission on a second instance C120 of communication channel C100 to a second instance AD10b of speech decoder AD10. Speech decoder AD10b is arranged to decode a received version S320 of encoded speech signal S220 and to synthesize a corresponding instance S420 of output speech signal S400.

Speech encoder AE10a and speech decoder AD10b (similarly, speech encoder AE10b and speech decoder AD10a) may be used together in any communication device for transmitting and receiving speech signals, including, for example, the user terminals, ground stations, or gateways described below with reference to FIG. 14. As described herein, speech encoder AE10 may be implemented in many different ways, and speech encoders AE10a and AE10b may be instances of different implementations of speech encoder AE10. Likewise, speech decoder AD 10 may be implemented in many different ways, and speech decoders AD10a and AD10b may be instances of different implementations of speech decoder AD10.

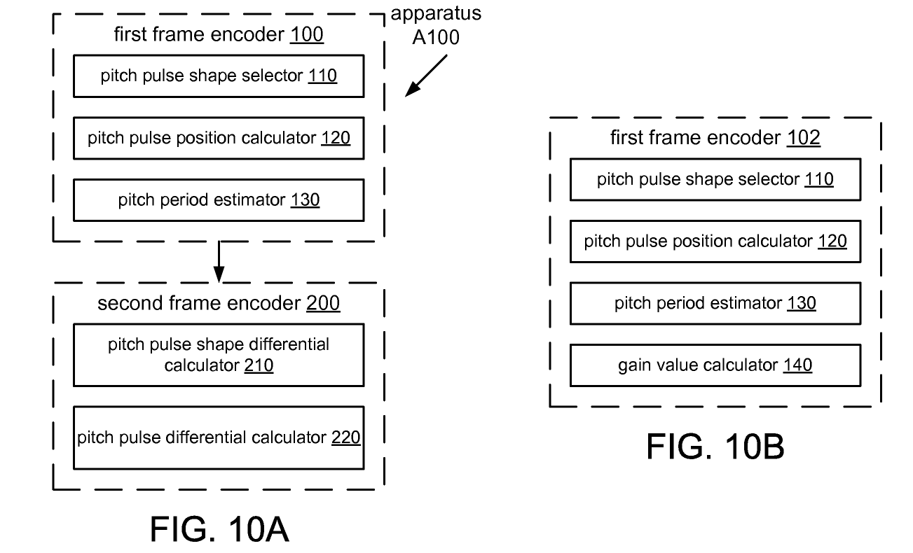

FIG. 10A shows a block diagram of an apparatus for encoding frames of a speech signal A100 according to a general configuration that includes a first frame encoder 100 that is configured to encode a first frame of the speech signal as a first encoded frame and a second frame encoder 200 that is configured to encode a second frame of the speech signal as a second encoded frame, where the second frame follows the first frame. Speech encoder AE10 may be implemented to include an instance of apparatus A100. First frame encoder 100 includes a pitch pulse shape selector 110 that is configured to select one among a set of time-domain pitch pulse shapes based on information from at least one pitch pulse of the first frame (e.g., as described above with reference to various implementations of task E110). Encoder 100 also includes a pitch pulse position calculator 120 that is configured to calculate a position of a terminal pitch pulse of the first frame (e.g., as described above with reference to various implementations of task E120). Encoder 100 also includes a pitch period estimator 130 that is configured to estimate a pitch period of the first frame (e.g., as described above with reference to various implementations of task E130). FIG. 10B shows a block diagram of an implementation 102 of encoder 100 that also includes a gain value calculator 140 that is configured to calculate a set of gain values that correspond to different pitch pulses of the first frame (e.g., as described above with reference to various implementations of task E140).

Second frame encoder 200 includes a pitch pulse shape differential calculator 210 that is configured to calculate a pitch pulse shape differential between a pitch pulse shape of the second frame and a pitch pulse shape of the first frame (e.g., as described above with reference to various implementations of task E210). Encoder 200 also includes a pitch pulse differential calculator 220 that is configured to calculate a pitch period differential between a pitch period of the second frame and a pitch period of the first frame (e.g., as described above with reference to various implementations of task E220).

FIG. 1A shows a block diagram of an apparatus for decoding excitation signals of a speech signal A200 according to a general configuration that includes a first frame decoder 300 and a second frame decoder 400. Decoder 300 is configured to decode a portion of a first encoded frame to obtain a first excitation signal, where the portion includes representations of a time-domain pitch pulse shape, a pitch pulse position, and a pitch period. Decoder 300 includes a first excitation signal generator 310 configured to arrange a first copy of the time-domain pitch pulse shape within the first excitation signal according to the pitch pulse position. Excitation generator 310 is also configured to arrange a second copy of the time-domain pitch pulse shape within the first excitation signal according to the pitch pulse position and the pitch period. For example, generator 310 may be configured to perform implementations of tasks D110 and D120 as described herein. In this example, decoder 300 also includes a synthesis filter 320 that is configured according to a set of LPC coefficient values obtained by decoder 300 from the first encoded frame (e.g., by dequantizing one or more quantized LSP vectors from the first encoded frame and inverse transforming the result) and arranged to filter the excitation signal to obtain a first decoded frame.

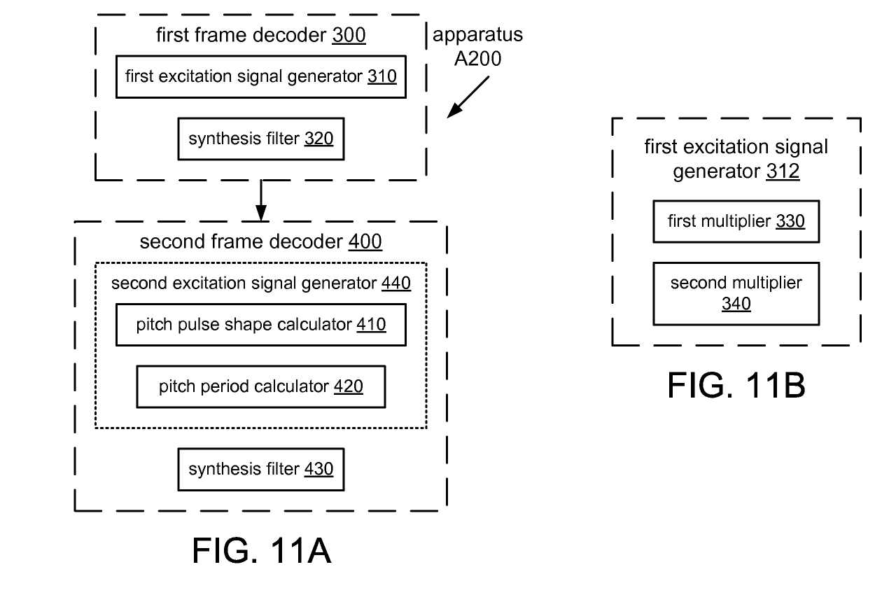

FIG. 11B shows a block diagram of an implementation 312 of first excitation signal generator 310 that includes first and second multipliers 330, 340 for a case in which the portion of the first encoded frame also includes a representation of a set of gain values. First multiplier 330 is configured to apply one of the set of gain values to the first copy of the time-domain pitch pulse shape. For example, first multiplier 330 may be configured to perform an implementation of task D130 as described herein. Second multiplier 340 is configured to apply a different one of the set of gain values to the second copy of the time-domain pitch pulse shape. For example, second multiplier 340 may be configured to perform an implementation of task D140 as described herein. In an implementation of decoder 300 that includes generator 312, synthesis filter 320 may be arranged to filter the resulting gain-adjusted excitation signal to obtain the first decoded frame. First and second multipliers 330, 340 may be implemented using different structures or using the same structure at different times.

Second frame decoder 400 is configured to decode a portion of a second encoded frame to obtain a second excitation signal, where the portion includes representations of a pitch pulse shape differential and a pitch period differential. Decoder 400 includes a second excitation signal generator 440 that includes a pitch pulse shape calculator 410 and a pitch period calculator 420. Pitch pulse shape calculator 410 is configured to calculate a second pitch pulse shape based on the time-domain pitch pulse shape and the pitch pulse shape differential. For example, pitch pulse shape calculator 410 may be configured to perform an implementation of task D210 as described herein. Pitch period calculator 420 is configured to calculate a second pitch period based on the pitch period and the pitch period differential. For example, pitch period calculator 420 may be configured to perform an implementation of task D220 as described herein. Excitation generator 440 is configured to arrange two or more copies of the second pitch pulse shape within the second excitation signal according to the pitch pulse position and the second pitch period. For example, generator 440 may be configured to perform an implementation of task D230 described herein. In this example, decoder 400 also includes a synthesis filter 430 that is configured according to a set of LPC coefficient values obtained by decoder 400 from the first encoded frame (e.g., by dequantizing one or more quantized LSP vectors from the first encoded frame and inverse transforming the result) and arranged to filter the second excitation signal to obtain a second decoded frame. Synthesis filters 320, 430 may be implemented using different structures or using the same structure at different times. Speech decoder AD10 may be implemented to include an instance of apparatus A200.

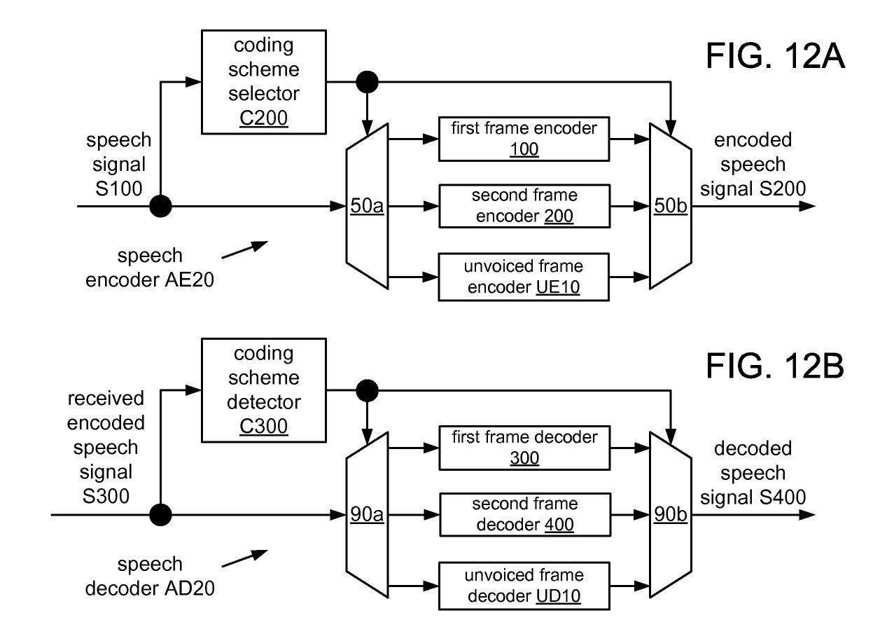

FIG. 12A shows a block diagram of a multi-mode implementation AE20 of speech encoder AE10. Encoder AE20 includes an implementation of first frame encoder 100 (e.g., encoder 102), an implementation of second frame encoder 200, an unvoiced frame encoder UE10 (e.g., a QNELP encoder), and a coding scheme selector C200. Coding scheme selector C200 is configured to analyze characteristics of incoming frames of speech signal S100 (e.g., according to a modified EVRC frame classification scheme as described below) to select an appropriate one of encoders 100, 200, and UE10 for each frame via selectors 50a, 50b. It may be desirable to implement second frame encoder 200 to apply a quarter-rate PPP (QPPP) coding scheme and to implement unvoiced frame encoder UE10 to apply a quarter-rate NELP (QNELP) coding scheme. FIG. 12B shows a block diagram of an analogous multi-mode implementation AD20 of speech encoder AD 10 that includes an implementation of first frame decoder 300 (e.g., decoder 302), an implementation of second frame encoder 400, an unvoiced frame decoder UD10 (e.g., a QNELP decoder), and a coding scheme detector C300. Coding scheme detector C300 is configured to determine formats of encoded frames of received encoded speech signal S300 (e.g., according to one or more mode bits of the encoded frame, such as the first and/or last bits) to select an appropriate corresponding one of decoders 300, 400, and UD10 for each encoded frame via selectors 90a, 90b.

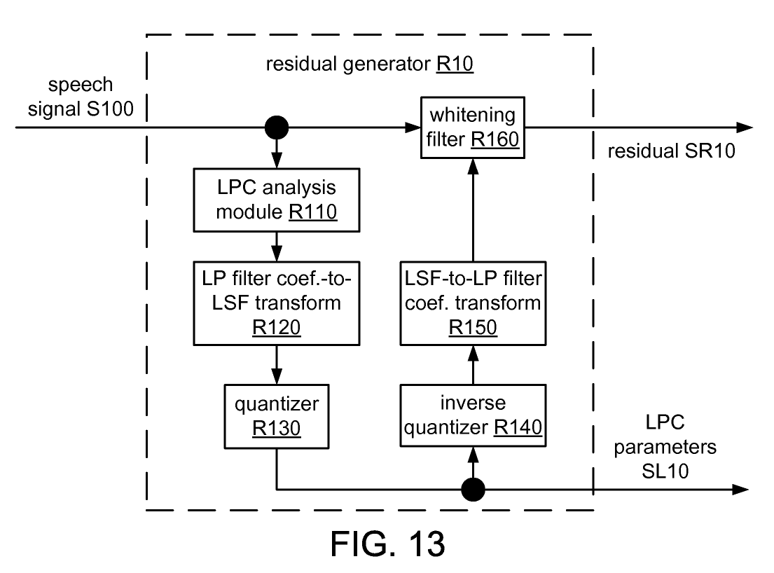

FIG. 13 shows a block diagram of a residual generator R10 that may be included within an implementation of speech encoder AE10. Generator R10 includes an LPC analysis module R110 configured to calculate a set of LPC coefficient values based on a current frame of speech signal S100. Transform block R120 is configured to convert the set of LPC coefficient values to a set of LSFs, and quantizer R130 is configured to quantize the LSFs (e.g., as one or more codebook indices) to produce LPC parameters SL10. Inverse quantizer R140 is configured to obtain a set of decoded LSFs from the quantized LPC parameters SL10, and inverse transform block R150 is configured to obtain a set of decoded LPC coefficient values from the set of decoded LSFs. A whitening filter R160 (also called an analysis filter) that is configured according to the set of decoded LPC coefficient values processes speech signal S100 to produce an LPC residual SR10. Residual generator R10 may also be implemented to generate an LPC residual according to any other design deemed suitable for the particular application. An instance of residual generator R10 may be implemented within and/or shared among any one or more of frame encoders 104, 204, and UE10.

FIG. 14 shows a schematic diagram of a system for satellite communications that includes a satellite 10, ground stations 20a, 20b, and user terminals 30a, 30b. Satellite 10 may be configured to relay voice communications over a half-duplex or full-duplex channel between ground stations 20a and 20b, between user terminals 30a and 30b, or between a ground station and a user terminal, possibly via one or more other satellites. Each of the user terminals 30a, 30b may be a portable device for wireless satellite communications, such as a mobile telephone or a portable computer equipped with a wireless modem, a communications unit mounted within a terrestrial or space vehicle, or another device for satellite voice communications. Each of the ground stations 20a, 20b is configured to route the voice communications channel to a respective network 40a, 40b, which may be an analog or pulse code modulation (PCM) network (e.g., a public switched telephone network or PSTN) and/or a data network (e.g., the Internet, a local area network (LAN), a campus area network (CAN), a metropolitan area network (MAN), a wide area network (WAN), a ring network, a star network, and/or a token ring network). One or both of the ground stations 20a, 20b may also include a gateway that is configured to transcode the voice communications signal to and/or from another form (e.g., analog, PCM, a higher-bit-rate coding scheme, etc.).

The length of the prototype extracted during PWI encoding is typically equal to the current value of the pitch lag, which may vary from frame to frame. Quantizing the prototype for transmission to the decoder thus presents a problem of quantizing a vector whose dimension is variable. In conventional PWI and PPP coding schemes, quantization of the variable-dimension prototype vector is typically performed by converting the time-domain vector to a complex-valued frequency-domain vector (e.g., using a discrete-time Fourier transform (DTFT) operation). Such an operation is described above with reference to pitch pulse shape differential calculation task E210. The amplitude of this complex-valued variable-dimension vector is then sampled to obtain a vector of fixed dimension. The sampling of the amplitude vector may be nonuniform. For example, it may be desirable to sample the vector with higher resolution at low frequencies than at high frequencies.

It may be desirable to perform differential PWI encoding of voiced frames that follow the onset frame. In a full-rate PPP coding mode, the phase of the frequency-domain vector is sampled in a similar manner as the amplitude to obtain a fixed-dimension vector. In a QPPP coding mode, however, no bits are available to carry such phase information to the decoder. In this case, the pitch lag is encoded differentially (e.g., relative to the pitch lag of the previous frame), and the phase information must also be estimated based on information from one or more previous frames. For example, when a transitional frame coding mode (e.g., task E100) is used to encode the onset frame, the phase information for a subsequent frame may be derived from pitch lag and pulse location information.

For encoding onset frames, it may be desirable to perform a procedure that can be expected to detect all of the pitch pulses within the frame. For example, the use of a robust pitch peak detection operation may be expected to provide a better lag estimate and/or phase reference for subsequent frames. Reliable reference values may be especially important for cases in which a subsequent frame is encoded using a relative coding scheme such as a differential coding scheme (e.g., task E200), as such schemes are typically susceptible to error propagation. As noted above, in this description the position of a pitch pulse is indicated by the position of its peak, although in another context the position of a pitch pulse may be equivalently indicated by the position of another feature of the pulse, such as its first or last sample.

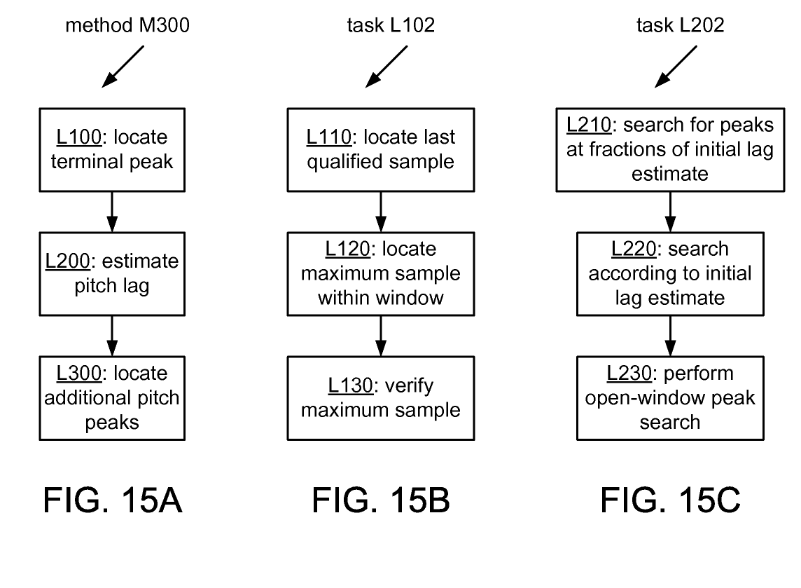

FIG. 15A shows a flowchart of a method M300 according to a general configuration that includes tasks L100, L200, and L300. Task L100 locates a terminal pitch peak of the frame. In a particular implementation, task L100 is configured to select a sample as the terminal pitch peak according to a relation between (A) a quantity that is based on sample amplitude and (B) an average of the quantity for the frame. In one such example, the quantity is sample magnitude (i.e., absolute value), and in this case the frame average may be calculated as:

$$\frac{{\sum }_{i < N} \vert {s}_{i} \vert}{N} \qquad EQ . 1$$

where s denotes sample value (i.e., amplitude), N denotes the number of samples in the frame, and i is a sample index. In another such example, the quantity is sample energy (i.e., amplitude squared), and in this case the frame average may be calculated as:

$$\frac{{\sum }_{i < N} {s}_{i}^{2}}{N} \qquad EQ . 2$$

where s denotes sample value (i.e., amplitude), N denotes the number of samples in the frame, and i is a sample index. In the description below, energy is used.

Task L100 may be configured to locate the terminal pitch peak as the initial pitch peak of the frame or as the final pitch peak of the frame. To locate the initial pitch peak, task L100 may be configured to begin at the first sample of the frame and work forward in time. To locate the final pitch peak, task L100 may be configured to begin at the last sample of the frame and work backward in time. In the particular examples described below, task L100 is configured to locate the terminal pitch peak as the final pitch peak of the frame.

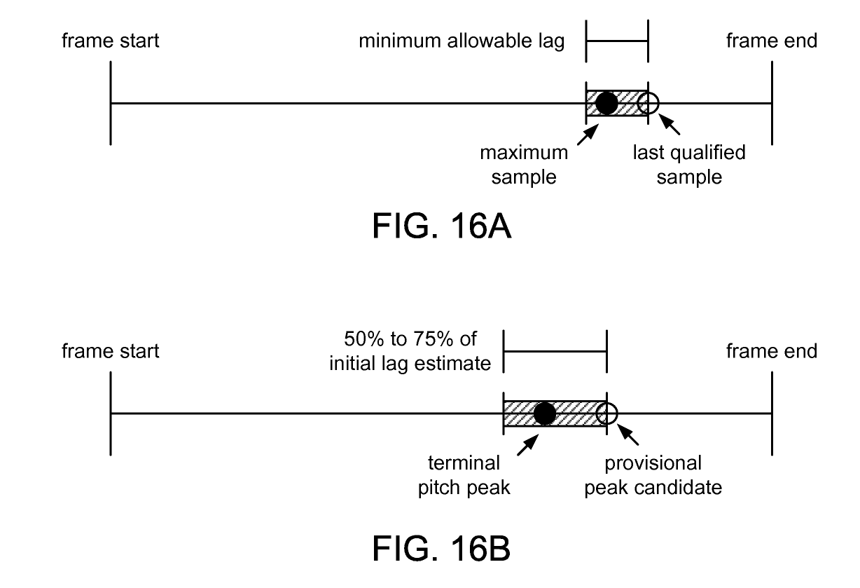

FIG. 15B shows a block diagram of an implementation L102 of task L100 that includes subtasks L110, L120, and L130. Task L110 locates the last sample in the frame that qualifies to be a terminal pitch peak. In this example, task L110 locates the last sample whose energy relative to the frame average exceeds (alternatively, is not less than) a corresponding threshold value TH1. In one example, the value of TH1 is six. If no such sample is found in the frame, method M300 is terminated and another coding mode (e.g., QPPP) is used for the frame. Otherwise, task L120 searches within a window prior to this sample (as shown in FIG. 16A) to find a sample having the greatest amplitude and selects this sample as a provisional peak candidate. It may be desirable for the search window in task L120 to have a width WL1 equal to a minimum allowable lag value. In one example, the value of WL1 is twenty samples. For a case in which more than one sample in the search window has the greatest amplitude, task L120 may be variously configured to select the first such sample, the last such sample, or any other such sample.

Task L130 verifies the final pitch peak selection by finding the sample having the greatest amplitude within a window prior to the provisional peak candidate (as shown in FIG. 16B). It may be desirable for the search window in task L130 to have a width WL2 that is between 50% and 100%, or between 50% and 75%, of an initial lag estimate. The initial lag estimate is typically equal to the most recent lag estimate (i.e., from a previous frame). In one example, the value of WL2 is equal to five-eighths of the initial lag estimate. If the amplitude of the new sample is greater than that of the provisional peak candidate, task L130 selects the new sample instead as the final pitch peak. In another implementation, if the amplitude of the new sample is greater than that of the provisional peak candidate, task L130 selects the new sample as a new provisional peak candidate and repeats the search within a window of width WL2 prior to the new provisional peak candidate until no such sample is found.

Task L200 calculates an estimated lag value for the frame. Task L200 is typically configured to locate the peak of a pitch pulse that is adjacent to the terminal pitch peak and to calculate the lag estimate as the distance between these two peaks. It may be desirable to configure task L200 to search only within the frame boundaries and/or to require the distance between the terminal pitch peak and the adjacent pitch peak to be greater than (alternatively, not less than) a minimum allowable lag value (e.g., twenty samples).

It may be desirable to configure task L200 to use the initial lag estimate to find the adjacent peak. First, however, it may be desirable for task L200 to check the initial lag estimate for pitch doubling errors (which may include pitch tripling and/or pitch quadrupling errors). Typically the initial lag estimate will have been determined using a correlation-based method. Pitch doubling errors are common to correlation-based methods of pitch estimation and are typically quite audible. FIG. 15C shows a flowchart of an implementation L202 of task L200. Task L202 includes an optional but recommended subtask L210 that checks the initial lag estimate for pitch doubling errors. Task L210 is configured to search for pitch peaks within narrow windows at distances of, e.g., ½, ⅓, and ¼ lag from the terminal pitch peak and may be iterated as described below.

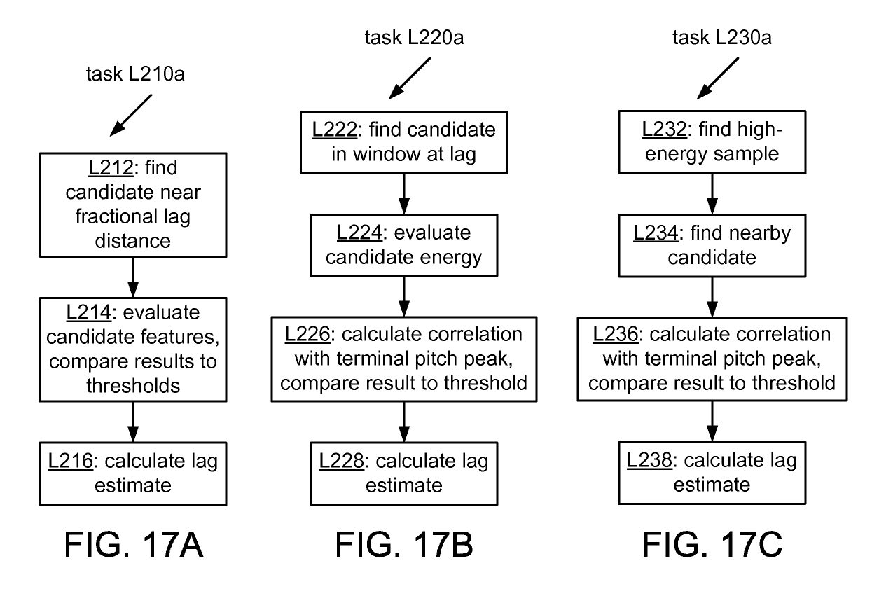

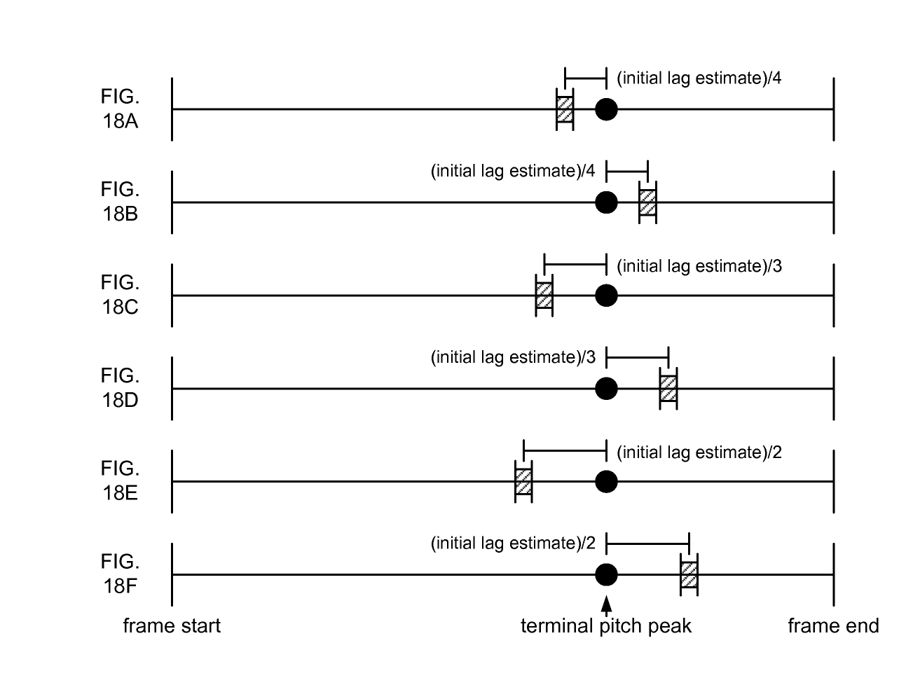

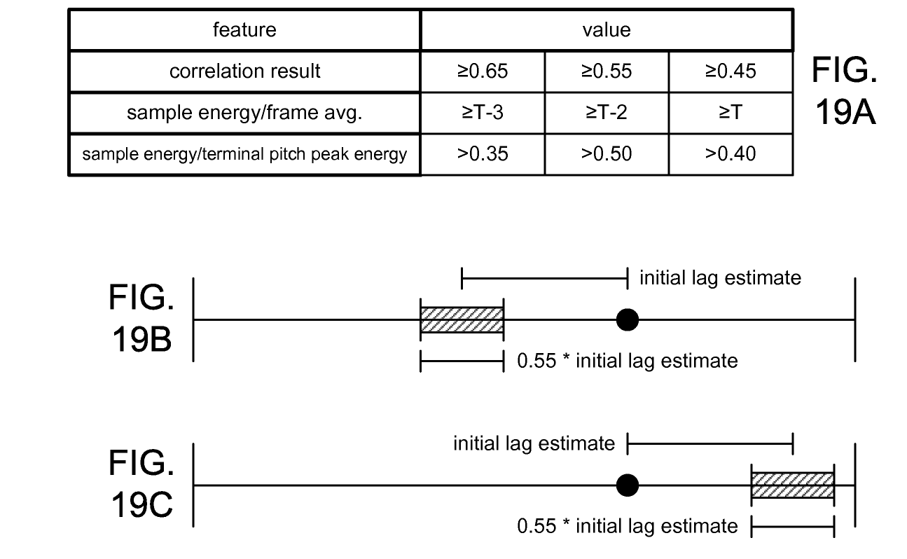

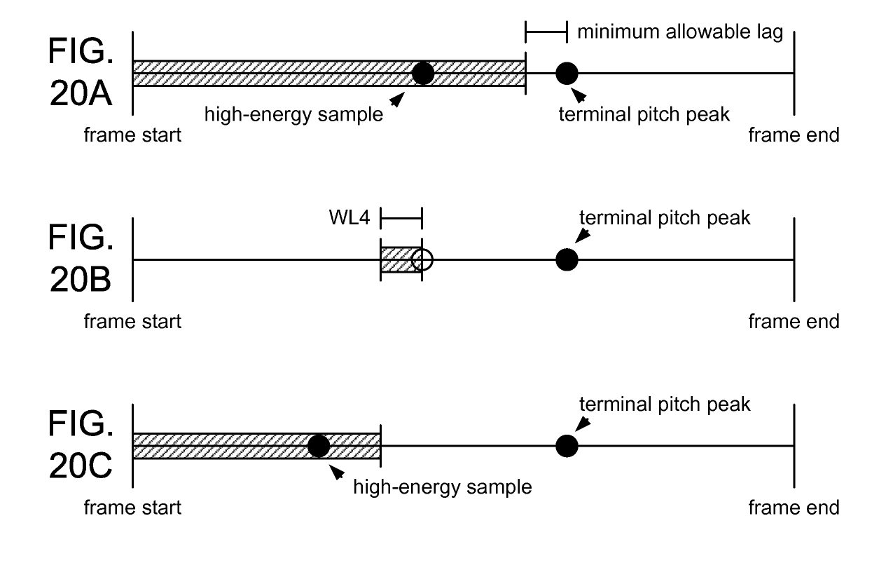

FIG. 17A shows a flowchart of an implementation L210a of task L210 that includes subtasks L212, L214, and L216. For the smallest pitch fraction to be checked (e.g., lag/4), task L212 searches within a small window (e.g., five samples) whose center is offset from the terminal pitch peak by a distance substantially equal to the pitch fraction (e.g., within a truncation or rounding error) to find the sample having the maximum value (e.g., in terms of amplitude, magnitude, or energy). FIG. 18A illustrates such an operation.

Task T214 evaluates one or more features of the maximum-valued sample (i.e., the “candidate”) and compares these values to respective threshold values. The evaluated features may include the sample energy of the candidate, the ratio of the candidate energy to the average frame energy (e.g., the peak-to-RMS energy), and/or the ratio of candidate energy to terminal peak energy. Task L214 may be configured to perform such evaluations in any order, and the evaluations may be performed serially and/or in parallel to each other.

It may also be desirable for task L214 to correlate a neighborhood of the candidate with a similar neighborhood of the terminal pitch peak. For this feature evaluation, task L214 is typically configured to correlate a segment of length N1 samples that is centered at the candidate with a segment of equal length that is centered at the terminal pitch peak. In one example, the value of N1 is equal to seventeen samples. It may be desirable to configure task L214 to perform a normalized correlation (e.g., having a result in the range of from zero to one). It may be desirable to configure task L214 to repeat the correlation for segments of length N1 that are centered at, e.g., one sample before and after the candidate (for example, to account for timing offset and/or sampling error), and to select the largest correlation result. For a case in which the correlation window would extend beyond a frame boundary, it may be desirable to shift or truncate the correlation window. (For a case in which the correlation window is truncated, it may be desirable to normalize the correlation result, unless it is normalized already.) In one example, the candidate is accepted as the adjacent pitch peak if any of the three sets of conditions shown as columns in FIG. 19A are satisfied, where the threshold value T may be equal to six.

If task T214 finds an adjacent pitch peak, task L216 calculates the current lag estimate as the distance between the terminal pitch peak and the adjacent pitch peak. Otherwise, task L210a iterates on the other side of the terminal peak (as shown in FIG. 18B), then alternates between the two sides of the terminal peak for the other pitch fractions to be checked, from smallest to largest, until an adjacent pitch peak is found (as shown in FIGS. 18C to 18F). If the adjacent pitch peak is found between the terminal pitch peak and the closest frame boundary, then the terminal pitch peak is re-labeled as the adjacent pitch peak, and the new peak is labeled as the terminal pitch peak. In an alternative implementation, task L210 is configured to search on the trailing side of the terminal pitch peak (i.e., the side that was already searched in task L100) before the leading side.

If fractional lag test task L210 does not locate a pitch peak, task L220 searches for a pitch peak adjacent to the terminal pitch peak according to the initial lag estimate (e.g., within a window that is offset from the terminal peak position by the initial lag estimate). FIG. 17B shows a flowchart of an implementation L220a of task L220 that includes subtasks L222, L224, L226, and L228. Task L222 finds a candidate (e.g., the sample having the maximum value in terms of amplitude or magnitude) within a window of width WL3 centered around a distance of one lag to the left of the final peak (as shown in FIG. 19B, where the filled circle indicates the terminal pitch peak). In one example, the value of WL3 is equal to 0.55 times the initial lag estimate. Task L224 evaluates the energy of the candidate sample. For example, task L224 may be configured to determine whether a measure of the energy of the candidate (e.g., a ratio of sample energy to frame average energy, such as peak-to-RMS energy) is greater than (alternatively, not less than) a corresponding threshold TH3. Example values of TH3 include 1, 1.5, 3, and 6.

Task L226 correlates a neighborhood of the candidate with a similar neighborhood of the terminal pitch peak. Task L226 is typically configured to correlate a segment of length N2 samples that is centered at the candidate with a segment of equal length that is centered at the terminal pitch peak. Examples of values for N2 include ten, eleven, and seventeen samples. It may be desirable to configure task L226 to perform a normalized correlation. It may be desirable to configure task L226 to repeat the correlation for segments centered at, e.g., one sample before and after the candidate (for example, to account for timing offset and/or sampling error), and to select the largest correlation result. For a case in which the correlation window would extend beyond a frame boundary, it may be desirable to shift or truncate the correlation window. (For a case in which the correlation window is truncated, it may be desirable to normalize the correlation result, unless it is normalized already.) Task L226 also determines whether the correlation result is greater than (alternatively, not less than) a corresponding threshold TH4. Example values of TH4 include 0.75, 0.65, and 0.45. The tests of tasks L224 and L226 may be combined according to different sets of values for TH3 and TH4. In one such example, the results of L224 and L226 are positive if any of the following sets of values produces positive results: TH3=1 and TH4=0.75; TH3=1.5 and TH4=0.65; TH3=3 and TH4=0.45; TH3=6 (in this case, the result of task L226 is taken to be positive).

If the results of tasks L224 and L226 are positive, the candidate is accepted as the adjacent pitch peak, and task T228 calculates the current lag estimate as the distance between this sample and the terminal pitch peak. Tasks L224 and L226 may execute in either order and/or parallel with one another. Task L220 may also be implemented to include only one of tasks L224 and L226. If task L220 concludes without finding an adjacent pitch peak, it may be desirable to iterate task L220 on the trailing side of the terminal pitch peak (as shown in FIG. 19C, where the filled circle indicates the terminal pitch peak).

If neither one of tasks L210 and L220 locates a pitch peak, task L230 performs an open window search for a pitch peak on the leading side of the terminal pitch peak. FIG. 17C shows a flowchart of an implementation L230a of task L230 that includes subtasks L232, L234, L236, and L238. Starting at a sample some distance D1 away from the terminal pitch peak, task L232 finds a sample whose energy relative to the average frame energy exceeds (alternatively, is not less than) a threshold value (e.g., TH1). FIG. 20A illustrates such an operation. In one example, the value of D1 is a minimum allowable lag value, such as twenty samples. Task L234 finds a candidate (e.g., the sample having the maximum value in terms of amplitude or magnitude) within a window of width WL4 of this sample (as shown in FIG. 20B). In one example, the value of WL4 is equal to twenty samples.

Task L236 correlates a neighborhood of the candidate with a similar neighborhood of the terminal pitch peak. Task L236 is typically configured to correlate a segment of length N3 samples that is centered at the candidate with a segment of equal length that is centered at the terminal pitch peak. In one example, the value of N3 is equal to eleven samples. It may be desirable to configure task L326 to perform a normalized correlation. It may be desirable to configure task L326 to repeat the correlation for segments centered at, e.g., one sample before and after the candidate (for example, to account for timing offset and/or sampling error) and to select the largest correlation result. For a case in which the correlation window would extend beyond a frame boundary, it may be desirable to shift or truncate the correlation window. (For a case in which the correlation widow is truncated, it may be desirable to normalize the correlation result, unless it is already normalized.) Task T326 determines whether the correlation result exceeds (alternatively, is not less than) a threshold value TH5. In one example, the value of TH5 is equal to 0.45. If the result of task L236 is positive, the candidate is accepted as the adjacent pitch peak, and task T238 calculates the current lag estimate as the distance between this sample and the terminal pitch peak. Otherwise, task L230a iterates across the frame (e.g., starting at the left side of the previous search window, as shown in FIG. 20C) until a pitch peak is found or the search is exhausted.

When lag estimation task L200 has concluded, task L300 executes to locate any other pitch pulses in the frame. Task L300 may be implemented to use correlation and the current lag estimate to locate more pulses. For example, task L300 may be configured to use criteria such as correlation and sample-to-RMS energy values to test maximum-valued samples within narrow windows around the lag estimate. As compared to lag estimation task L200, task L300 may be configured to use a smaller search window and/or relaxed criteria (e.g., lower threshold values), especially if a peak adjacent to the terminal pitch peak has already been found. For example, in an onset or other transitional frame, the pulse shape may change such that some pulses within the frame may not be strongly correlated, and it may be desirable to relax or even to ignore the correlation criterion for pulses after the second one, so long as the amplitude of the pulse is sufficiently high and the location is correct (e.g., according to the current lag value). It may be desirable to minimize the probability of missing a valid pulse, and especially for large lag values, the voiced part of a frame may not be very peaky. In one example, method M300 allows a maximum of eight pitch pulses per frame.

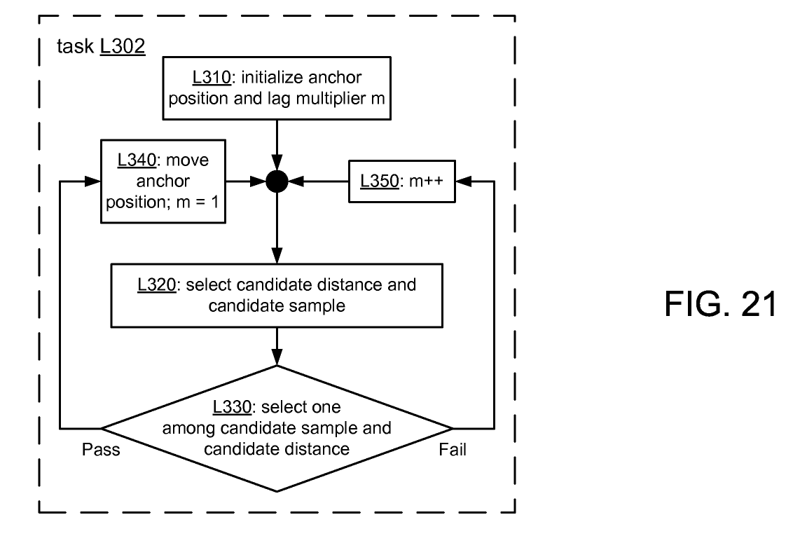

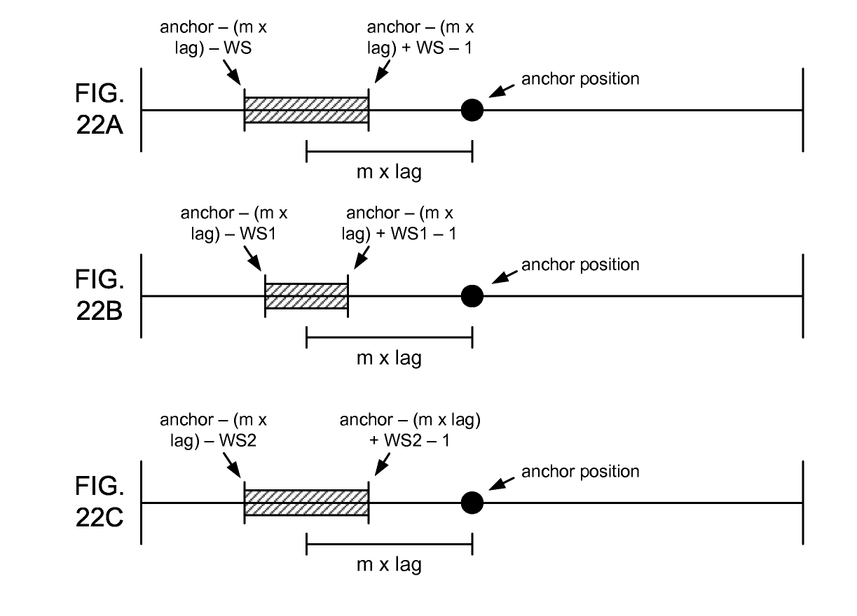

Task L300 may be implemented to calculate two or more different candidates for the next pitch peak and to select the pitch peak according to one of these candidates. For example, task L300 may be configured to select a candidate sample, based on the sample value, and to calculate a candidate distance, based on a correlation result. FIG. 21 shows a flowchart for an implementation L302 of task L300 that includes subtasks L310, L320, L330, L340, and L350. Task L310 initializes an anchor position for the candidate search. For example, task L310 may be configured to use the position of the most recently accepted pitch peak as the initial anchor position. In a first iteration of task L302, for example, the anchor position may be the position of the pitch peak adjacent to the terminal pitch peak, if such a peak was located by task L200, or the position of the terminal pitch peak otherwise. It may also be desirable for task L310 to initialize a lag multiplier m (e.g., to a value of one).

Task L320 selects the candidate sample and calculates the candidate distance. Task L320 may be configured to search for these candidates within a window as shown in FIG. 22A, where the large bounded horizontal line indicates the current frame, the left large vertical line indicates the frame start, the right large vertical line indicates the frame end, the dot indicates the anchor position, and the shaded box indicates the search window. In this example, the window is centered at a sample whose distance from the anchor position is the product of the current lag estimate and the lag multiplier m, and the window extends WS samples to the left (i.e., backward in time) and (WS−1) samples to the right (i.e., forward in time).

Task L320 may be configured to initialize the window size parameter WS to a value of one-fifth of the current lag estimate. It may be desirable for window size parameter WS to have at least a minimum value, such as twelve samples. Alternatively, if a pitch peak adjacent to the terminal pitch peak has not been found yet, it may be desirable for task L320 to initialize window size parameter WS to a possibly larger value, such as one-half of the current lag estimate.

To find the candidate sample, task L320 searches the window to find the sample having the maximum value and records this sample's location and value. Task L320 may be configured to select the sample whose value has the highest amplitude within the search window. Alternatively, task L320 may be configured to select the sample whose value has the highest magnitude, or the highest energy, within the search window.

The candidate distance corresponds to the sample within the search window at which the correlation with the anchor position is highest. To find this sample, task L320 correlates a neighborhood of each sample in the window with a similar neighborhood of the anchor position and records the maximum correlation result and the corresponding distance. Task L320 is typically configured to correlate a segment of length N4 samples that is centered at each test sample with a segment of equal length that is centered at the anchor position. In one example, the value of N4 is eleven samples. It may be desirable for task L320 to perform a normalized correlation.

As stated above, task T320 may be configured to use the same search window to find the candidate sample and the candidate distance. However, task T320 may also be configured to use different search windows for these two operations. FIG. 22B shows an example in which task L320 performs the search for the candidate sample over a window having a size parameter WS1, and FIG. 22C shows an example in which the same instance of task L320 performs the search for the candidate distance over a window having a size parameter WS2 of a different value.

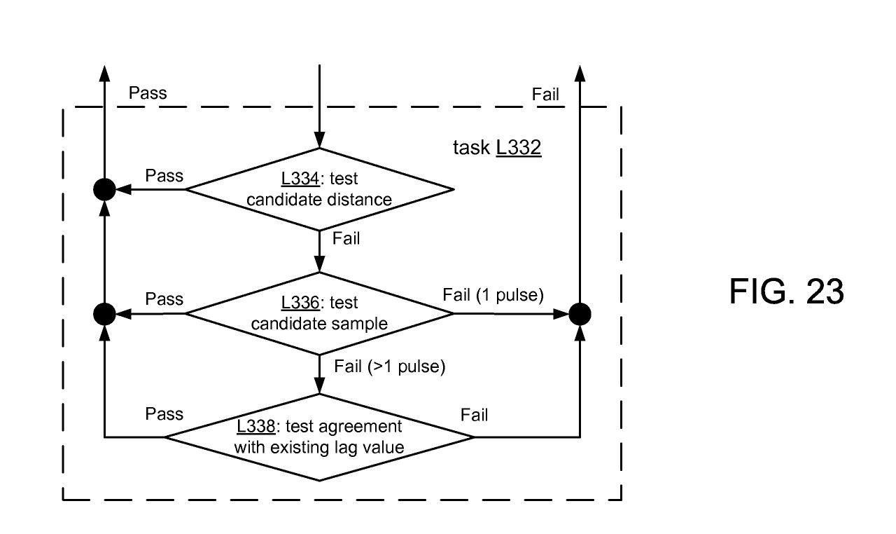

Task L302 includes a subtask L330 that selects one among the candidate sample and the sample that corresponds to the candidate distance as a pitch peak. FIG. 23 shows a flowchart of an implementation L332 of task L330 that includes subtasks L334, L336, and L338.

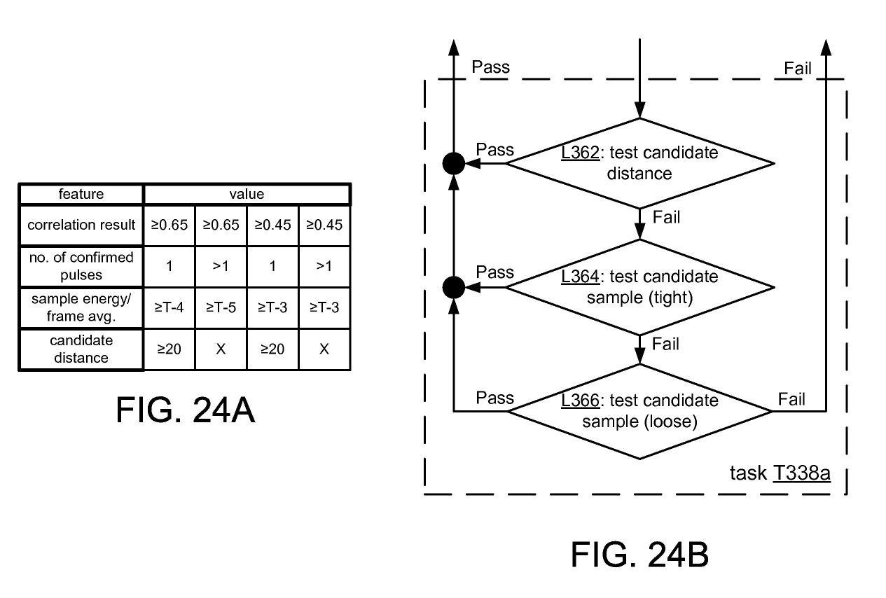

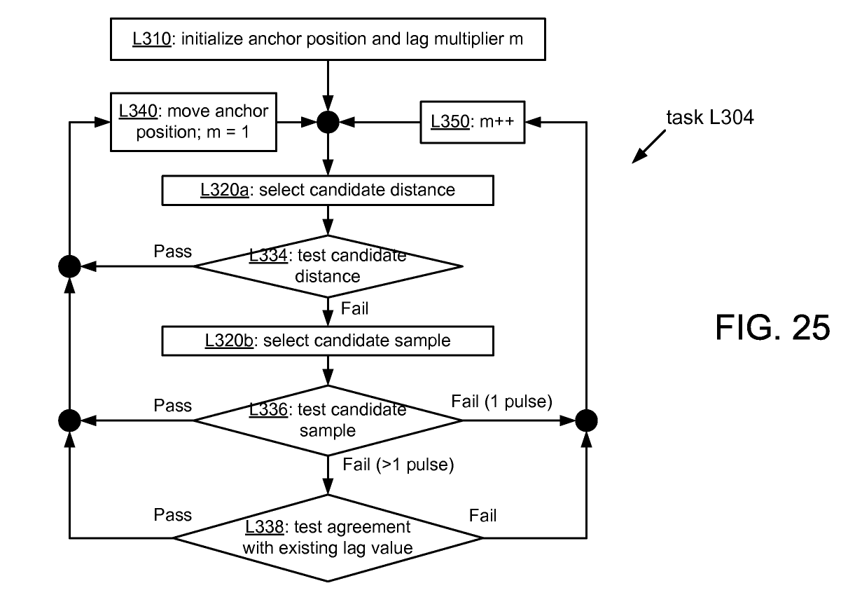

Task L334 tests the candidate distance. Task L334 is typically configured to compare the correlation result to a threshold value. It may also be desirable for task L334 to compare a measure based on the energy of the corresponding sample (e.g., the ratio of sample energy to frame average energy) to a threshold value. For a case in which only one pitch pulse has been identified, task L334 may be configured to verify that the candidate distance is at least equal to a minimum value (e.g., a minimum allowable lag value, such as twenty samples). The columns of the table of FIG. 24A show four different sets of test conditions based on the values of such parameters that may be used by an implementation of task L334 to determine whether to accept the sample that corresponds to the candidate distance as a pitch peak.

For a case in which task L334 accepts the sample that corresponds to the candidate distance as a pitch peak, it may be desirable to adjust the peak location to the left or right (for example, by one sample) if that sample has a higher amplitude (alternatively, a higher magnitude). Alternatively or additionally, it may be desirable in such a case for task L334 to set the value of window size parameter WS to a smaller value (e.g., ten samples) for further iterations of task L300 (or to set one or both of parameters WS1 and WS2 to such a value). If the new pitch peak is only the second one confirmed for the frame, it may also be desirable for task L334 to calculate the current lag estimate as the distance between the anchor position and the peak location.

Task L302 includes a subtask L336 that tests the candidate sample. Task L336 may be configured to determine whether a measure of the sample energy (e.g., the ratio of sample energy to frame average energy) exceeds (alternatively, is not less than) a threshold value. It may be desirable to vary the threshold value depending on how many pitch peaks have been confirmed for the frame. For example, it may be desirable for task L336 to use a lower threshold value (e.g., T-3) if only one pitch peak has been confirmed for the frame, and to use a higher threshold value (e.g., T) if more than one pitch peak has already been confirmed for the frame.

For a case in which task L336 selects the candidate sample as the second confirmed pitch peak, it may also be desirable for task L336 to adjust the peak location to the left or right (for example, by one sample) based on results of correlation with the terminal pitch peak. In such case, task L336 may be configured to correlate a segment of length N5 samples that is centered at each such sample with a segment of equal length that is centered at the terminal pitch peak (in one example, the value of N5 is eleven samples). Alternatively or additionally, it may be desirable in such a case for task L336 to set the value of window size parameter WS to a smaller value (e.g., ten samples) for further iterations of task L300 (or to set one or both of parameters WS1 and WS2 to such a value).

For a case in which both of test tasks L334 and L336 have failed and only one pitch peak has been confirmed for the frame, task L302 may be configured to increment the value of lag estimate multiplier m (via task L350), to iterate task L320 at the new value of m to select a new candidate sample and a new candidate distance, and to repeat task L332 for the new candidates.

As shown in FIG. 23, task L336 may be arranged to execute upon failure of candidate distance test task L334. In another implementation of task T332, candidate sample test task L336 may be arranged to execute first, such that candidate distance test task L334 executes only upon failure of task L336.

Task L332 also includes a subtask L338. For a case in which both of test tasks L334 and L336 have failed and more than one pitch peak has already been confirmed for the frame, task L338 tests agreement of one or both of the candidates with the current lag estimate.

FIG. 24B shows a flowchart for an implementation L338a of task L338. Task L338a includes a subtask L362 that tests the candidate distance. If the absolute difference between the candidate distance and the current lag estimate is less than (alternatively, not greater than) a threshold value, then task L362 accepts the candidate distance. In one example, the threshold value is three samples. It may also be desirable for task L362 to verify that the correlation result and/or the energy of the corresponding sample are acceptably high. In one such example, task L362 accepts a candidate distance that is less than (alternatively, not greater than) the threshold value if the correlation result is not less than 0.35 and the ratio of sample energy to frame average energy is not less than 0.5. For a case in which task L362 accepts the candidate distance, it may also be desirable for task L362 to adjust the peak location to the left or right (e.g., by one sample) if that sample has a higher amplitude (alternatively, a higher magnitude).

Task L338a also includes a subtask L364 that tests the lag agreement of the candidate sample. If the absolute difference between (A) the distance between the candidate sample and the closest pitch peak and (B) the current lag estimate is less than (alternatively, not greater than) a threshold value, then task L364 accepts the candidate sample. In one example, the threshold value is a low value, such as two samples. It may also be desirable for task L364 to verify that the energy of the candidate sample is acceptably high. In one such example, task L364 accepts the candidate sample if it passes the lag agreement test and if the ratio of sample energy to frame average energy is not less than (T-5).

The implementation of task L338a shown in FIG. 24B also includes another subtask L366, which tests the lag agreement of the candidate sample against a looser bound than the low threshold value of task L364. If the absolute difference between (A) the distance between the candidate sample and the closest confirmed peak and (B) the current lag estimate is less than (alternatively, not greater than) a threshold value, then task L366 accepts the candidate sample. In one example, the threshold value is (0.175* lag). It may also be desirable for task L366 to verify that the energy of the candidate sample is acceptably high. In one such example, task L366 accepts the candidate sample if the ratio of sample energy to frame average energy is not less than (T-3).

If both of the candidate sample and the candidate distance fail all tests, task T302 increments the lag estimate multiplier m (via task T350), iterates task L320 at the new value of m to select a new candidate sample and a new candidate distance, and repeats task L330 for the new candidates until the frame boundary is reached. Once a new pitch peak has been confirmed, it may be desirable to search for another peak in the same direction until the frame boundary is reached. In this case, task L340 moves the anchor position to the new pitch peak and resets the value of lag estimate multiplier m to one. When the frame boundary is reached, it may be desirable to initialize the anchor position to the terminal pitch peak position and repeat task L300 in the opposite direction.

A large reduction in the lag estimate from one frame to the next may indicate a pitch overflow error. Such an error is caused by a drop in pitch frequency such that the lag value for the current frame exceeds the maximum allowable lag value. It may be desirable for method M300 to compare an absolute or relative difference between the previous and current lag estimates to a threshold value (e.g., when a new lag estimate is calculated, or at the end of the method) and to keep only the largest pitch peak of the frame if an error is detected. In one example, the threshold value is equal to 50% of the previous lag estimate.

For frames classified as transient (e.g., frames having a large pitch change, typically toward the end of a word) that have two pulses with a large magnitude squared ratio, it may be desirable to correlate over the entire current lag estimate, rather than over just a small window, before accepting the smaller peak as the a pitch peak. Such a case may arise with male voices, which typically have secondary peaks that may correlate well with the main peak over a small window. One of both of tasks L200 and L300 may be implemented to include such an operation.

It is expressly noted that lag estimation task L200 of method M300 may be the same task as lag estimation task E130 of method M100. It is expressly noted that terminal pitch peak location task L100 of method M300 may be the same task as terminal pitch peak position calculation task E120 of method M100. For an application in which both of methods M100 and M300 are executed, it may be desirable to arrange pitch pulse shape selection task E110 to execute upon conclusion of method M300.

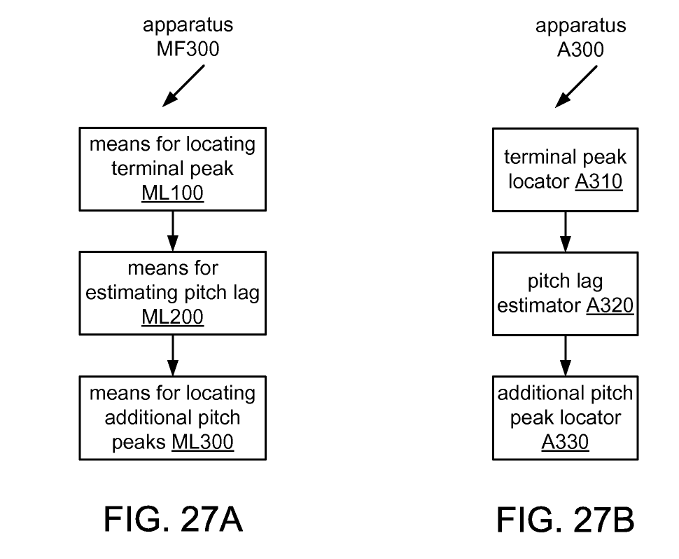

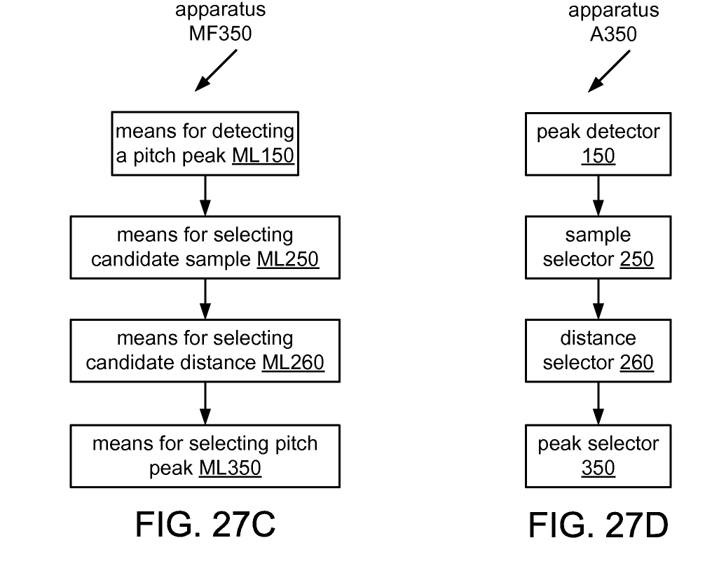

FIG. 27A shows a block diagram of an apparatus MF300 that is configured to detect pitch peaks of a frame of a speech signal. Apparatus MF300 includes means ML100 for locating a terminal pitch peak of the frame (e.g., as described above with reference to various implementations of task L100). Apparatus MF300 includes means ML200 for estimating a pitch lag of the frame (e.g., as described above with reference to various implementations of task L200). Apparatus MF300 includes means ML300 for locating additional pitch peaks of the frame (e.g., as described above with reference to various implementations of task L300).

FIG. 27B shows a block diagram of an apparatus A300 that is configured to detect pitch peaks of a frame of a speech signal. Apparatus A300 includes a terminal pitch peak locator A310 that is configured to locate a terminal pitch peak of the frame (e.g., as described above with reference to various implementations of task L100). Apparatus A300 includes a pitch lag estimator A320 that is configured to estimate a pitch lag of the frame (e.g., as described above with reference to various implementations of task L200). Apparatus A300 includes an additional pitch peak locator A330 that is configured to locate additional pitch peaks of the frame (e.g., as described above with reference to various implementations of task L300).

FIG. 27C shows a block diagram of an apparatus MF350 that is configured to detect pitch peaks of a frame of a speech signal. Apparatus MF350 includes means ML150 for detecting a pitch peak of the frame (e.g., as described above with reference to various implementations of task L100). Apparatus MF350 includes means ML250 for selecting a candidate sample (e.g., as described above with reference to various implementations of task L320 and L320b). Apparatus MF350 includes means ML260 for selecting a candidate distance (e.g., as described above with reference to various implementations of task L320 and L320a). Apparatus MF350 includes means ML350 for selecting, as a pitch peak of the frame, one among the candidate sample and a sample that corresponds to the candidate distance (e.g., as described above with reference to various implementations of task L330).

FIG. 27D shows a block diagram of an apparatus A350 that is configured to detect pitch peaks of a frame of a speech signal. Apparatus A350 includes a peak detector 150 configured to detect a pitch peak of the frame (e.g., as described above with reference to various implementations of task L100). Apparatus A350 includes a sample selector 250 configured to select a candidate sample (e.g., as described above with reference to various implementations of task L320 and L320b). Apparatus A350 includes a distance selector 260 configured to select a candidate distance (e.g., as described above with reference to various implementations of task L320 and L320a). Apparatus A350 includes a peak selector 350 configured to select, as a pitch peak of the frame, one among the candidate sample and a sample that corresponds to the candidate distance (e.g., as described above with reference to various implementations of task L330).

It may be desirable to implement task E100, first frame encoder 100, and/or means FE100 to produce an encoded frame that uniquely indicates the position of the terminal pitch pulse of the frame. The position of the terminal pitch pulse, combined with the lag value, provides important phase information for the following frame, which may lack such time-synchrony information (e.g., QPPP). It may also be desirable to minimize the number of bits needed to convey such information. Although eight bits (┐log₂ N┌ bits) would normally be needed to represent a unique position in a 160-bit (N-bit) frame, a method as described herein may be used to encode the position of the terminal pitch pulse in only seven bits (└log₂ N┘ bits). This method reserves one of the seven-bit values (in this example, 127 (2^{└log}^{₂} ^{N┘}−1)) for use as a mode value.

For a situation in which the position of the terminal pitch pulse is given relative to the last sample, the frame will match one of the following three cases:

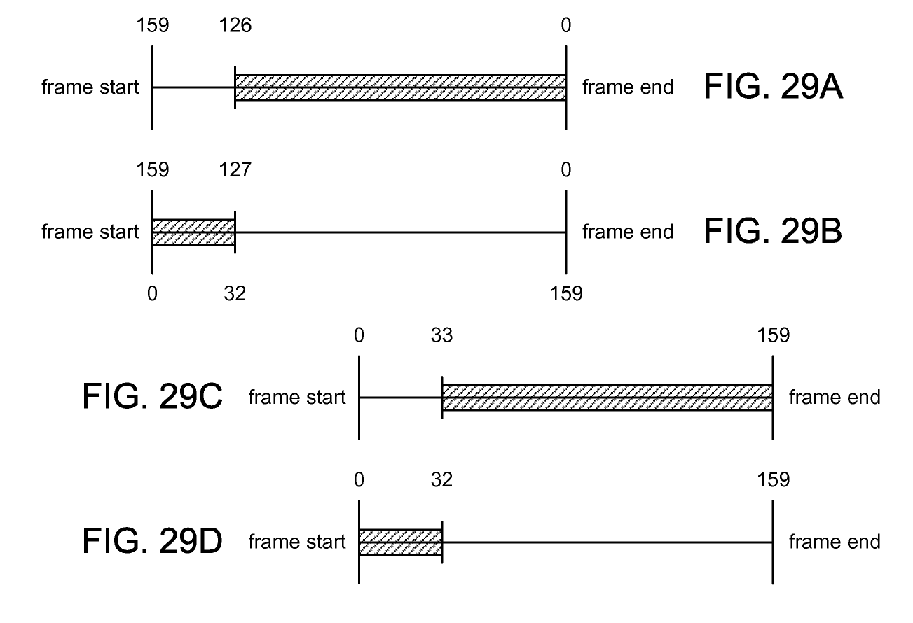

Case 1: The position of the terminal pitch pulse relative to the last sample of the frame is less than (2^{└log}^{₂} ^{N┘}−1) (e.g., less than 127, for a 160-bit frame as shown in FIG. 29A), and the frame contains more than one pitch pulse. In this case, the position of the terminal pitch pulse is encoded into └log₂ N┘ bits (seven bits), and the pitch lag is also transmitted (e.g., in seven bits).

Case 2: The position of the terminal pitch pulse relative to the last sample of the frame is less than (2^{└log}^{₂} ^{N┘}−1) (e.g., less than 127, for a 160-bit frame as shown in FIG. 29A), and the frame contains only one pitch pulse. In this case, the position of the terminal pitch pulse is encoded into └log₂ N┘ bits (e.g., seven bits), and the pitch lag is set to the mode value (e.g., 127).

Case 3: If the position of the terminal pitch pulse relative to the last sample of the frame is greater than (2^{└log}^{₂} ^{N┘}−2) (e.g., greater than 126, for a 160-bit frame as shown in FIG. 29B), it is unlikely that the frame contains more than one pitch pulse. For a 160-bit frame and a sampling rate of 8 kHz, this would imply activity at a pitch of at least 250 Hz in about the first twenty percent of the frame, with no pitch pulses in the remainder of the frame. It would be unlikely for such a frame to be classified as an onset frame. In this case, the number (2^{└log}^{₂} ^{N┘}−1) (e.g., 127) is transmitted in place of the actual pulse position, and the lag bits are used to carry the position of the terminal pitch pulse with respect to the first sample of the frame. A corresponding decoder may be configured to test whether the position bits of the encoded frame indicate a pulse position of (2^{└log}^{₂} ^{N┘}−1). If so, the decoder may then obtain the position of the terminal pitch pulse with respect to the first sample of the frame from the lag bits instead.

In case 3 as applied to a 160-bit frame, thirty-three such positions are possible (i.e., zero through 32). By rounding one of the positions into another (e.g., by rounding position 159 to position 158, or by rounding position 127 to position 128), the actual position can be transmitted in only five bits, leaving two of the seven lag bits free to carry other information.

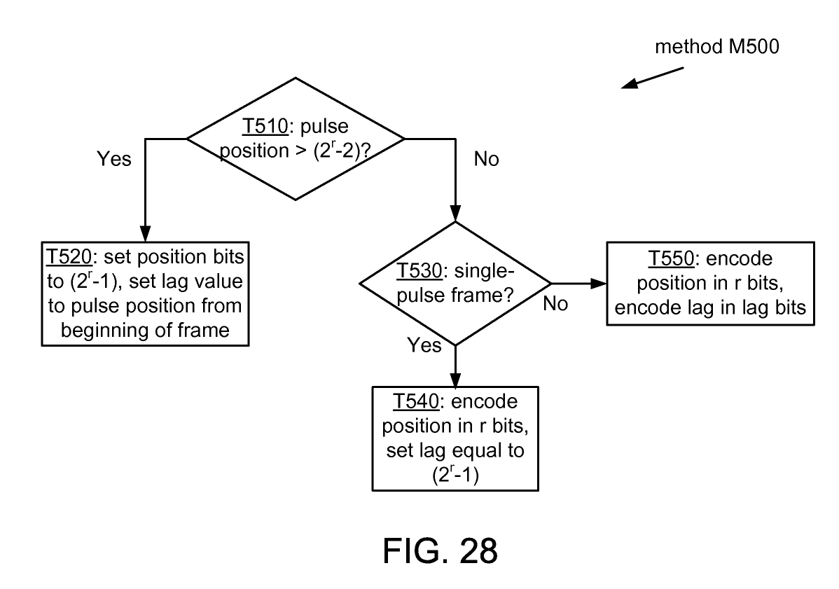

FIG. 28 shows a flowchart of a method M500 according to a general configuration that operates according to the three cases above. Method M500 is configured to encode the position of the terminal pitch pulse in a q-bit frame using r bits, where r is less than log₂ q. In one example as discussed above, q is equal to 160 and r is equal to seven. Method M500 may be performed within an implementation of task E100 (e.g., within task E120), by an implementation of first frame encoder 100 (e.g., by pitch pulse position calculator 120), an/or by an implementation of means FE100 (e.g., by means FE120).

Method M500 includes tasks T510, T520, and T530. Task T510 determines whether the terminal pitch pulse position (relative to the end of the frame) is greater than (2^{r}−2) (e.g., greater than 126). If the result is true, then the frame matches case three above. In this case, task T520 sets the terminal pitch pulse position bits to (2^{r}−1) (e.g., to 127) and sets the lag bits equal to the position of the terminal pitch pulse relative to the beginning of the frame.

If the result of task T510 is false, then task T530 determines whether the frame contains only one pitch pulse. If the result of task T530 is true, then the frame matches case two above, and there is no need to transmit a lag value. In this case, task T540 sets the lag bits to the mode value (2^{r}−1).

If the result of task T530 is false, then the frame contains more than one pitch pulse and the position of the terminal pitch pulse relative to the end of the frame is not greater than (2^{r}−2) (e.g., is not greater than 126). Such a frame matches case one above, and task T550 encodes the position in r bits and encodes the lag value into the lag bits.

For a situation in which the position of the terminal pitch pulse is given relative to the first sample, the frame will match one of the following three cases:

Case 1: The position of the terminal pitch pulse relative to the first sample of the frame is greater than (N−2^{└log}^{₂} ^{N┘}) (e.g., greater than 32, for a 160-bit frame as shown in FIG. 29C), and the frame contains more than one pitch pulse. In this case, the position of the terminal pitch pulse minus (N−2^{└log}^{₂} ^{N┘}) is encoded into └log₂ N┘ bits (e.g., seven bits), and the pitch lag is also transmitted (e.g., in seven bits).

Case 2: The position of the terminal pitch pulse relative to the first sample of the frame is greater than (2^{└log}^{₂} ^{N┘}−1) (e.g., greater than 32, for a 160-bit frame as shown in FIG. 29C), and the frame contains only one pitch pulse. In this case, the position of the terminal pitch pulse minus (N−2^{└log}^{₂} ^{N┘}) is encoded into └log₂ N┘ bits (e.g., seven bits), and the pitch lag is set to as the mode value (2^{└log}^{₂} ^{N┘}−1) (e.g., 127).

Case 3: If the position of the terminal pitch pulse is not greater than (N−2^{└log}^{₂} ^{N┘}) (e.g., not greater than 32, for a 160-bit frame as shown in FIG. 29D), it is unlikely that the frame contains more than one pitch pulse. For a 160-bit frame and a sampling rate of 8 kHz, this would imply activity at a pitch of at least 250 Hz in about the first twenty percent of the frame, with no pitch pulses in the remainder of the frame. It would be unlikely for such a frame to be classified as an onset frame. In this case, the number (2^{└log}^{₂} ^{N┘}) (e.g., 127) is transmitted in place of the actual pulse position, and the lag bits are used to transmit the position of the terminal pitch pulse with respect to the first sample of the frame. A corresponding decoder may be configured to test whether the position bits of the encoded frame indicate a pulse position of (2^{└log}^{₂} ^{N┘}−1). If so, the decoder may then obtain the position of the terminal pitch pulse with respect to the first sample of the frame from the lag bits instead.

In case 3 as applied to a 160-bit frame, thirty-three such positions are possible (zero through 32). By rounding one of the positions into another (e.g., by rounding position 0 to position 1, or by rounding position 32 to position 31), the actual position can be transmitted in only five bits, leaving two of the seven lag bits free to carry other information. One of skill in the art will recognize that method M500 may be modified for a situation in which the position of the terminal pitch pulse is given relative to the first sample.

Quarter-rate allows forty bits per frame. In one example of a transitional frame coding format as applied by an implementation of encoding task E100, encoder 100, or means FE100, a region of seventeen bits is used to indicate LSPs and encoding mode, a region of seven bits is used to indicate the position of the terminal pitch pulse, a region of seven bits is used to indicate lag, a region of seven bits is used to indicate pulse shape, and a region of two bits is used to indicate gain profile. Other examples include formats in which the region for LSPs is smaller and the region for gain profile is correspondingly larger.

A corresponding decoder (e.g., an implementation of decoder 300 or means FD100 or a device performing an implementation of decoding task D100) may be configured to construct the excitation signal from the pulse shape VQ table output by copying the indicated pulse to each of the locations indicated by the terminal pitch pulse location and the lag value and scaling the resulting signal according to the gain VQ table output. For a case in which the indicated pulse is longer than the lag value, any overlap between adjacent pulses may be handled by averaging each pair of overlapped values, by selecting one value of each pair (e.g., the highest or lowest value, or the value belonging to the pulse on the left or on the right), or by simply discarding the samples beyond the lag value.

The pitch pulses of an excitation signal are not simply impulses or spikes. Rather, a pitch pulse typically has an amplitude profile or shape over time that is speaker-dependent, and preserving this shape may be important for speaker recognition. It may be desirable to encode a good representation of pulse shape to serve as a reference (e.g., a prototype) for subsequent voiced frames.

The shapes of the pitch pulses provide information that is perceptually important for speaker identification and recognition. In order to provide this information to the decoder, a transitional frame coding mode (e.g., as performed by an implementation of task E100, encoded 100, or means FE100) may be configured to include pulse shape information in the encoded frame. Encoding the pulse shape may present a problem of quantizing a vector whose dimension is variable. For example, the length of the pitch period in the residual, and thus the length of the pitch pulse, may vary over a wide range. In one example, the allowable pitch lag value ranges from 20 to 146 samples.

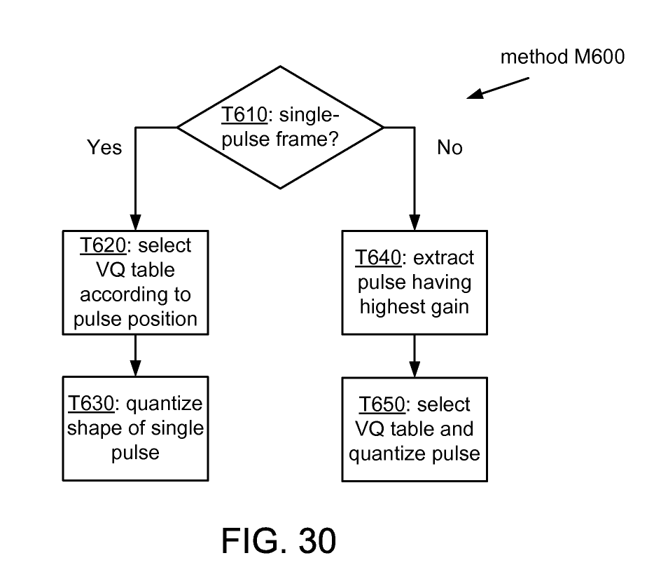

It may be desirable to encode the shape of a pitch pulse without converting the pulse to the frequency domain. FIG. 30 shows a flowchart of a method M600 according to a general configuration may be performed within an implementation of task E100 (e.g., within task E110), by an implementation of first frame encoder 100 (e.g., by pitch pulse shape selector 110), and/or by an implementation of means FE100 (e.g., by means FE110). Method M600 includes tasks T610, T620, T630, T640, and T650. Task T610 selects one among two processing paths, depending on whether the frame has a single pitch pulse or multiple pitch pulses.

For a single-pulse frame, task T620 selects one of a set of different single-pulse vector quantization (VQ) tables according to the position of the pitch pulse within the frame. Each of these tables has a vector dimension equal to the length of the frame (e.g., 160 samples). In one example, the set of single-pulse VQ tables includes three tables. Task T630 then quantizes the pulse shape by finding the best match within the selected VQ table.

In one particular example, such a coding system includes three pulse shape VQ tables for single-pulse frames. Each table has 128 entries, each of length 160, such that the pulse shape is encoded as a seven-bit index.

A corresponding decoder (e.g., an implementation of decoder 300 or means FD100 or a device performing an implementation of decoding task D100) may be configured to identify a frame as single-pulse if the pulse position value is equal to a mode value (e.g., 127). Alternatively or additionally, such a decoder may be configured to identify a frame as single-pulse if the lag value is equal to a mode value (e.g., 127).

For a multiple-pulse frame, task T640 may be configured to extract the pitch pulse with the maximum gain (e.g., highest peak). When extracting the pulse, it may be desirable to make sure that the peak is not the first or last sample of the extracted pulse, which could lead to a discontinuity and/or omission of one or more important samples. In some cases, information after the peak may be more important to speech quality than information before it, so it may be desirable to extract the pulse so that the peak is near the beginning. In one example, task T640 extracts the shape from the pitch period that begins two samples before the pitch peak. Such an approach allows capturing samples that occur after the peak and may contain important shape information. In another example, it may be desirable to capture more samples before the peak, which may also contain important information. In a further example, task T640 is configured to extract the pitch period that is centered at the peak. It may be desirable to extract more than one pitch pulse from a frame, and to calculate an average shape from the two or more pitch pulses with the highest gain. It may be desirable to normalize pulse amplitude before performing shape selection.

For a multi-pulse frame, task T650 selects a pulse shape VQ table based on the lag value (or the length of the extracted prototype) and then selects the best match from the selected table. It may be desirable to provide nine or ten pulse shape VQ tables to encode multi-pulse frames. Each table has a different vector dimension and is associated with a different lag range or “bin”. Because the length of the pulse may not exactly match the length of the table entries, task T650 may be configured to zero-pad the shape vector (e.g., at the end) to match the corresponding table vector size before selecting the best match from the table. Alternatively or additionally, task T650 may be configured to truncate the shape vector to match the corresponding table vector size before selecting the best match from the table. In one example, each of the multi-pulse pulse shape VQ tables has 128 entries, such that the pulse shape is encoded as a seven-bit index.

A corresponding decoder (e.g., an implementation of decoder 300 or means FD100 or a device performing an implementation of decoding task D100) may be configured to obtain a lag value and a pulse shape index value from the encoded frame, to use the lag value to select the appropriate pulse shape VQ table, and to use the pulse shape index value to select the desired pulse shape from the selected pulse shape VQ table.

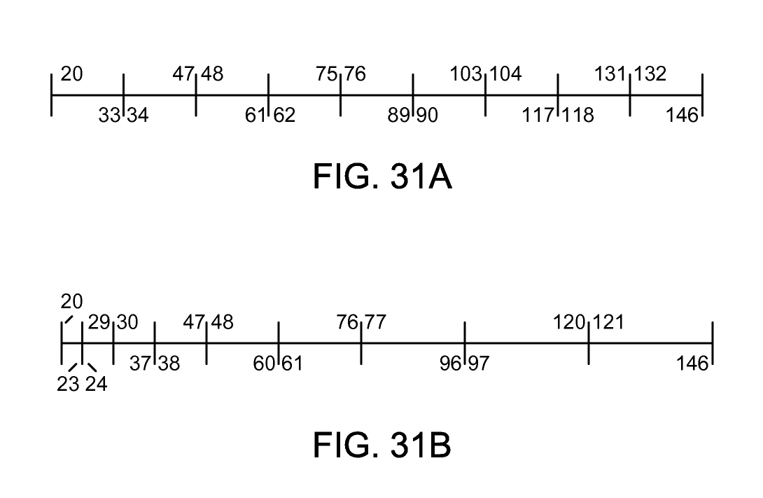

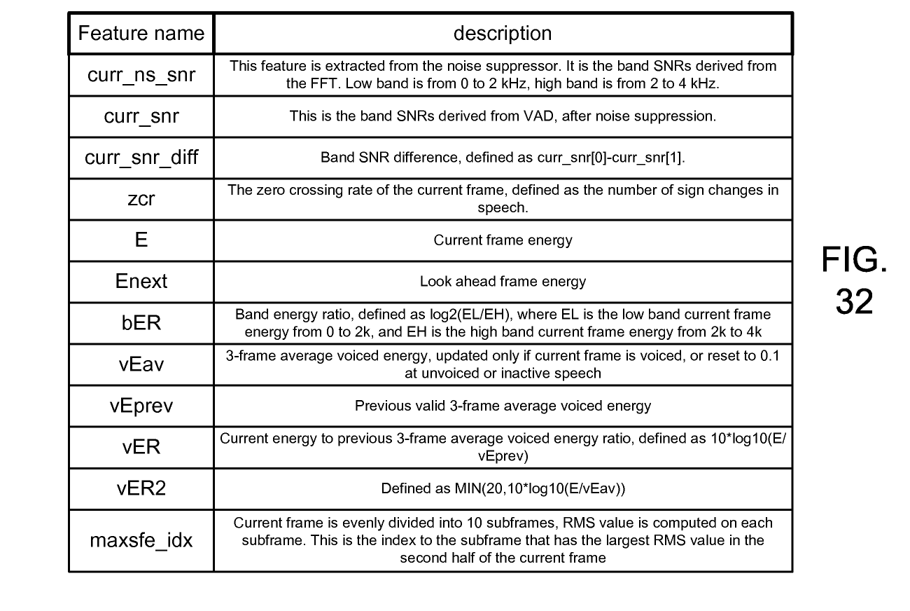

The range of possible (allowable) lag values may be divided into bins in a uniform manner or in a nonuniform manner. In one example of a uniform division as illustrated in FIG. 31A, the lag range of 20 to 146 samples is divided into the following nine bins: 20-33, 34-47, 48-61, 62-75, 76-89, 90-103, 104-117, 118-131, and 132-146. In this example, all of the bins have a width of fourteen samples except the last bin, which has a width of fifteen samples.

A uniform division as set forth above may lead to reduced quality at high pitch frequencies as compared to the quality at low pitch frequencies. In the example above, a pitch pulse having a length of twenty samples would be extended (e.g., zero-padded) by 65% before matching, while a pitch pulse having a length of 132 samples would be extended (e.g., zero-padded) by only 11%. One potential advantage of using a nonuniform division is to equalize the maximum relative extension among the different lag bins. In one example of a nonuniform division as illustrated in FIG. 31B, the lag range of 20 to 146 samples is divided into the following nine bins: 20-23, 24-29, 30-37, 38-47, 48-60, 61-76, 77-96, 97-120, and 121-146. In this case, a pitch pulse having a length of twenty samples would be extended (e.g., zero-padded) by 15% before matching, a pitch pulse having a length of 121 samples would be extended (e.g., zero-padded) by 21%, and the maximum extension of any pitch pulse in the range of 20-146 samples is 25%.

A speech encoder according to a configuration (e.g., according to an implementation of speech encoder AE20) uses three or four coding schemes to encode different classes of frames: a quarter-rate NELP (QNELP) coding scheme, a quarter-rate PPP (QPPP) coding scheme, and a transitional frame coding scheme as described above. The QNELP coding scheme is used to encode unvoiced frames and down-transient frames. The QNELP coding scheme, or an eighth-rate NELP coding scheme, may be used to encode silence frames (e.g., background noise). The QPPP coding scheme is used to encode voiced frames. The transitional frame coding scheme may be used to encode up-transient (i.e., onset) frames and transient frames. The table of FIG. 26 shows an example of a bit allocation for each of these four coding schemes.

Modern vocoders typically perform classification of speech frames. For example, such a vocoder may operate according to a scheme that classifies a frame as one of the six different classes discussed above: silence, unvoiced, voiced, transient, down-transient, and up-transient. Examples of such schemes are described in U.S. Publ. Pat. Appl. No. 2002/0111798 (Huang). One example of such a classification scheme is also described in Section 4.8 (pp. 4-57 to 4-71) of the 3GPP2 (Third Generation Partnership Project 2) document “Enhanced Variable Rate Codec, Speech Service Options 3, 68, and 70 for Wideband Spread Spectrum Digital Systems” (3GPP2 C.S0014-C, January 2007, available online at www.3gpp2.org). This scheme classifies frames using the features listed in the table of FIG. 32, and this section is incorporated by reference as an example of the “EVRC classification scheme” described herein.

The parameters E, EL, and EH that appear in the table of FIG. 32 may be calculated as follows (for a 160-bit frame):

$$E = {\sum }_{n = 0}^{159} {s}^{2} ( n ) , E L = {\sum }_{n = 0}^{159} {s}_{L}^{2} ( n ) , \\ E H = {\sum }_{n = 0}^{159} {s}_{H}^{2} ( n ) , \qquad EQ . 3$$

where s_{L} (n) and s_{H} (n) are low-pass filtered (using a 12^{th} order pole-zero low-pass filter) and high-pass filtered (using a 12^{th} order pole-zero high-pass filter) versions of the input speech signal, respectively. Other features that may be used in the EVRC classification scheme include the previous frame mode decision (“prev_mode”), the presence of stationary voiced speech in the previous frame (“prev_voiced”), and a voice activity detection result for the current frame (“curr_va”).

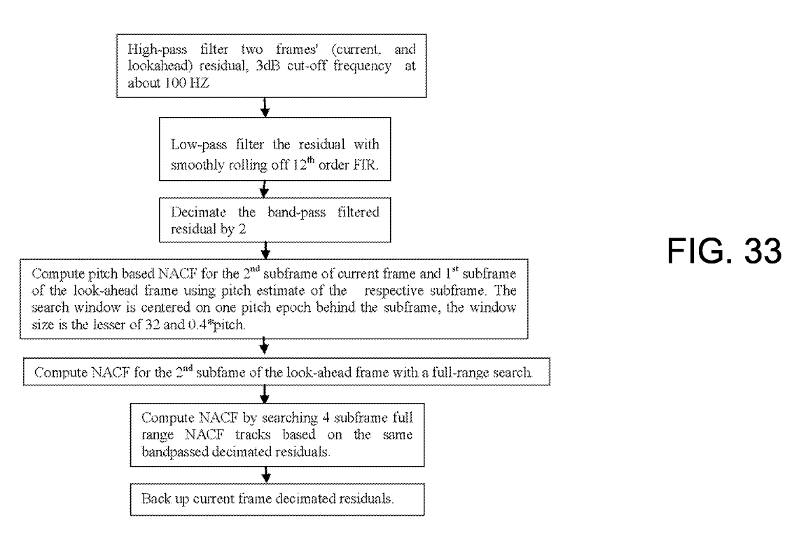

An important feature used in the classification scheme is the pitch-based normalized autocorrelation function (NACF). FIG. 33 shows a flowchart of a procedure for computing the pitch-based NACF. First, the LPC residual of the current frame and of the next frame (also called the look-ahead frame) is filtered through a third-order highpass filter having a 3-dB cut-off frequency at about 100 Hz. It may be desirable to compute this residual using unquantized LPC coefficient values. Then the filtered residual is low-pass filtered with a finite-impulse-response (FIR) filter of length 13 and decimated by a factor of two. The decimated signal is denoted by r_{d}(n).

The NACFs for two subframes of the current frame are computed as:

$$nacf ( k ) = max \frac{\begin{matrix}sign ( {\sum }_{n = 0}^{40 - 1} [ {r}_{d} ( 40 k + n ) {r}_{d} ( 40 k + n - lag ( k ) + i ) ] ) \\ {( {\sum }_{n = 0}^{40 - 1} [ {r}_{d} ( 40 k + n ) {r}_{d} ( 40 k + n - lag ( k ) + i ) ] )}^{2}\end{matrix}}{\begin{matrix}( {\sum }_{n = 0}^{40 - 1} [ {r}_{d} ( 40 k + n ) {r}_{d} ( 40 k + n ) ] ) \\ ( {\sum }_{n = 0}^{40 - 1} [ {r}_{d} ( 40 k + n - lag ( k ) + i ) {r}_{d} ( 40 k + n - lag ( k ) + i ) ] )\end{matrix}} \qquad EQ . 4$$

for k=1, 2, with the maximization done over all integer i such that

$$- \frac{1 + max [ 6 , min ( 0.2 \times lag ( k ) , 16 ) ]}{2} \leq i \leq \frac{1 + max [ 6 , min ( 0.2 \times lag ( k ) , 16 ) ]}{2} ,$$

where lag(k) is a lag value for subframe k as estimated by a pitch estimation routine (e.g., a correlation-based technique). These values for the first and second subframes of the current frame may also be referenced as nacf_at_pitch[2] (also written as “nacf_ap[2]”) and nacf_ap[3], respectively. The NACF values that were calculated according to the expression above for the first and second subframes of the previous frame may be referenced as nacf_ap[0] and nacf_ap[1], respectively.

The NACF for the look-ahead frame is computed as:

$$nacf ( 2 ) = max \frac{\begin{matrix}sign ( {\sum }_{n = 0}^{80 - 1} [ {r}_{d} ( 80 + n ) {r}_{d} ( 80 + n - i ) ] ) \\ {( {\sum }_{n = 0}^{80 - 1} [ {r}_{d} ( 80 + n ) {r}_{d} ( 80 + n - i ) ] )}^{2}\end{matrix}}{\begin{matrix}( {\sum }_{n = 0}^{80 - 1} [ {r}_{d} ( 80 + n ) {r}_{d} ( 80 + n ) ] ) \\ ( {\sum }_{n = 0}^{80 - 1} [ {r}_{d} ( 80 + n - i ) {r}_{d} ( 80 k + n - i ) ] )\end{matrix}} \qquad EQ . 5$$

with the maximization being done over all integer i such that

$$\frac{20}{2} \leq i \leq \frac{120}{2} .$$

This value may also be referenced as nacf_ap[4].

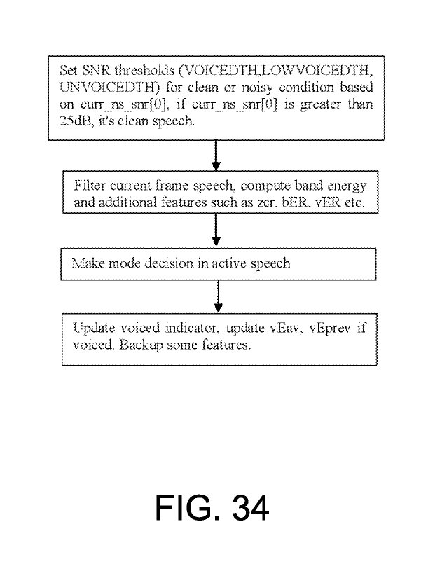

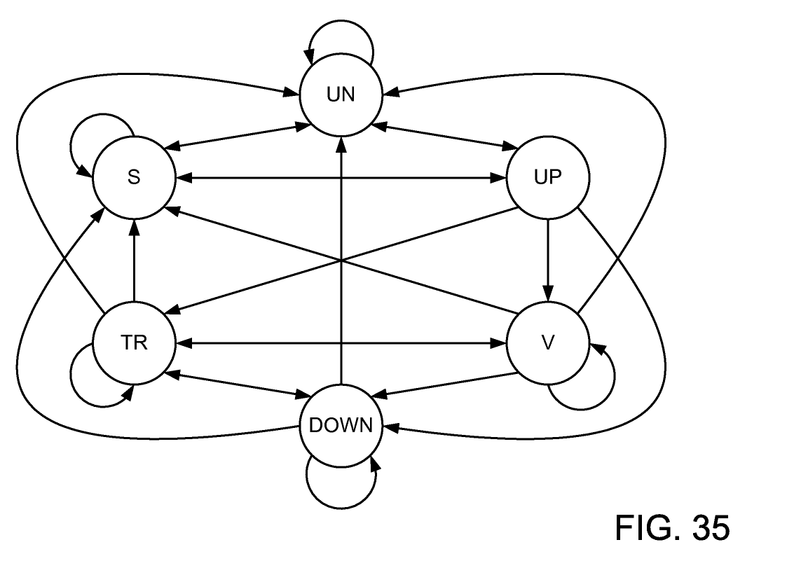

FIG. 34 is a flowchart that illustrates the EVRC classification scheme at a high level. The mode decision may be considered as a transition between states based on the previous mode decision and on features such as NACFs, where the states are the different frame classifications. FIG. 35 is a state diagram that illustrates the possible transitions between states in the EVRC classification scheme, where the labels S, UN, UP, TR, V, and DOWN denote the frame classifications silence, unvoiced, up-transient, transient, voiced, and down-transient, respectively.

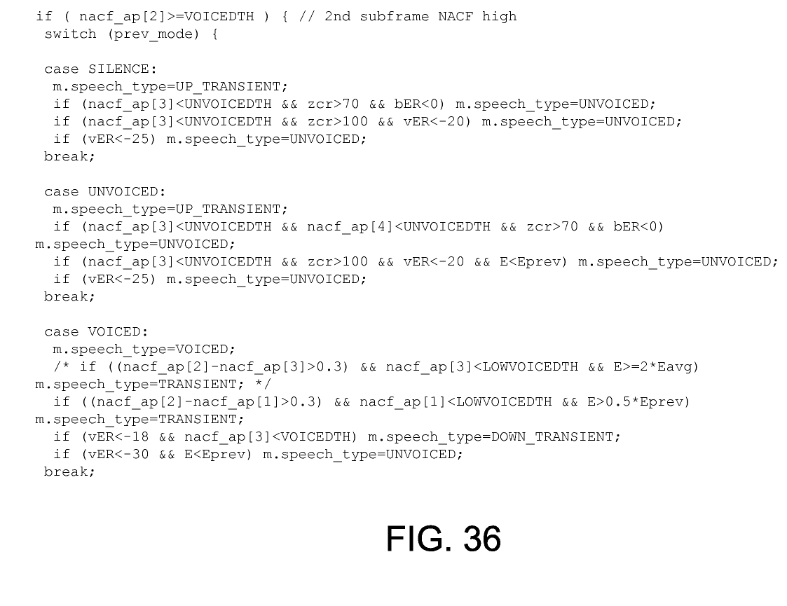

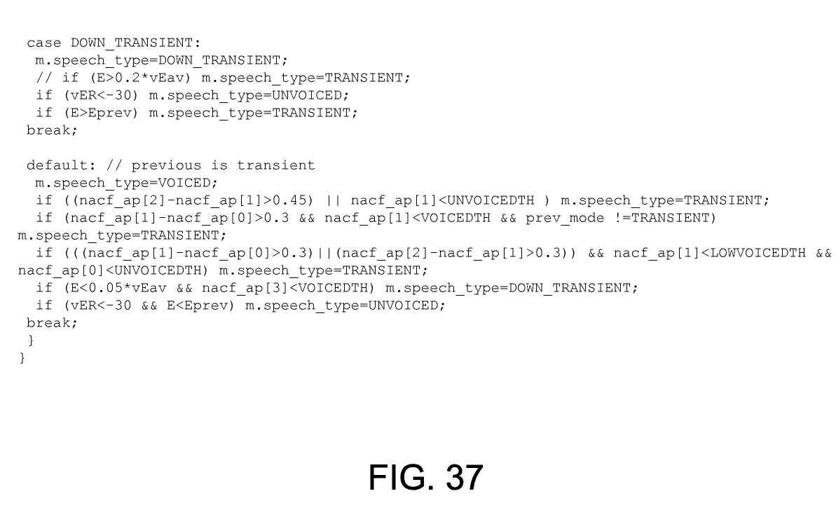

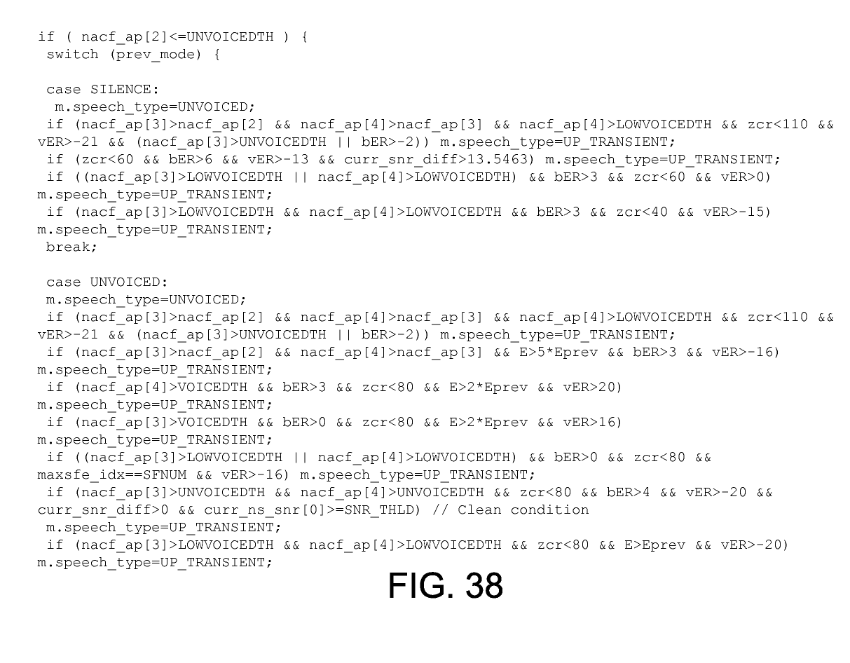

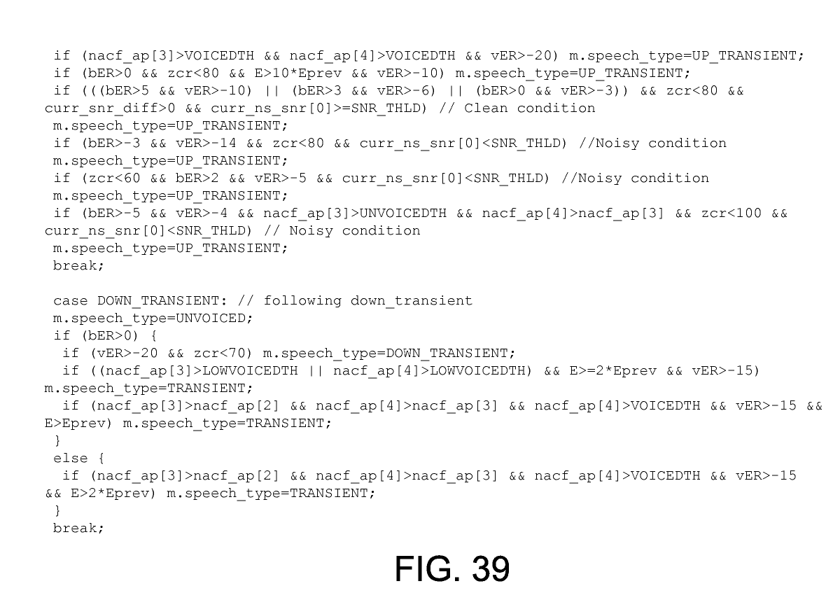

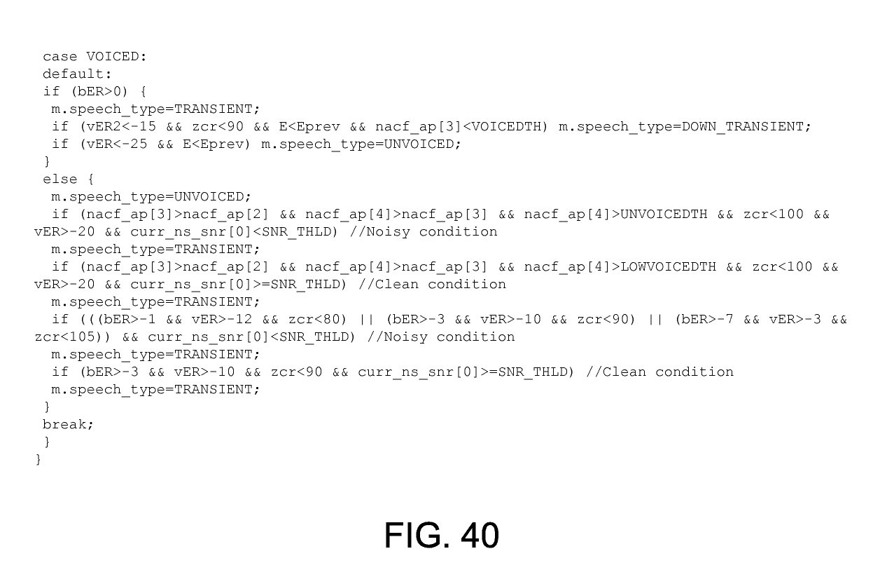

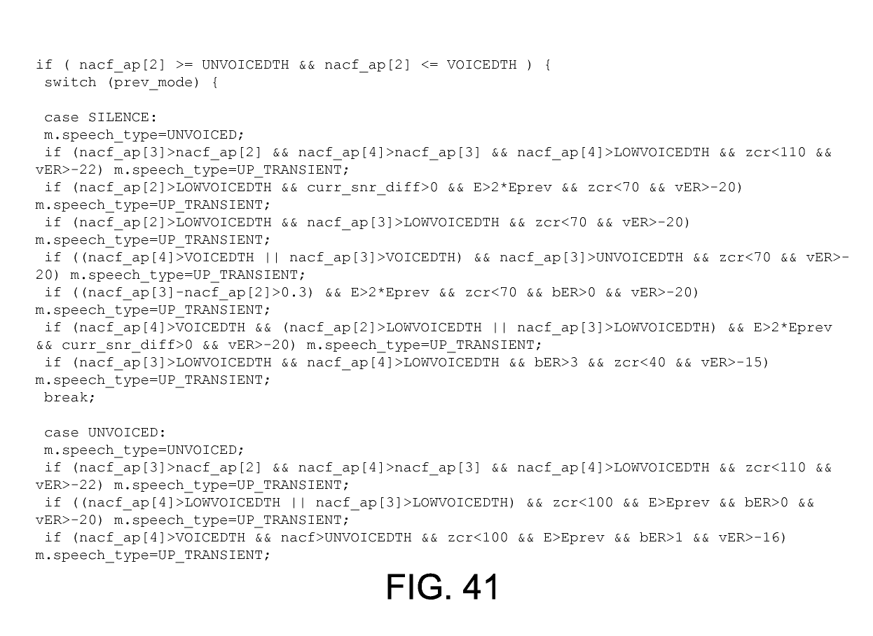

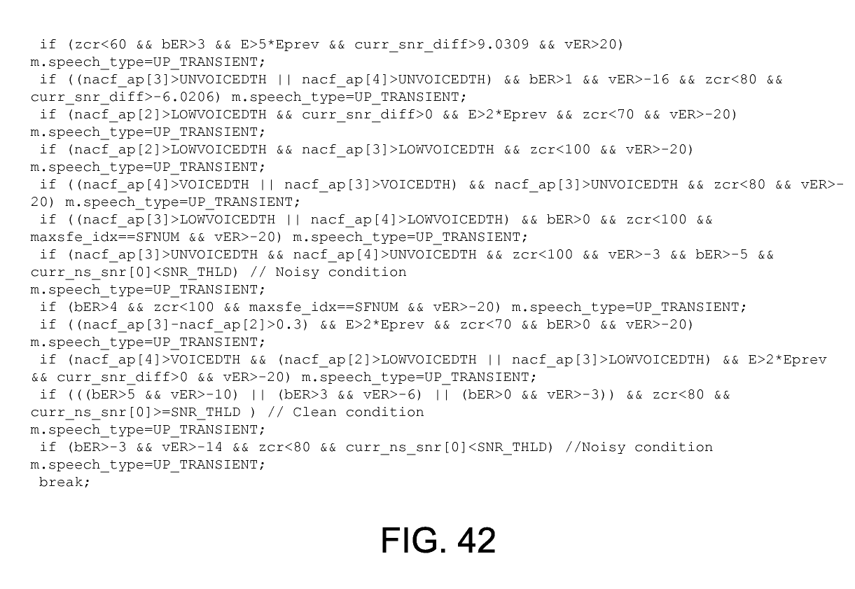

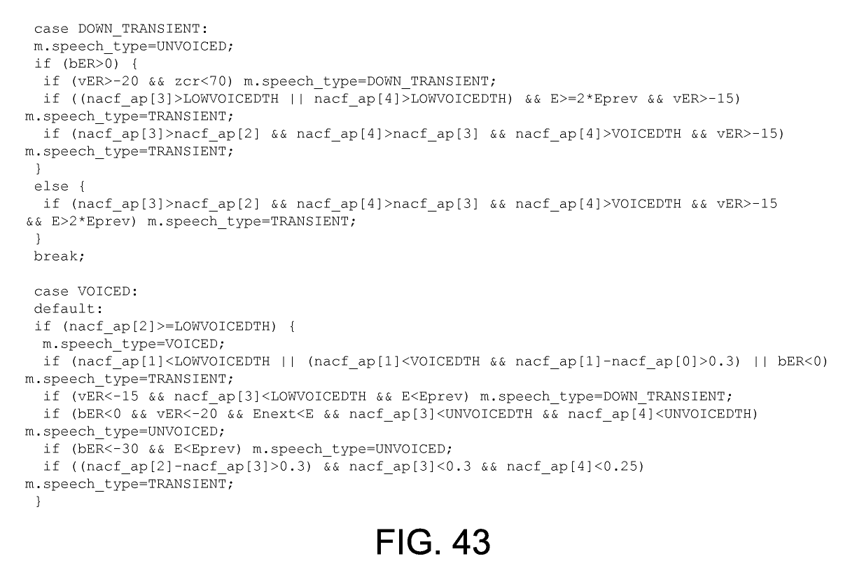

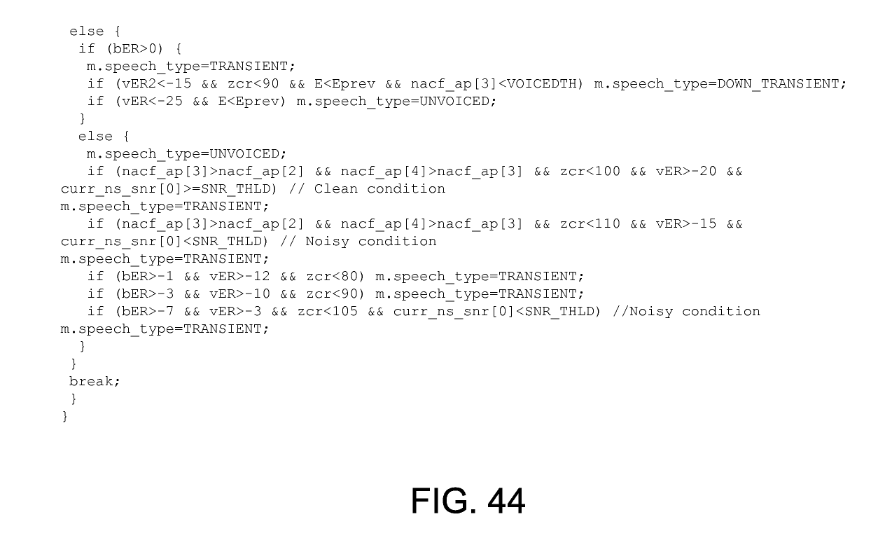

The EVRC classification scheme may be implemented by selecting one of three different procedures, depending on a relation between nacf_at_pitch[2] (the second subframe NACF of the current frame, also written as “nacf_ap[2]”) and the threshold values VOICEDTH and UNVOICEDTH. The code listing that extends across FIGS. 36 and 37 describes a procedure that may be used when nacf_ap[2]>VOICEDTH. The code listing that extends across FIGS. 38-40 describes a procedure that may be used when nacf_ap[2]<UNVOICEDTH. The code listing that extends across FIGS. 41-44 describes a procedure that may be used when nacf_ap[2]>=UNVOICEDTH and nacf_ap[2]<=VOICEDTH.

It may be desirable to vary the values of the thresholds VOICEDTH, LOWVOICEDTH, and UNVOICEDTH according to the value of the feature curr_ns_snr. For example, if the value of curr_ns_snr is not less than an SNR threshold of 25 dB, then the following threshold values for clean speech may be applied: VOICEDTH=0.75, LOWVOICEDTH=0.5, UNVOICEDTH=0.35; and if the value of curr_ns_snr is less than an SNR threshold of 25 dB, then the following threshold values for noisy speech may be applied: VOICEDTH=0.65, LOWVOICEDTH=0.5, UNVOICEDTH=0.35.

Accurate classification of frames may be especially important to ensure good quality in a low-rate vocoder. For example, it may be desirable to use a transitional frame coding mode as described herein only if the onset frame has at least one distinct peak or pulse. Such a feature may be important for reliable pulse detection, without which the transitional frame coding mode may produce a distorted result. It may be desirable to encode frames that lack at least one distinct peak or pulse using a NELP coding scheme rather than a PPP or transitional frame coding scheme. For example, it may be desirable to reclassify such a transient or up-transient frame as an unvoiced frame.

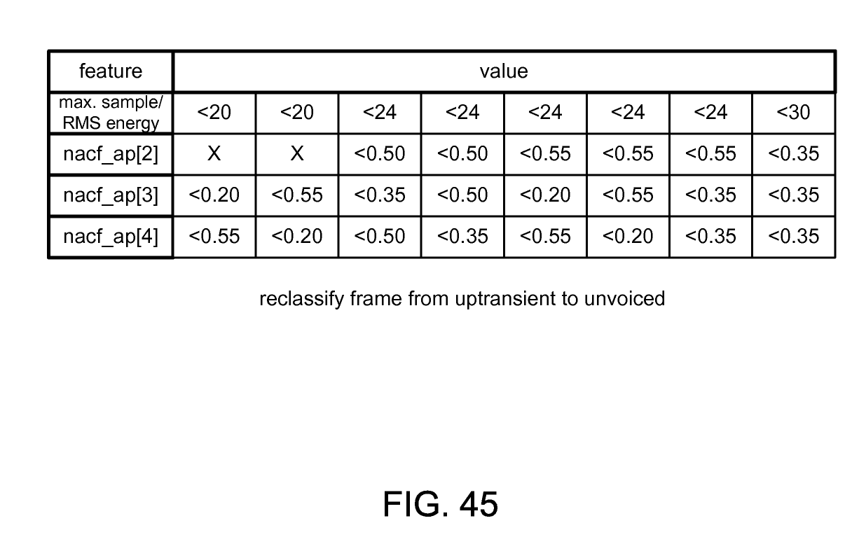

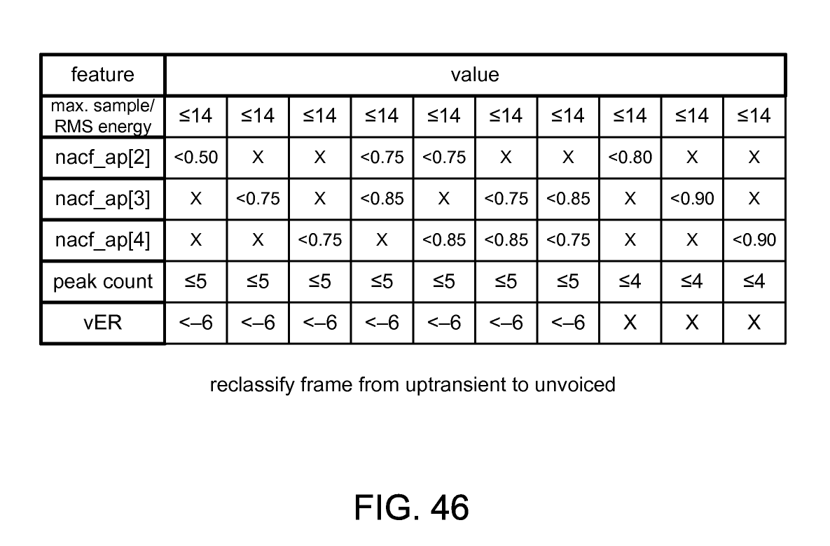

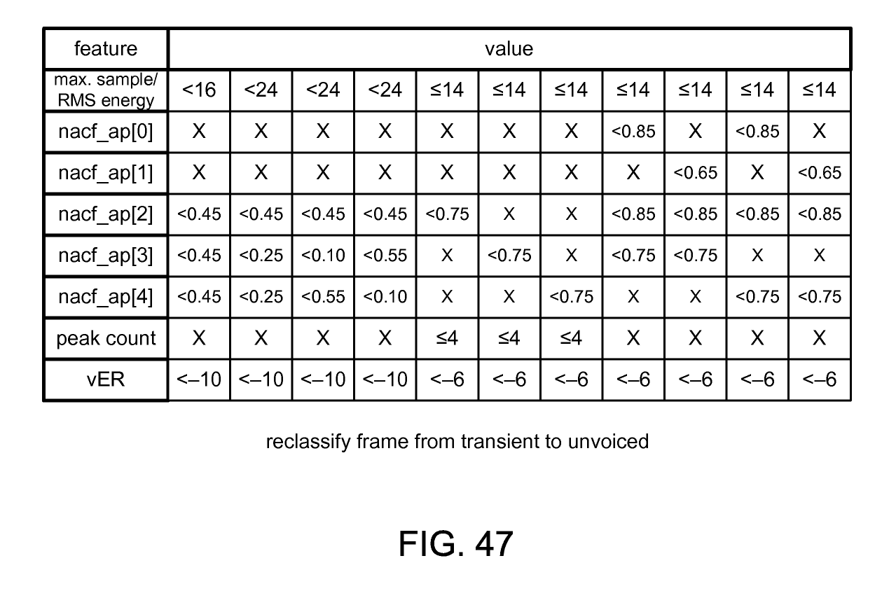

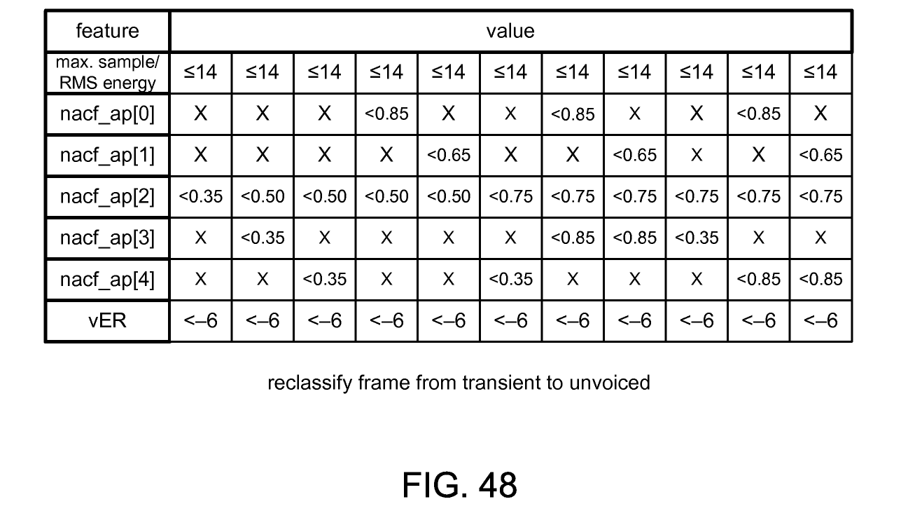

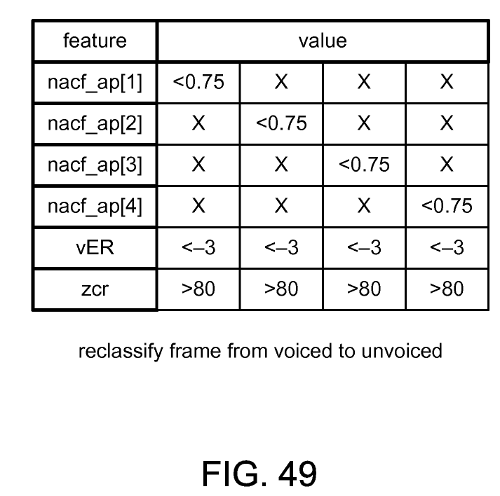

Such a reclassification may be based on one or more normalized autocorrelation function (NACF) values and/or other features. The reclassification may also be based on features that are not used in the EVRC classification scheme, such as a peak-to-RMS energy value of the frame (“maximum sample/RMS energy”) and/or the actual number of pitch pulses in the frame (“peak count”). Any one or more of the eight conditions shown in the table of FIG. 45, and/or any one or more of the ten conditions shown in the table of FIG. 46, may be used for reclassifying an up-transient frame as an unvoiced frame. Any one or more of the eleven conditions shown in the table of FIG. 47, and/or any one or more of the eleven conditions shown in the table of FIG. 48, may be used for reclassifying a transient frame as an unvoiced frame. Any one or more of the four conditions shown in the table of FIG. 49 may be used for reclassifying a voiced frame as an unvoiced frame. It may also be desirable to limit such reclassification to frames that are relatively free of low-band noise. For example, it may be desirable to reclassify a frame according to any of the conditions in FIG. 46, 48, or 49, or any of the seven right-most conditions of FIG. 47, only if the value of curr_ns_snr is not less than 25 dB.

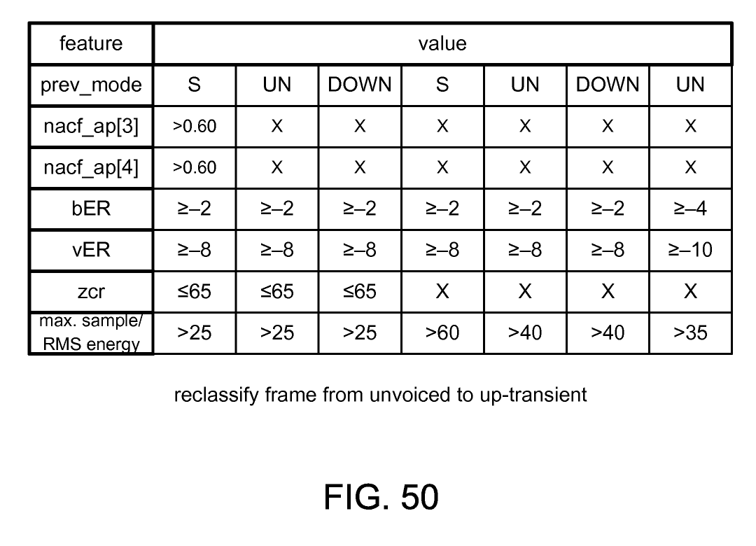

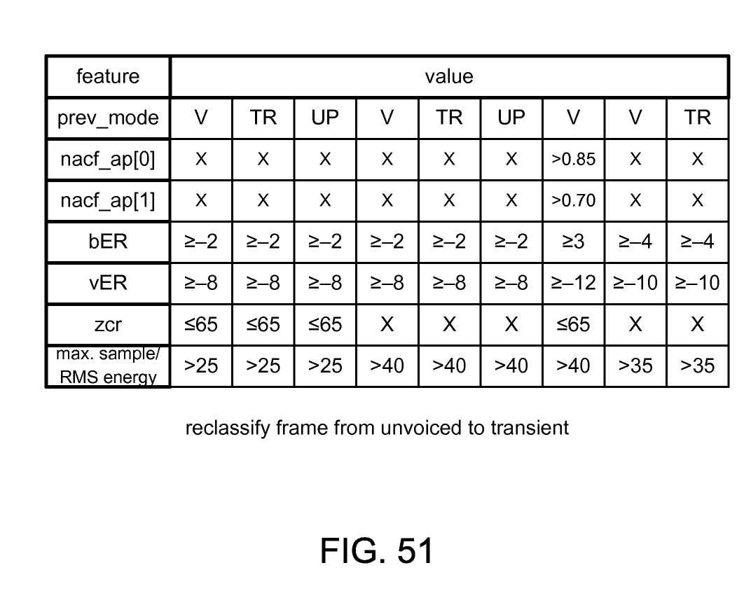

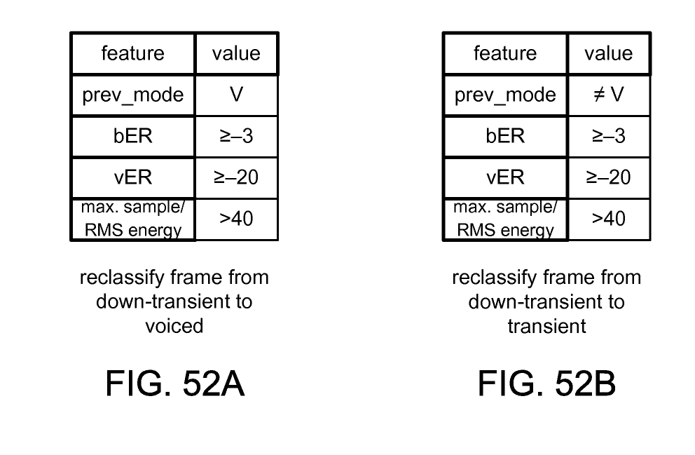

Conversely, it may be desirable to reclassify an unvoiced frame that includes at least one distinct peak or pulse as an up-transient or transient frame. Such a reclassification may be based on one or more normalized autocorrelation function (NACF) values and/or other features. The reclassification may also be based on features that are not used in the EVRC classification scheme, such as a peak-to-RMS energy value of the frame and/or peak count. Any one or more of the seven conditions shown in the table of FIG. 50 may be used for reclassifying an unvoiced frame as an up-transient frame. Any one or more of the nine conditions shown in the table of FIG. 51 may be used for reclassifying an unvoiced frame as a transient frame. The condition shown in the table of FIG. 52A may be used for reclassifying a down-transient frame as a voiced frame. The condition shown in the table of FIG. 52B may be used for reclassifying a down-transient frame as a transient frame.

As an alternative to frame reclassification, a method of frame classification such as the EVRC classification scheme may be modified to produce a classification result that is equal to a combination of the EVRC classification scheme and one or more of the reclassification conditions described above and/or set forth in FIGS. 45-52B.

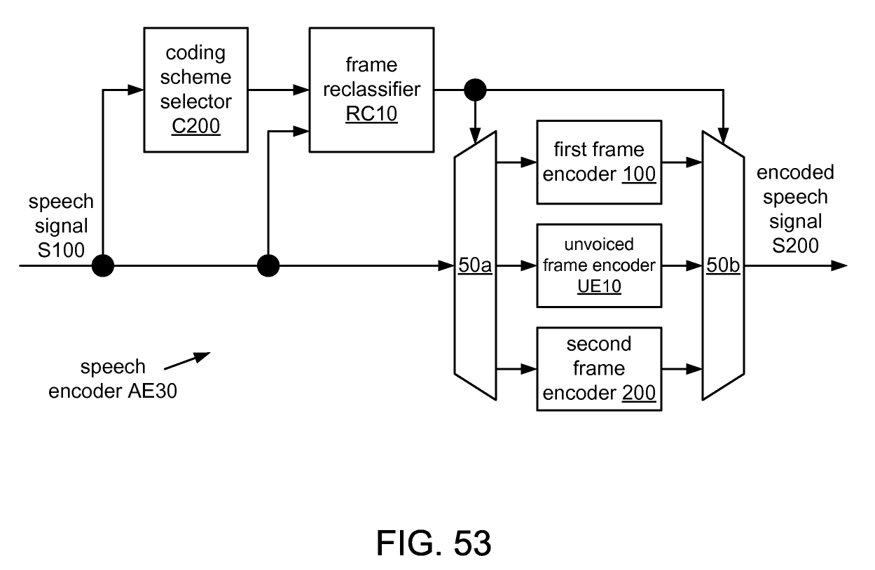

FIG. 53 shows a block diagram of an implementation AE30 of speech encoder AE20. Coding scheme selector C200 may be configured to apply a classification scheme such as the EVRC classification scheme described in the code listings of FIGS. 36-44. Speech encoder AE30 includes a frame reclassifier RC10 that is configured to reclassify frames according to one or more of the conditions described above and/or set forth in FIGS. 45-52B. Frame reclassifier RC10 may be configured to receive a frame classification and/or values of other frame features from coding scheme selector C200. Frame reclassifier RC10 may also be configured to calculate values of additional frame features (e.g., peak-to-RMS energy value, peak count). Alternatively, speech encoder AE30 may be implemented to include an implementation of coding scheme selector C200 that produces a classification result equal to a combination of the EVRC classification scheme and one or more of the reclassification conditions described above and/or set forth in FIGS. 45-52B.

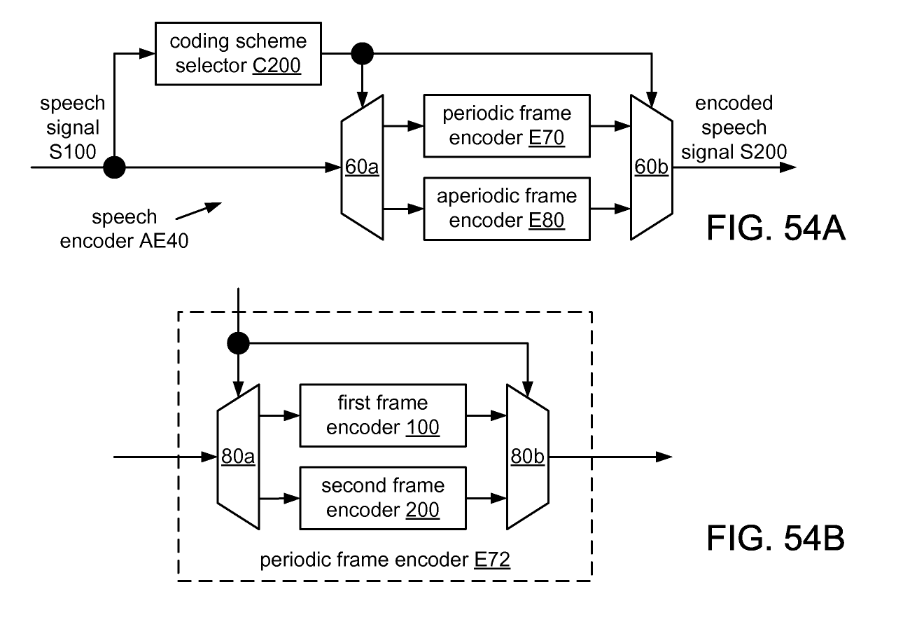

FIG. 54A shows a block diagram of an implementation AE40 of speech encoder AE10. Speech encoder AE40 includes a periodic frame encoder E70 configured to encode periodic frames and an aperiodic frame encoder E80 configured to encode aperiodic frames. For example, speech encoder AE40 may include an implementation of coding scheme selector C200 that is configured to direct selectors 60a, 60b to select periodic frame encoder E70 for frames classified as voiced, transient, up-transient, or down-transient, and to select aperiodic frame encoder E80 for frames classified as unvoiced or silence.

FIG. 54B shows a block diagram of an implementation E72 of periodic frame encoder E70. Encoder E72 includes implementations of first frame encoder 100 and second frame encoder 200 as described herein. Encoder E72 also includes selectors 80a, 80b that are configured to select one of encoders 100 and 200 for the current frame according to a classification result from coding scheme selector C200. It may be desirable to configure periodic frame encoder to select second frame encoder 200 (e.g., a QPPP encoder) as the default encoder for periodic frames. Aperiodic frame encoder E80 may be similarly implemented to select one among an unvoiced frame encoder (e.g., a QNELP encoder) and a silence frame encoder (e.g., an eighth-rate NELP encoder). Alternatively, aperiodic frame encoder E80 may be implemented as an instance of unvoiced frame encoder UE10.

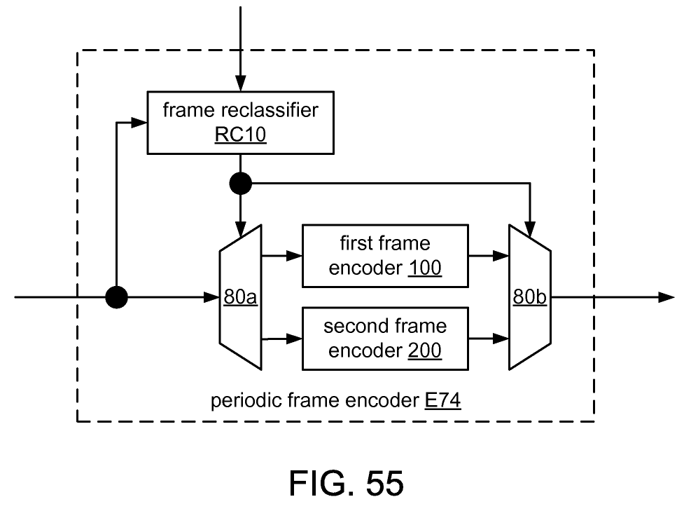

FIG. 55 shows a block diagram of an implementation E74 of periodic frame encoder E72. Encoder E74 includes an instance of frame reclassifier RC10 that is configured to reclassify frames according to one or more of the conditions described above and/or set forth in FIGS. 45-52B and to control selectors 80a, 80b to select one of encoders 100 and 200 for the current frame according to a result of the reclassification. In a further example, coding scheme selector C200 may be configured to include frame reclassifier RC10, or to perform a classification scheme equal to a combination of the EVRC classification scheme and one or more of the reclassification conditions described above and/or set forth in FIGS. 45-52B, and to select first frame encoder 100 as indicated by such classification or reclassification.

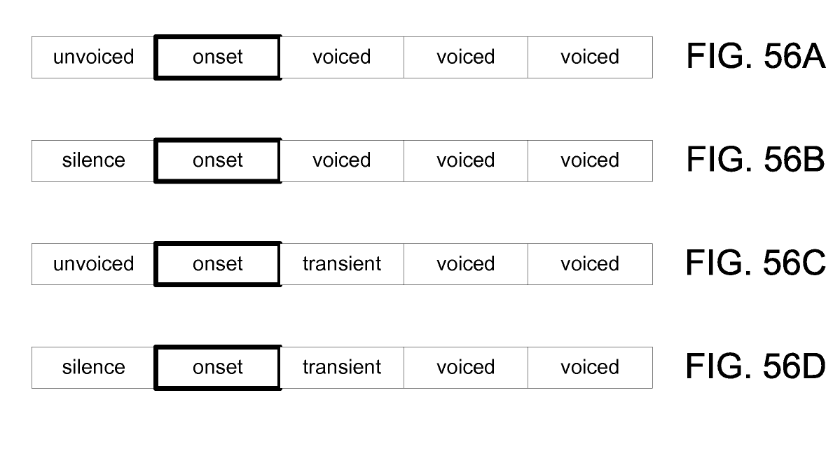

It may be desirable to use a transitional frame coding mode as described above to encode transient and/or up-transient frames. FIGS. 56A-D show some typical frame sequences in which the use of a transitional frame coding mode as described herein may be desirable. In these examples, use of the transitional frame coding mode would typically be indicated for the frame that is outlined in bold. Such a coding mode typically performs well on fully or partially voiced frames that have a relatively constant pitch period and sharp pulses. Quality of the decoded speech may be reduced, however, when the frame lacks sharp pulses or when the frame precedes the actual onset of voicing. In some cases, it may be desirable to skip or cancel use of the transitional frame coding mode, or otherwise to delay use of this coding mode until a later frame (e.g., the following frame).

Pulse misdetection may cause pitch error, missing pulses, and/or insertion of extraneous pulses. Such errors may lead to distortion such as pops, clicks, and/or other discontinuities in the decoded speech. Therefore, it may be desirable to verify that the frame is suitable for transitional frame coding, and cancelling the use of a transitional frame coding mode when the frame is not suitable may help to reduce such problems.

It may be determined that a transient or up-transient frame is unsuitable for the transitional frame coding mode. For example, the frame may lack a distinct, sharp pulse. In such case, it may be desirable to use the transitional frame coding mode to encode the first suitable voiced frame that follows the unsuitable frame. For example, if an onset frame lacks a distinct sharp pulse, it may be desirable to perform transitional frame coding on the first suitable voiced frame that follows. Such a technique may help to ensure a good reference for subsequent voiced frames.

In some cases, use of a transitional frame coding mode may lead to pulse gain mismatch problems and/or pulse shape mismatch problems. Only a limited number of bits are available to encode these parameters, and the current frame may not provide a good reference even though transitional frame coding is otherwise indicated. Cancelling unnecessary use of a transitional frame coding mode may help to reduce such problems. Therefore, it may be desirable to verify that a transitional frame coding mode is more suitable for the current frame than another coding mode.

For a case in which the use of transitional frame coding is skipped or cancelled, it may be desirable to use the transitional frame coding mode to encode the first suitable frame that follows, as such action may help to provide a good reference for subsequent voiced frames. For example, it may be desirable to force transitional frame coding on the very next frame, if it is at least partially voiced.

The need for transitional frame coding, and/or the suitability of a frame for transitional frame coding, may be determined based on criteria such as current frame classification, previous frame classification, initial lag value (e.g., as determined by a pitch estimation routine such as a correlation-based technique), modified lag value (e.g., as determined by a pulse detection operation such as method M200), lag value of a previous frame, and/or NACF values.

It may be desirable to use a transitional frame coding mode near the start of a voiced segment, as the result of using QPPP without a good reference is unpredictable. In some cases, however, QPPP may be expected to provide a better result than a transitional frame coding mode. For example, in some cases, the use of a transitional frame coding mode may be expected to yield a poor reference or even to cause a more objectionable result than using QPPP.

It may be desirable to skip transitional frame coding if it is not necessary for the current frame. In such case, it may be desirable to default to a voiced coding mode, such as QPPP (e.g., to preserve the continuity of the QPPP). Unnecessary use of a transitional frame coding mode may lead to problems of mismatch in pulse gain and/or pulse shape in later frames (e.g., due to the limited bit budget for these features). A voiced coding mode having limited time-synchrony, such as QPPP, may be especially sensitive to such errors.

After encoding a frame using a transitional frame coding scheme, it may be desirable to check the encoded result, and to reject the use of transitional frame coding on the frame if the encoded result is poor. For a frame that is mostly unvoiced and becomes voiced only near the end, the transitional coding mode may be configured to encode the unvoiced portion without pulses (e.g., as zero or a low value), the transitional coding mode may be configured to fill at least part of the unvoiced portion with pulses. If the unvoiced portion is encoded without pulses, the frame may produce an audible click or discontinuity in the decoded signal. In such case, it may be desirable to use a NELP coding scheme for the frame instead. It may be desirable to avoid using NELP on a voiced segment, however, which may cause distortion. If a transitional coding mode is cancelled for a frame, in most cases it may be desirable to use a voiced coding mode (e.g., QPPP) rather than an unvoiced coding mode (e.g. QNELP) to encode the frame. As described above, a selection to use transitional coding mode may be implemented as a selection between the transitional coding mode and a voiced coding mode. While the result of using QPPP without a good reference may be unpredictable (e.g., the phase of the frame will be derived from preceding unvoiced frame), it is unlikely to produce a click or discontinuity in the decoded signal. In such case, use of the transitional coding mode may be postponed until the next frame.

It may be desirable to override a decision to use a transitional coding mode for a frame when a pitch discontinuity between frames is detected. In one example, a task T710 checks check for pitch continuity with the previous frame (e.g., checks for a pitch doubling error). If the frame is classified as voiced or transient, and the lag value indicated for the current frame by the pulse detection routine is much less than (e.g., is about ½, ⅓, or ¼ of) the lag value indicated for the previous frame by the pulse detection routine, then the task cancels the decision to use the transitional coding mode.

In another example, a task T720 checks for pitch overflow as compared to previous frame. Pitch overflow occurs when the speech has a very low pitch frequency that results in a lag value higher than the maximum allowable lag. Such a task may be configured to cancel the decision to use the transitional coding mode if the lag value for the previous frame was large (e.g., more than 100 samples) and the lag values indicated for the current frame by the pitch estimation and pulse detection routines are both much less than the previous pitch (e.g., more than 50% less). In such case, it may also be desirable to keep only the largest pitch pulse of the frame as a single pulse. Alternatively, the frame may be encoded using the previous lag estimate and a voiced and/or relative coding mode (e.g., task E200, QPPP).

It may be desirable to override a decision to use a transitional coding mode for a frame when an inconsistency among results from two different routines is detected. In one example, a task T730 checks for consistency of lag values from the pitch estimation routine and the pulse detection routine in the presence of strong NACF. A very high NACF at pitch for the second pulse indicates a good pitch estimate, such that an inconsistency between the two lag estimates would be unexpected. Such a task may be configured to cancel the decision to use a transitional coding mode if the lag estimate from the pulse detection routine is very different from (e.g., greater than 1.6 times) the lag estimate from the pitch estimation routine.

In another example, a task T740 checks for agreement between the lag value and the position of the terminal pulse. It may be desirable to cancel a decision to use a transitional frame coding mode when one or more of the peak positions, as encoded using the lag estimate (which may be an average of the distance between the peaks), are too different from the corresponding actual peak positions. Task T740 may be configured to use the position of the terminal pulse and the lag value calculated by the pulse detection routine to calculate reconstructed pitch pulse positions, to compare each of the reconstructed positions to the actual pitch peak positions as detected by the pulse detection algorithm, and to cancel the decision to use transitional frame coding if any of the differences is too large (e.g., is greater than eight samples).

In a further example, a task T750 checks for agreement between lag value and pulse position. Such a task may be configured to cancel the decision to use transitional frame coding if the final pitch peak is more than one lag period away from the final frame boundary. For example, such a task may be configured to cancel the decision to use transitional frame coding if the distance between the position of the final pitch pulse and the end of the frame is greater than the final lag estimate (e.g., a lag value calculated by lag estimation task L200 and/or method M300). Such a condition may indicate a pulse misdetection or a lag that is not yet stabilized.

If the current frame has two pulses and is classified as transient, and if a ratio of the squared magnitudes of the peaks of the two pulses is large, it may be desirable to correlate the two pulses over the entire lag value and to reject the smaller peak unless the correlation result is greater than (alternatively, not less than) a corresponding threshold value. If the smaller peak is rejected, it may also be desirable to cancel a decision to use transitional frame coding for the frame.

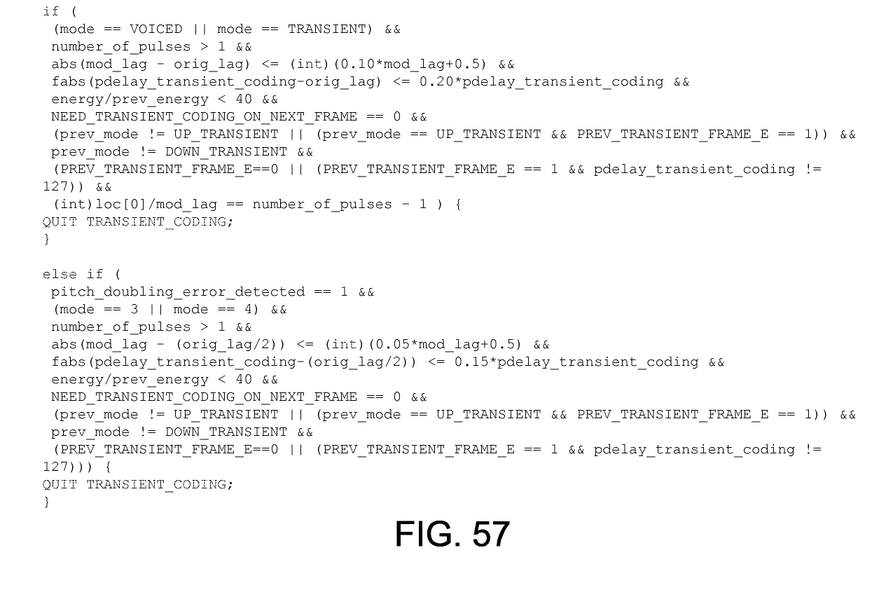

FIG. 57 shows a code listing for two routines that may be used to cancel a decision to use transitional frame coding for a frame. In this listing, mod lag indicates the lag value from the pulse detection routine; orig_lag indicates the lag value from the pitch estimation routine; pdelay_transient_coding indicates the lag value from the pulse detection routine for the previous frame; PREV_TRANSIENT_FRAME_E indicates whether a transitional coding mode was used for the previous frame; and loc[0] indicates the position of the final pitch peak of the frame.

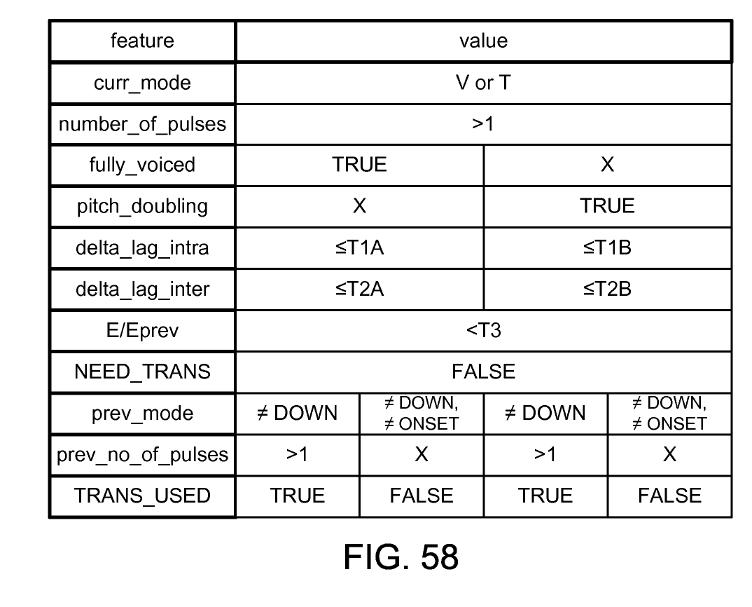

FIG. 58 shows four different conditions that may be used to cancel a decision to use transitional frame coding. In this table, curr_mode indicates the current frame classification; prev_mode indicates the frame classification for the previous frame; number_of_pulses indicates the number of pulses in the current frame; prev_no_of_pulses indicates the number of pulses in the previous frame; pitch doubling indicates whether a pitch doubling error has been detected in the current frame; delta lag_intra indicates the absolute value (e.g., integer) of the difference between the lag values from the pitch estimation routine and the pulse detection routine (or, if pitch doubling was detected, the absolute value of the difference between the half the lag value from the pitch estimation routine and the lag value from the pulse detection routine); delta_lag_inter indicates the absolute value (e.g., floating point) of the difference between the final lag value of the previous frame and the lag value from the pitch estimation routine (or half that lag value, if pitch doubling was detected) for the current frame; NEED_TRANS indicates whether the use of a transitional frame coding mode for the current frame was indicated during coding of the previous frame; TRANS_USED indicates whether the transitional coding mode was used to encode the previous frame; and fully voiced indicates whether the integer part of the distance between the position of the terminal pitch pulse and the opposite end of the frame, as divided by the final lag value, is equal to number_of_pulses minus one. Examples of values for the thresholds include T1A=[0.1*(lag value from the pulse detection routine)+0.5], T1B=[0.05*(lag value from the pulse detection routine)+0.5], T2A=[0.2*(final lag value for the previous frame)], and T2B=[0.15*(final lag value for the previous frame)].

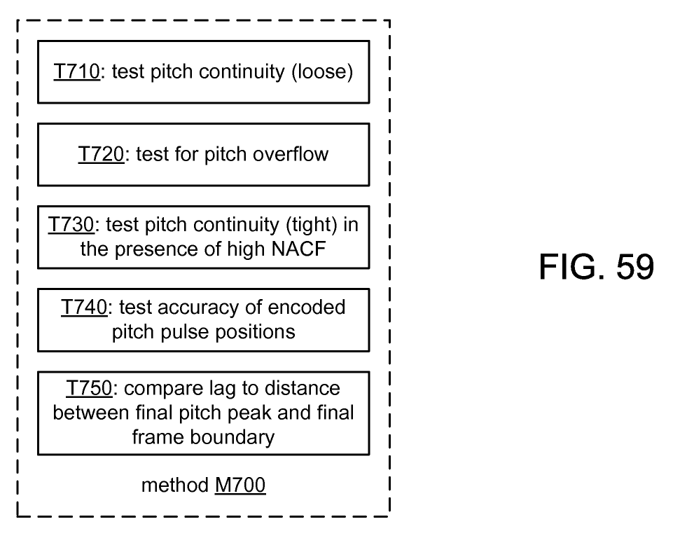

Frame reclassifier RC10 may be implemented to include one or more of the provisions described above for canceling a decision to use a transitional coding mode, such as tasks T710-T750, the code listing in FIG. 57, and the conditions shown in FIG. 58. For example, frame reclassifier RC10 may be implemented to perform method M700 as shown in FIG. 59, and to cancel a decision to use a transitional coding mode if any of test tasks T710-T750 fails.

In a typical application of an implementation of a method as described herein (e.g., method M100, M200, M300, M500, M600, or M700, or another routine or code listing), an array of logic elements (e.g., logic gates) is configured to perform one, more than one, or even all of the various tasks of the method. One or more (possibly all) of the tasks may also be implemented as code (e.g., one or more sets of instructions), embodied in a computer program product (e.g., one or more data storage media such as disks, flash or other nonvolatile memory cards, semiconductor memory chips, etc.) that is readable and/or executable by a machine (e.g., a computer) including an array of logic elements (e.g., a processor, microprocessor, microcontroller, or other finite state machine). The tasks of an implementation of such a method may also be performed by more than one such array or machine. In these or other implementations, the tasks may be performed within a device for wireless communications, such as a mobile user terminal or other device having such communications capability. Such a device may be configured to communicate with circuit-switched and/or packet-switched networks (e.g., using one or more protocols such as VoIP (voice over Internet Protocol)). For example, such a device may include RF circuitry configured to transmit a signal that includes encoded frames and/or to receive such a signal. Such a device may also be configured to perform one or more other operations on the encoded frames before RF transmission, such as interleaving, puncturing, convolutional coding, error correction coding, and/or applying one or more layers of network protocol.

The various elements of implementations of an apparatus described herein (e.g., apparatus A100, A200, A300, A500, A600, A700, or speech encoder AE20, or elements thereof) may be implemented as electronic and/or optical devices residing, for example, on the same chip or among two or more chips in a chipset, although other arrangements without such limitation are also contemplated. One or more elements of such an apparatus may be implemented in whole or in part as one or more sets of instructions arranged to execute on one or more fixed or programmable arrays of logic elements (e.g., transistors, gates) such as microprocessors, embedded processors, IP cores, digital signal processors, FPGAs (field-programmable gate arrays), ASSPs (application-specific standard products), and ASICs (application-specific integrated circuits).

It is possible for one or more elements of an implementation of such an apparatus to be used to perform tasks or execute other sets of instructions that are not directly related to an operation of the apparatus, such as a task relating to another operation of a device or system in which the apparatus is embedded. It is also possible for one or more elements of an implementation of an apparatus described herein to have structure in common (e.g., a processor used to execute portions of code corresponding to different elements at different times, a set of instructions executed to perform tasks corresponding to different elements at different times, or an arrangement of electronic and/or optical devices performing operations for different elements at different times).

The foregoing presentation of the described configurations is provided to enable any person skilled in the art to make or use the methods and other structures disclosed herein. The flowcharts and other structures shown and described herein are examples only, and other variants of these structures are also within the scope of the disclosure. Various modifications to these configurations are possible, and the generic principles presented herein may be applied to other configurations as well.

Each of the configurations described herein may be implemented in part or in whole as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a microprocessor or other digital signal processing unit. The data storage medium may be an array of storage elements such as semiconductor memory (which may include without limitation dynamic or static RAM (random-access memory), ROM (read-only memory), and/or flash RAM), or ferroelectric, magnetoresistive, ovonic, polymeric, or phase-change memory; or a disk medium such as a magnetic or optical disk. The term “software” should be understood to include source code, assembly language code, machine code, binary code, firmware, macrocode, microcode, any one or more sets or sequences of instructions executable by an array of logic elements, and any combination of such examples.

Each of the methods disclosed herein may also be tangibly embodied (for example, in one or more data storage media as listed above) as one or more sets of instructions readable and/or executable by a machine including an array of logic elements (e.g., a processor, microprocessor, microcontroller, or other finite state machine). Thus, the present disclosure is not intended to be limited to the configurations shown above but rather is to be accorded the widest scope consistent with the principles and novel features disclosed in any fashion herein, including in the attached claims as filed, which form a part of the original disclosure.

What is claimed is:

1. A method of encoding frames of a speech signal, said method comprising:
encoding a first frame of the speech signal as a first encoded frame; and
encoding a second frame of the speech signal as a second encoded frame,
wherein said encoding a first frame includes:
based on information from at least one pitch pulse of the first frame, selecting one among a plurality of time-domain pitch pulse shapes;
calculating a position of a terminal pitch pulse of the first frame; and
estimating a pitch period of the first frame, and
wherein said encoding a second frame includes:
calculating a pitch pulse shape differential between a pitch pulse shape of the second frame and a pitch pulse shape of the first frame; and
calculating a pitch period differential between a pitch period of the second frame and a pitch period of the first frame, and
wherein the first encoded frame includes representations of each among the selected time-domain pitch pulse shape, the calculated position, and the estimated pitch period, and
wherein the second encoded frame includes representations of each among the pitch pulse shape differential and the pitch period differential, and
wherein the second frame follows said first frame in the speech signal.

2. The method of encoding frames according to claim 1, wherein the second frame immediately follows said first frame in the speech signal.

3. The method of encoding frames according to claim 1, wherein said method comprises detecting that the first frame is an onset frame.

4. The method of encoding frames according to claim 1, wherein said encoding a second frame includes calculating a frequency-domain pitch prototype based on information from at least one pitch pulse of the second frame, and
wherein the pitch pulse shape differential is based on a difference between (A) the calculated frequency-domain pitch prototype and (B) a frequency-domain representation of the selected time-domain pitch pulse shape.

5. The method of encoding frames according to claim 1, wherein said encoding a first frame includes calculating a plurality of gain values, each of the plurality of gain values corresponding to a different one of a plurality of pitch pulses of the first frame, and
wherein the first encoded frame includes a representation of the plurality of gain values.

6. The method of encoding frames according to claim 1, wherein said method includes encoding a third frame of the speech signal as a third encoded frame,
wherein the second frame follows said first frame in the speech signal, and
wherein the third frame follows said second frame in the speech signal, and
wherein said encoding a third frame includes:
calculating a second pitch pulse shape differential between a pitch pulse shape of the third frame and a pitch pulse shape of the second frame; and
calculating a second pitch period differential between a pitch period of the third frame and a pitch period of the second frame, and
wherein the third encoded frame includes representations of the second pitch pulse shape differential and the second pitch period differential.

7. An apparatus for encoding frames of a speech signal, said apparatus comprising:
means for encoding a first frame of the speech signal as a first encoded frame; and
means for encoding a second frame of the speech signal as a second encoded frame,
wherein said means for encoding a first frame includes:
means for selecting, based on information from at least one pitch pulse of the first frame, one among a plurality of time-domain pitch pulse shapes;
means for calculating a position of a terminal pitch pulse of the first frame; and
means for estimating a pitch period of the first frame, and
wherein said means for encoding a second frame includes:
means for calculating a pitch pulse shape differential between a pitch pulse shape of the second frame and a pitch pulse shape of the first frame; and
means for calculating a pitch period differential between a pitch period of the second frame and a pitch period of the first frame, and
wherein the first encoded frame includes representations of the selected time-domain pitch pulse shape, the calculated position, and the estimated pitch period, and
wherein the second encoded frame includes representations of the pitch pulse shape differential and the pitch period differential, and
wherein the second frame follows said first frame in the speech signal.

8. The apparatus for encoding frames according to claim 7, wherein said apparatus includes means for detecting that the first frame is an onset frame.

9. The apparatus for encoding frames according to claim 7, wherein said means for encoding a second frame includes means for calculating a frequency-domain pitch prototype based on information from at least one pitch pulse of the second frame, and
wherein the pitch pulse shape differential is based on a difference between (A) the calculated frequency-domain pitch prototype and (B) a frequency-domain representation of the selected time-domain pitch pulse shape.

10. The apparatus for encoding frames according to claim 7, wherein said means for encoding a first frame includes means for calculating a plurality of gain values, each of the plurality of gain values corresponding to a different one of a plurality of pitch pulses of the first frame, and
wherein the first encoded frame includes a representation of the plurality of gain values.

11. The apparatus for encoding frames according to claim 7, wherein said apparatus includes means for encoding a third frame of the speech signal as a third encoded frame,
wherein the second frame follows said first frame in the speech signal, and
wherein the third frame follows said second frame in the speech signal, and
wherein said means for encoding a third frame includes:
means for calculating a second pitch pulse shape differential between a pitch pulse shape of the third frame and a pitch pulse shape of the second frame; and
means for calculating a second pitch period differential between a pitch period of the third frame and a pitch period of the second frame, and
wherein the third encoded frame includes representations of the second pitch pulse shape differential and the second pitch period differential.

12. An apparatus for encoding frames of a speech signal, said apparatus comprising:
a first frame encoder configured to encode a first frame of the speech signal as a first encoded frame; and
a second frame encoder configured to encode a second frame of the speech signal as a second encoded frame,
wherein said first frame encoder includes:
a pitch pulse shape selector configured to select, based on information from at least one pitch pulse of the first frame, one among a plurality of time-domain pitch pulse shapes;
a pitch peak position calculator configured to calculate a position of a terminal pitch pulse of the first frame; and
a pitch period estimator configured to estimate a pitch period of the first frame, and
wherein said second frame encoder includes:
a pitch pulse shape differential calculator configured to calculate a pitch pulse shape differential between a pitch pulse shape of the second frame and a pitch pulse shape of the first frame; and
a pitch period differential calculator configured to calculate a pitch period differential between a pitch period of the second frame and a pitch period of the first frame, and
wherein the first encoded frame includes representations of the selected time-domain pitch pulse shape, the calculated position, and the estimated pitch period, and
wherein the second encoded frame includes representations of the pitch pulse shape differential and the pitch period differential, and
wherein the second frame follows said first frame in the speech signal.

13. The apparatus for encoding frames according to claim 12, wherein said apparatus includes a frame classifier configured to detect that the first frame is an onset frame.

14. The apparatus for encoding frames according to claim 12, wherein said second frame encoder includes a pitch prototype calculator configured to calculate a frequency-domain pitch prototype based on information from at least one pitch pulse of the second frame, and
wherein the pitch pulse shape differential is based on a difference between (A) the calculated frequency-domain pitch prototype and (B) a frequency-domain representation of the selected time-domain pitch pulse shape.

15. The apparatus for encoding frames according to claim 12, wherein said first frame encoder includes a gain value calculator configured to calculate a plurality of gain values, each of the plurality of gain values corresponding to a different one of a plurality of pitch pulses of the first frame, and
wherein the first encoded frame includes a representation of the plurality of gain values.

16. The apparatus for encoding frames according to claim 12, wherein said second frame encoder is configured to encode a third frame of the speech signal as a third encoded frame,
wherein the second frame follows said first frame in the speech signal, and
wherein the third frame follows said second frame in the speech signal, and
wherein said pitch pulse shape differential calculator is configured to calculate a second pitch pulse shape differential between a pitch pulse shape of the third frame and a pitch pulse shape of the second frame, and
wherein said pitch period differential calculator is configured to calculate a second pitch period differential between a pitch period of the third frame and a pitch period of the second frame, and
wherein the third encoded frame includes representations of the second pitch pulse shape differential and the second pitch period differential.

17. A computer-readable medium comprising instructions which when executed by a processor cause the processor to:
encode a first frame of the speech signal as a first encoded frame; and
encode a second frame of the speech signal as a second encoded frame,
wherein said instructions that cause the processor to encode a first frame include:
instructions that cause the processor to select, based on information from at least one pitch pulse of the first frame, one among a plurality of time-domain pitch pulse shapes;
instructions that cause the processor to calculate a position of a terminal pitch peak of the first frame; and
instructions that cause the processor to estimate a pitch period of the first frame, and
wherein said instructions that cause the processor to encode a second frame include:
instructions that cause the processor to calculate a pitch pulse shape differential between a pitch pulse shape of the second frame and a pitch pulse shape of the first frame; and
instructions that cause the processor to calculate a pitch period differential between a pitch period of the second frame and a pitch period of the first frame, and
wherein the first encoded frame includes representations of the selected time-domain pitch pulse shape, the calculated position, and the estimated pitch period, and
wherein the second encoded frame includes representations of the pitch pulse shape differential and the pitch period differential, and
wherein the second frame follows said first frame in the speech signal.

18. The computer-readable medium according to claim 17, wherein said medium includes instructions which when executed by a processor cause the processor to detect that the first frame is an onset frame.

19. The computer-readable medium according to claim 17, wherein said instructions that cause the processor to encode a second frame include instructions that cause the processor to calculate a frequency-domain pitch prototype based on information from at least one pitch pulse of the second frame, and
wherein the pitch pulse shape differential is based on a difference between (A) the calculated frequency-domain pitch prototype and (B) a frequency-domain representation of the selected time-domain pitch pulse shape.

20. The computer-readable medium according to claim 17, wherein said instructions that cause the processor to encode a first frame include instructions that cause the processor to calculate a plurality of gain values, each of the plurality of gain values corresponding to a different one of a plurality of pitch pulses of the first frame, and
wherein the first encoded frame includes a representation of the plurality of gain values.

21. The computer-readable medium according to claim 17, wherein said medium includes instructions which when executed by a processor cause the processor to encode a third frame of the speech signal as a third encoded frame,
wherein the second frame follows said first frame in the speech signal, and
wherein the third frame follows said second frame in the speech signal, and
wherein said instructions that cause the processor to encode a third frame include:
instructions that cause the processor to calculate a second pitch pulse shape differential between a pitch pulse shape of the third frame and a pitch pulse shape of the second frame; and
instructions that cause the processor to calculate a second pitch period differential between a pitch period of the third frame and a pitch period of the second frame, and
wherein the third encoded frame includes representations of the second pitch pulse shape differential and the second pitch period differential.

22. A method of decoding excitation signals of a speech signal, said method comprising:
decoding a portion of a first encoded frame to obtain a first excitation signal; and
decoding a portion of a second encoded frame to obtain a second excitation signal,
wherein the portion of the first encoded frame includes representations of each among a time-domain pitch pulse shape, a pitch peak position, and a pitch period, and
wherein the portion of the second encoded frame includes representations of each among a pitch pulse shape differential and a pitch period differential, and
wherein said decoding a portion of a first encoded frame includes:
arranging a first copy of the time-domain pitch pulse shape within the first excitation signal according to the pitch peak position; and
arranging a second copy of the time-domain pitch pulse shape within the first excitation signal according to the pitch peak position and the pitch period, and
wherein said decoding a portion of a second encoded frame includes:
calculating a second pitch pulse shape based on the time-domain pitch pulse shape and the pitch pulse shape differential;
calculating a second pitch period based on the pitch period and the pitch period differential; and
arranging a plurality of copies of the second pitch pulse shape within the second excitation signal according to the pitch peak position and the second pitch period.

23. The method of decoding excitation signals according to claim 22, wherein the portion of the first encoded frame includes a representation of a plurality of gain values, and
wherein said decoding a portion of a first encoded frame includes:
applying one of the plurality of gain values to the first copy of the time-domain pitch pulse shape; and
applying a different one of the plurality of gain values to the second copy of the time-domain pitch pulse shape.

24. A method of detecting pitch peaks of a frame of a speech signal, said method comprising:
detecting a first pitch peak of the frame;
selecting a candidate sample from among a plurality of samples within a first search window of the frame;
selecting a candidate distance from among a plurality of distances, each among the plurality of distances corresponding to a different sample within a second search window of the frame; and
selecting, as a second pitch peak of the frame, one among (A) the candidate sample and (B) the sample that corresponds to the candidate distance,
wherein each among the plurality of distances is a distance between A) the corresponding sample and B) the first pitch peak.

25. The method of detecting pitch peaks according to claim 24, wherein the sample that corresponds to the candidate distance is different than the candidate sample.

26. The method of detecting pitch peaks according to claim 24, wherein said selecting a candidate sample includes at least one among (A) selecting the sample having the maximum amplitude among the samples within the first search window to be the candidate sample, (B) selecting the sample having the maximum magnitude among the samples within the first search window to be the candidate sample, and (C) selecting the sample having the maximum energy among the samples within the first search window to be the candidate sample.

27. The method of detecting pitch peaks according to claim 24, wherein said selecting a candidate sample includes selecting the sample having the maximum amplitude among the samples within the first search window to be the candidate sample.

28. The method of detecting pitch peaks according to claim 24, wherein said method comprises, for each among the plurality of distances, calculating a value of a correlation between a neighborhood of the corresponding sample and a neighborhood of the first pitch peak, and
wherein said selecting a candidate distance includes selecting the distance that corresponds to the maximum among the calculated correlation values to be the candidate distance.

29. The method of detecting pitch peaks according to claim 28, wherein said selecting one among the candidate sample and the sample that corresponds to the candidate distance is based on at least one among (A) a relation between a value based on an energy of the candidate sample and a first threshold value and (B) a relation between the calculated correlation value that corresponds to the candidate distance and a second threshold value.

30. The method of detecting pitch peaks according to claim 24, wherein the first pitch peak is a terminal pitch peak of the frame.

31. The method of detecting pitch peaks according to claim 24, wherein said method comprises, prior to said detecting a first pitch peak of the frame, detecting a third pitch peak of the frame, wherein the third pitch peak is a terminal pitch peak of the frame.

32. The method of detecting pitch peaks according to claim 31, wherein said detecting a first pitch peak of the frame is based on (A) a position of the third pitch peak within the frame, (B) a pitch period estimate, and (C) a relation between a first energy threshold value and a value based on an energy of the first pitch peak.

33. The method of detecting pitch peaks according to claim 32, wherein said selecting one among the candidate sample and the sample that corresponds to the candidate distance is based on at least one among (A) a relation between a value based on an energy of the candidate sample and a second threshold value and (B) a relation between a value based on an energy of the sample that corresponds to the candidate distance and the second threshold value,
wherein the second threshold value is less than the first threshold value.

34. An apparatus for detecting pitch peaks of a frame of a speech signal, said apparatus comprising:
means for detecting a first pitch peak of the frame;
means for selecting a candidate sample from among a plurality of samples within a first search window of the frame;
means for selecting a candidate distance from among a plurality of distances, each among the plurality of distances corresponding to a different sample within a second search window of the frame; and
means for selecting, as a second pitch peak of the frame, one among (A) the candidate sample and (B) the sample that corresponds to the candidate distance,
wherein each among the plurality of distances is a distance between A) the corresponding sample and B) the first pitch peak.

35. The apparatus for detecting pitch peaks according to claim 34, wherein said means for selecting a candidate sample is configured to select the sample having the maximum amplitude among the samples within the first search window to be the candidate sample.

36. The apparatus for detecting pitch peaks according to claim 34, wherein said apparatus comprises means for calculating, for each among the plurality of distances, a value of a correlation between a neighborhood of the corresponding sample and a neighborhood of the first pitch peak, and
wherein said means for selecting a candidate distance is configured to select the distance that corresponds to the maximum among the calculated correlation values to be the candidate distance.

37. The apparatus for detecting pitch peaks according to claim 36, wherein said means for selecting one among the candidate sample and the sample that corresponds to the candidate distance is configured to select said one among the candidate sample and the sample that corresponds to the candidate distance based on at least one among (A) a relation between a value based on an energy of the candidate sample and a first threshold value and (B) a relation between the calculated correlation value that corresponds to the candidate distance and a second threshold value.

38. The apparatus for detecting pitch peaks according to claim 34, wherein said apparatus comprises means for detecting a third pitch peak of the frame, wherein the third pitch peak is a terminal pitch peak of the frame, and
wherein said means for detecting a first pitch peak of the frame is configured to detect the first pitch peak based on (A) a position of the third pitch peak within the frame, (B) a pitch period estimate, and (C) a relation between a first energy threshold value and a value based on an energy of the first pitch peak.

39. The apparatus for detecting pitch peaks according to claim 38, wherein said means for selecting one among the candidate sample and the sample that corresponds to the candidate distance is configured to select said one among the candidate sample and the sample that corresponds to the candidate distance based on at least one among (A) a relation between a value based on an energy of the candidate sample and a second threshold value and (B) a relation between a value based on an energy of the sample that corresponds to the candidate distance and the second threshold value,
wherein the second threshold value is less than the first threshold value.

40. An apparatus for detecting pitch peaks of a frame of a speech signal, said apparatus comprising:
a peak detector configured to detect a first pitch peak of the frame;
a sample selector configured to select a candidate sample from among a plurality of samples within a first search window of the frame;
a distance selector configured to select a candidate distance from among a plurality of distances, each among the plurality of distances corresponding to a different sample within a second search window of the frame; and
a peak selector configured to select, as a second pitch peak of the frame, one among (A) the candidate sample and (B) the sample that corresponds to the candidate distance,
wherein each among the plurality of distances is a distance between A) the corresponding sample and B) the first pitch peak.

41. The apparatus for detecting pitch peaks according to claim 40, wherein said sample selector is configured to select the sample having the maximum amplitude among the samples within the first search window to be the candidate sample.

42. The apparatus for detecting pitch peaks according to claim 40, wherein said apparatus comprises a correlator configured to calculate, for each among the plurality of distances, a value of a correlation between a neighborhood of the corresponding sample and a neighborhood of the first pitch peak, and
wherein said distance selector is configured to select the distance that corresponds to the maximum among the calculated correlation values to be the candidate distance.

43. The apparatus for detecting pitch peaks according to claim 42, wherein said peak selector is configured to select one among the candidate sample and the sample that corresponds to the candidate distance based on at least one among (A) a relation between a value based on an energy of the candidate sample and a first threshold value and (B) a relation between the calculated correlation value that corresponds to the candidate distance and a second threshold value.

44. The apparatus for detecting pitch peaks according to claim 40, wherein said apparatus comprises a terminal peak detector configured to detect a third pitch peak of the frame, wherein the third pitch peak is a terminal pitch peak of the frame, and
wherein said peak detector is configured to detect the first pitch peak based on (A) a position of the third pitch peak within the frame, (B) a pitch period estimate, and (C) a relation between a first energy threshold value and a value based on an energy of the first pitch peak.

45. The apparatus for detecting pitch peaks according to claim 44, wherein said peak selector is configured to select one among the candidate sample and the sample that corresponds to the candidate distance based on at least one among (A) a relation between a value based on an energy of the candidate sample and a second threshold value and (B) a relation between a value based on an energy of the sample that corresponds to the candidate distance and the second threshold value,
wherein the second threshold value is less than the first threshold value.

46. A computer-readable medium comprising instructions which when executed by a processor cause the processor to:
detect a first pitch peak of the frame;
select a candidate sample from among a plurality of samples within a first search window of the frame;
select a candidate distance from among a plurality of distances, each among the plurality of distances corresponding to a different sample within a second search window of the frame; and
select, as a second pitch peak of the frame, one among (A) the candidate sample and (B) the sample that corresponds to the candidate distance,
wherein each among the plurality of distances is a distance between A) the corresponding sample and B) the first pitch peak.

47. The computer-readable medium according to claim 46, wherein said instructions which cause the processor to select a candidate sample include instructions which cause the processor to select the sample having the maximum amplitude among the samples within the first search window to be the candidate sample.

48. The computer-readable medium according to claim 46, wherein said medium comprises instructions which when executed by a processor cause the processor to calculate, for each among the plurality of distances, a value of a correlation between a neighborhood of the corresponding sample and a neighborhood of the first pitch peak, and
wherein said instructions which cause the processor to select a candidate distance include instructions which cause the processor to select the distance that corresponds to the maximum among the calculated correlation values to be the candidate distance.

49. The computer-readable medium according to claim 48, wherein said instructions which cause the processor to select one among the candidate sample and the sample that corresponds to the candidate distance include instructions which cause the processor to select said one among the candidate sample and the sample that corresponds to the candidate distance based on at least one among (A) a relation between a value based on an energy of the candidate sample and a first threshold value and (B) a relation between the calculated correlation value that corresponds to the candidate distance and a second threshold value.

50. The computer-readable medium according to claim 46, wherein said medium comprises instructions which when executed by a processor cause the processor to detect a third pitch peak of the frame, wherein the third pitch peak is a terminal pitch peak of the frame, and
wherein said instructions which cause the processor to detect a first pitch peak of the frame include instructions which cause the processor to detect the first pitch peak based on (A) a position of the third pitch peak within the frame, (B) a pitch period estimate, and (C) a relation between a first energy threshold value and a value based on an energy of the first pitch peak.

51. The computer-readable medium according to claim 50, wherein said instructions which cause the processor to select one among the candidate sample and the sample that corresponds to the candidate distance include instructions which cause the processor to select said one among the candidate sample and the sample that corresponds to the candidate distance based on at least one among (A) a relation between a value based on an energy of the candidate sample and a second threshold value and (B) a relation between a value based on an energy of the sample that corresponds to the candidate distance and the second threshold value,
wherein the second threshold value is less than the first threshold value.
